(19) United States
(12) Patent Application Publication
(10) Pub. No.: US 2005/0192084 A1
(43) Pub. Date: Sep. 1, 2005

(54) Gaming machine with reel window

(75) Inventor: Hideaki Iwamoto, Tokyo (JP)

Correspondence Address: ARENT FOX PLLC, 1050 CONNECTICUT AVENUE, N.W., SUITE 400, WASHINGTON, DC, 20036, US

(73) Assignee: ARUZE CORP.

(21) Appl. No.: 11/065,163

(22) Filed: Feb. 25, 2005

(30) Foreign Application Priority Data
Feb. 27, 2004 (JP) 2004-055542

(51) Int. Cl. A63F 13/00; A63F 9/24

(52) U.S. Cl. 463/20; 463/16; 463/26

(57) ABSTRACT

A slot machine comprising: an image display device, which performs a high demonstration effect, is provided. The slot machine 1 is provided with a main display 4 in front of reels 22L, 22C, 22R. The main display 4 is provided with display windows 23, 24, 25 through which it is possible to transmissively recognize modes of variable display control and stop control of the reels 23, 24, 25 visually. By having a display image control means which controls an effect image on the main display 4 in conjunction with the variable display control and stop control of the reels 22L, 22C, 22R, the display image control means is configured to be able to make the display windows 23, 24, 25 invisible in accordance with the effect image movement. Therefore, a game effect may be displayed on the main display 4, which causes united feeling with the variable display control and stop control of the mechanical reels 22L, 22C, 22R.

### CROSS-REFERENCE TO RELATED APPLICATIONS

This application is based upon and claims the benefits of priority from Japanese Patent Application No. 2004-055542 filed on Feb. 27, 2004, the entire contents of which are incorporated herein by reference.

This application is related to a co-pending U.S. patent applications entitled “Gaming Machine With Game Effect” and “Gaming Machine With Payout Table,” and both being filed on even date herewith. The co-pending applications are expressly incorporated herein by reference.

### FIELD OF THE INVENTION

This invention relates to a gaming machine such as a slot machine which is equipped with a variable display means such as reels which carries out variable display of symbols necessary for a game, a control means such as a microcomputer, and so on.

### RELATED ART

In the past, as this kind of a gaming machine, there has been, for example, a slot machine. A game on the slot machine is started by inserting a coin into the slot machine, or by betting a coin to the slot machine within a range of coin numbers credited thereon and a player operating a start lever, a spin button etc. When the game on the slot machine is started, a plurality of reels having a plurality of symbols drawn on the surfaces thereof start to spin, and thereafter, in accordance with a predetermined order, each reel stops, and one game is completed. However, stopping each reel is not caused by a stop operation of the player, but is performed automatically, and therefore, the game often becomes monotonous.

In order to prevent the game from becoming monotonous in this manner, there has been provided a gaming machine which heightens a demonstration effect or a game effect by displaying demonstration display of an image relating to spinning and stopping of each reel on an area other than a symbol display area of each reel of the display device of the slot machine (e.g., JP-A-2001-87452 publication).

### SUMMARY OF THE INVENTION

However, in order to heighten a demonstration effect, demonstration display of an image relating to spinning and stopping of each reel of a slot machine is simply displayed on a different area from a symbol display area of each reel of a display device such that a visual effect relating to the demonstration display and spinning and stopping of each reel is not so well that a player may get bored with the demonstration effect in a short period of time.

According to the present invention, in view of the above-described, there is provided a gaming machine comprising: a slot machine being provided with a liquid crystal display device which may visually show identifiably symbols being drawn on the respective peripheral surfaces of mechanical reels, and the liquid crystal display device being disposed in front of the mechanical reels, and it is possible to expect a visual effect of as if the display windows of the mechanical reels were shuttered and made invisible with movement or action of a character and a high demonstration effect with actual feeling and to provide feeling of being at a live performance. More specifically, the following is provided.

(1) A gaming machine comprising:
reels (e.g., reels 22L, 22C, 22R etc. to be described later) having a plurality of symbols (e.g., symbols etc. shown in FIG. 4 to be described later) necessary for a game drawn on respective peripheral surfaces;
appearing symbol determination means (e.g., a main control circuit 50a which carries out a step S106 in FIG. 28, etc., which will be described later) for determining symbols which are stopped to appear on a predetermined position, out of the plurality of symbols;
reel control means (e.g., a main control circuit 50a which carries out a step S107 of FIG. 28, steps S133, S135 of FIG. 31, steps S140, S144, S151 of FIG. 32, steps S194, S197, S200 of FIG. 35, steps S214, S219, S222 of FIG. 36, steps S228, S231, S232, S234 of FIG. 37, steps S274, S276, S279, S282, S286, S289, S293, S294 of FIG. 40, steps S304, S307, S309, S311, S312 of FIG. 41, etc., which will be described later) which carries out variable display control for displaying variably the plurality of symbols by spinning the reels, and stop control for stopping the symbols on a basis of a determination result by the appearing symbol determination means and for displaying the symbols positioned on the predetermined position,
effect control means (e.g., a sub-control circuit 171 etc., including an image display control circuit 75, which will be described later) for controlling an image effect (e.g., game effect including graphics, sound effect or the like, which is realized by each of display window making-invisible effect data shown in FIGS. 22 and 25, as will be described later) relating to the game; and
effect display means (e.g., a main display 4 etc., which will be displayed later) for displaying the image effect, the effect display means comprising: display windows which are disposed in front of the reels and capable of showing variable display of the plurality of symbols and transmissive display of the symbols, at least one of the display windows being capable of disappearing (or “becoming unrecognizable”) with the image effect displayed thereon by control of the effect control means,
wherein the effect control means controls the image effect which visually relating to the stop control that is carried out by the reel control means, in response to determination of the appearing symbol determination means, to display the image effect on the effect display means, and
wherein the display windows being capable of transmissively displaying the symbols after the stop control in visual association with the image effect when the symbols are in a predetermined symbol arrangement (e.g., appearing symbols etc. corresponding to a winning combination shown in FIG. 10, which will be described later) determined by the appearing symbol determination means.

According to the invention described in (1), there is provided a slot machine being provided with a liquid crystal display device where it is possible to expect a visual effect as if the display window of the mechanical reel were shuttered and made invisible by movement of a character such that a high demonstration effect with actual feeling and feeling of being at a live performance may be achieved when the display window of the stopped reel is shuttered and symbols on the reel are not shown such that movement or animation of the character in relation with shuttering and symbol disappearing. Meanwhile, in the foregoing, symbols appearing along a predetermined line or appearing symbols are defined, but the winning combination or prize pattern is not limited to symbols appearing along a predetermined line, and it is possible that the winning combination or prize pattern is defined by symbols appearing at a predetermined position or predetermined positions, or just appearing symbols which may include blank or solid color symbols.

Here, the gaming machine may carry out the game when a player bets a game medium (e.g., a coin etc. which will be descried later) in advance. The appearing symbol determination means (e.g., a main control circuit 50a which carries out a step S106 of FIG. 28, etc., which will be described later) for determining symbols to appear. The symbols may appear along a predetermined line (e.g., a center line L etc., which will be described later).

(2) The gaming machine according to (1),
wherein the reel control means carries out the stop control to the plurality of reels in a predetermined order, and
wherein a last reel to which the stop control is performed has a predetermined specific symbol (e.g., a bonus trigger symbol etc., which will be described later) that becomes a trigger for a bonus game (e.g., MAGIC LAMP BONUS, BANDIT'S HIDEOUT BONUS, FORTUNE ISLAND BONUS etc., which will be described later), the bonus game being more favorable to a player than the game being played before the bonus game, and
wherein the predetermined specific symbol is stop-controlled on a predetermined position by the reel control means such that the bonus game is triggered.

According to the invention described in (2), the game effect is performed such that the reel symbols are disappearing as the reel display window of the stopped reel is shuttered and the game effect may inform a possibility of stopping a symbol, which becomes a trigger to start the bonus game favorable to the player, and therefore, the player can play the game with feeling of expectancy.

(3) The gaming machine according to (1) or (2),
wherein the reels (e.g., reels 22L, 22C, 22R etc. to be described later) and the display windows (e.g., display windows 23, 24 etc. which will be described later) are corresponding to each other,
wherein all display windows other than a last display window to which the stop control is carried out are capable of disappearing (or “becoming unrecognizable”) with the image effect displayed thereon.

According to the invention described in (3), a display window of a reel which has already stopped spinning is shuttered not to show a symbol of the reel, and one display window remains at the last and variable display of the reel is carried out, and thereby, the player can play the game over heightening feeling of expectancy to the possibility of appearance of the symbol which becomes a trigger to start the bonus game which is favorable to the player.

(4) A gaming machine, with which a player is capable of playing a base game and a bonus game that is more favorable to the player than the base game, comprising:
a plurality of reels having a plurality of symbols drawn on respective peripheral surfaces thereof;
a display window being capable of transmissively displaying at least one of the plurality of symbols of each reel;
a first display including the display window; and
a control device for performing variable display and stop control of the plurality of symbols on the respective plurality of reels;
wherein:
in the base game, the bonus game is triggered when at least one reel of the plurality of reels is stopped at a predetermined position so as to display a predetermined specific symbol, and
the first display is capable of displaying an image effect thereon so as to prevent at least one symbol from being transmissively displayed in the corresponding display window.

Here, the symbols may include a sign, a letter, a design, an illustration, a picture, and a pattern, and may include no pattern of white or another color, or solid color. Transmissive display may include displaying symbols etc. being disposed behind the display with light transmitting through the display. The reel may include a so-called video reel, and symbol spin display may include sequentially displaying a plurality of symbols(further plural kinds of symbols) drawn on peripheral surfaces of the reel by spinning the reel physically. The base game may means a game which a player normally plays at the beginning with the gaming machine. The bonus game is normally a game which may be shifted from the base game, and is a game which is more favorable to the player. To be more favorable to the player may mean that the player may obtain a profit more easily, and also that more profits may be obtained if winning probability is the same. In addition, the bonus game may generally include a bonus game, a free game, etc. A control device which controls variable display and stop control may perform the game control, or a separate control device may be installed to do the same. A round in the bonus game may mean such a process that a result (e.g., win etc.) of one unit of game which may be normally started by a player's operation or an automatic activation is obtained, and then, a profit thereof is distributed to the player. In addition, to be synchronized may mean to occur at the same time, or to occur along the shifted timeline with a predetermined period of time shifted (in advance or behind).

The bonus game may comprise a small game, which may be repeated as the condition allows. Such a small game may allow the player to accumulate awards to be obtained in the bonus game by repetition thereof. Therefore, one round may correspond to one play of the small game and may be defined as a unit of repetition. In the bonus game, after a predetermined number of rounds having been repeated, a bonus game completion prediction lottery is carried out, and on a basis of a result of the bonus game completion prediction lottery, another small game in the bonus game is repeated, or the game is shifted to the base game.

(5) The gaming machine according to (4), wherein the first display is provided with a panel being disposed in front of the display windows and is of an approximately same size as a display section of the first display, and wherein the image effect is shown on the panel.

The panel may comprise a displayable panel such as a liquid crystal panel, an organic EL panel, and so on. The display window being disposed in front of a reel may disappear or be erased by an image effect shown on the panel. Suppose the panel is a liquid crystal display, the panel may be capable of shuttering, shielding, or preventing the light from behind the panel such that the display window may disappear or be erased or shuttered.

(6) The gaming machine according to (4) or (5), wherein in the bonus game, after a predetermined number of rounds having been repeated, where one round is a unit of repetition, a bonus game completion prediction lottery is carried out, and on a basis of a result of the bonus game completion prediction lottery, a condition of the gaming machine is controlled to shift from the bonus game to the base game.

According to the present invention, it is possible to expect a visual effect as if display windows of the mechanical reels were shuttered and erased by movement or animation of the character, while the display windows of the mechanical reels are shuttered to make symbols of the mechanical reels invisible and displaying the game effect with moving images of the character in relation to the shuttering and the character movement, and therefore, a high demonstration effect with actual feeling and feeling of being at a live performance are expected, and it is further possible to heighten player's feeling of expectancy,

Further features of the present invention, its nature, and various advantages will be more apparent from the-accompanying drawings and the following description of the preferred embodiment.

### BRIEF DESCRIPTION OF THE DRAWINGS

FIG. 1 is a perspective view of a slot machine 1.

FIG. 2 is a vertical cross-sectional view of a main display 4 and a reel 22.

FIG. 3 is an exploded perspective view of the main display 4.

FIG. 4 is a view showing symbols and code numbers which are drawn on reels 22L, 22C, 22R.

FIG. 5 is a view showing an electric configuration of the slot machine 1.

FIG. 6 is a view showing an electric configuration of a sub control circuit 171 of the slot machine 1.

FIG. 7 is a view schematically showing a progressive system.

FIG. 8 is a view showing a probability lottery table for a base game.

FIG. 9 is a view showing a probability lottery table for MAGIC LAMP BONUS.

FIG. 10 is a view showing a winning combination determination table.

FIG. 11 is a view showing a normal image selection probability table.

FIG. 12 is a view showing a reel stopping order determination probability lottery table.

FIG. 13 is a view showing a bonus game demonstration selection probability lottery table.

FIG. 14 is a view showing a NUDGE demonstration determination probability lottery table at the time of bonus trigger symbol selection.

FIG. 15 is a view showing a demonstration selection probability lottery table in accordance with a winning combination (except for a bonus game and a loss (or not winning)).

FIG. 16 is a view showing a failure game effect selection probability table when a winning combination is a loss (or not winning).

FIG. 17 is a view showing a MAGIC LAMP BONUS completion prediction demonstration probability lottery table.

FIG. 18 is a view showing a MAGIC LAMP BONUS completion probability lottery table when MAGIC LAMP BONUS completion prediction demonstration is carried out.

FIG. 19 is a view showing a payout display change pattern probability lottery table.

FIG. 20 is a view showing a normal image demonstration data table.

FIG. 21 is a view showing a reel stop demonstration data table of winning combinations except the bonus game or the loss(or not winning).

FIGS. 22A-C show a reel stop demonstration data table when the winning combination is the loss(or not winning).

FIG. 23 is a view showing a MAGIC LAMP BONUS state game demonstration data table.

FIG. 24 is a view showing a MAGIC LAMP BONUS completion demonstration data table.

FIGS. 25A-B show a bonus game demonstration data table.

FIGS. 26A-B show a BANDIT'S HIDEOUT BONUS demonstration data table.

FIGS. 27A-B show a FORTUNE ISLAND BONUS demonstration data table.

FIG. 28 is a flow chart showing a flow of processing in a main control circuit 50a in a slot machine.

FIG. 29 is a view which follows FIG. 28.

FIG. 30 is a flow chart showing a flow of a subroutine for normal image selection processing.

FIG. 31 is a flow chart showing a flow of a subroutine for bonus game processing.

FIG. 32 is a view which follows FIG. 31.

FIG. 33 is a flow chart showing a flow of a routine for FORTUNE ISLAND BONUS start command reception processing.

FIG. 34 is a flow chart showing a flow of a routine for BANDIT'S HIDEOUT BONUS start command reception processing.

FIG. 35 is a flow chart showing a flow of a subroutine for demonstration and reel stop processing in accordance with a winning combination.

FIG. 36 is a flow chart showing a flow of a subroutine for MAGIC LAMP BONUS processing.

FIG. 37 is a view which follows FIG. 36.

FIG. 38 is a flow chart showing a flow of a routine for payout display change command reception processing.

FIG. 39 is a flow chart showing a flow of a subroutine for MAGIC LAMP BONUS completion lottery processing.

FIG. 40 is a flow chart showing a flow of a subroutine for failing game effect and reel stop processing in a first stopping order.

FIG. 41 is a flow chart showing a flow of a subroutine for failing game effect and reel stop processing in one other than the first stopping order.

FIG. 42 is an image view of an effect screen which is displayed on the main display 4.

FIG. 43 is an image view of the effect screen which is displayed on the main display 4.

FIG. 44 is an image view of the effect screen which is displayed on the main display 4.

FIG. 45 is an image view of the effect screen which is displayed on the main display 4.

FIG. 46 is an image view of the effect screen which is displayed on the main display 4.

FIG. 47 is an image view of the effect screen which is displayed on the main display 4.

FIG. 48 is an image view of the effect screen which is displayed on the main display 4.

FIG. 49 is an image view of the effect screen which is displayed on the main display 4.

FIG. 50 is an image view of the effect screen which is displayed on the main display 4.

FIG. 51 is an image view of the effect screen which is displayed on the main display 4.

FIG. 52 is an image view of the effect screen which is displayed on the main display 4.

FIG. 53 is an image view of the effect screen which is displayed on the main display 4.

FIG. 54 is an image view of the effect screen which is displayed on the main display 4.

FIG. 55 is an image view of the effect screen which is displayed on the main display 4.

FIG. 56 is an image view of the effect screen which is displayed on the main display 4.

FIG. 57 is an image view of the effect screen which is displayed on the main display 4.

FIG. 58 is an image view of the effect screen which is displayed on the main display 4.

FIG. 59 is an image view of the effect screen which is displayed on the main display 4.

FIG. 60 is an image view of the effect screen which is displayed on the main display 4.

FIG. 61 is an image view of the effect screen which is displayed on the main display 4.

FIG. 62 is an image view of the effect screen which is displayed on the main display 4.

FIG. 63 is an image view of the effect screen which is displayed on the main display 4.

FIG. 64 is an image view of the effect screen which is displayed on the main display 4.

FIG. 65 is an image view of the effect screen which is displayed on the main display 4.

FIG. 66 is an image view of the effect screen which is displayed on the main display 4.

FIG. 67 is an image view of the effect screen which is displayed on the main display 4.

FIG. 68 is an image view of the effect screen which is displayed on the main display 4.

FIG. 69 is an image view of the effect screen which is displayed on the main display 4.

FIG. 70 is an image view of the effect screen which is displayed on the main display 4.

FIG. 71 is an image view of the effect screen which is displayed on the main display 4.

FIG. 72 is an image view of the effect screen which is displayed on the main display 4.

FIG. 73 is an image view of the effect screen which is displayed on the main display 4.

FIG. 74 is an image view of the effect screen which is displayed on the main display 4.

FIG. 75 is an image view of the effect screen which is displayed on the main display 4.

FIG. 76 is an image view of the effect screen which is displayed on the main display 4.

FIG. 77 is an image view of the effect screen which is displayed on the main display 4.

FIG. 78 is an image view of the effect screen which is displayed on the main display 4.

FIG. 79 is an image view of the effect screen which is displayed on the main display 4.

FIG. 80 is an image view of the effect screen which is displayed on the main display 4.

FIG. 81 is an image view of the effect screen which is displayed on the main display 4.

FIG. 82 is an image view of the effect screen which is displayed on the main display 4.

FIGS. 83A-B are image views of the effect screens which are displayed on a sub display 3 and the main display 4, respectively.

FIGS. 84A-B are image views of effect screens which are displayed on the sub display 3 and the main display 4, respectively.

FIGS. 85A-B are image views of the effect screens which are displayed on the sub display 3 and the main display 4, respectively.

FIG. 86 is an image view of the effect screen which is displayed on the sub display 3.

FIG. 87 is an image view of the effect screen which is displayed on the sub display 3.

FIG. 88 is an image view of the effect screen which is displayed on the sub display 3.

FIG. 89 is an image view of the effect screen which is displayed on the sub display 3.

FIGS. 90A-B are image views of the effect screens which are displayed on the sub display 3 and the main display 4, respectively.

FIGS. 91A-B are image views of the effect screens which are displayed on the sub display 3 and the main display 4, respectively.

FIG. 92 is an image view of the effect screen which is displayed on the sub display 3.

FIG. 93 is an image view of the effect screen which is displayed on the sub display 3.

FIG. 94 is an image view of the effect screen which is displayed on the sub display 3.

FIG. 95 is an image view of the effect screen which is displayed on the sub display 3.

FIG. 96 is an image view of the effect screen which is displayed on the sub display 3.

FIG. 97 is an image view of the effect screen which is displayed on the sub display 3.

FIG. 98 is an image view of the effect screen which is displayed on the sub display 3.

FIG. 99 is an image view of the effect screen which is displayed on the sub display 3.

FIG. 100 is an image view of the effect screen which is displayed on the sub display 3.

FIG. 101 is an image view of the effect screen which is displayed on the sub display 3.

FIG. 102 is an image view of the effect screen which is displayed on the sub display 3.

FIG. 103 is an image view of the effect screen which is displayed on the sub display 3.

FIG. 104 is an image view of the effect screen which is displayed on the main display 4.

FIG. 105 is an image view of the effect screen which is displayed on the sub display 3.

FIG. 106 is an image view of the effect screen which is displayed on the sub display 3.

FIG. 107 is an image view of the effect screen which is displayed on the sub display 3.

FIG. 108 is an image view of a payout display screen which is displayed on the sub display 3.

FIG. 109 is an image view of the payout display screen which is displayed on the sub display 3.

FIG. 110 is an image view of the payout display screen which is displayed on the sub display 3.

FIG. 111 is an image view of the payout display screen which is displayed on the sub display 3.

FIG. 112 is an image view of the payout display screen which is displayed on the sub display 3.

### DESCRIPTION OF THE PREFERRED EMBODIMENTS

The preferred embodiment of the present invention will be described below in reference to the drawings. However, the present invention is not limited to the embodiment, and various modifications and changes in design can be made without departing from the scope of the present invention.

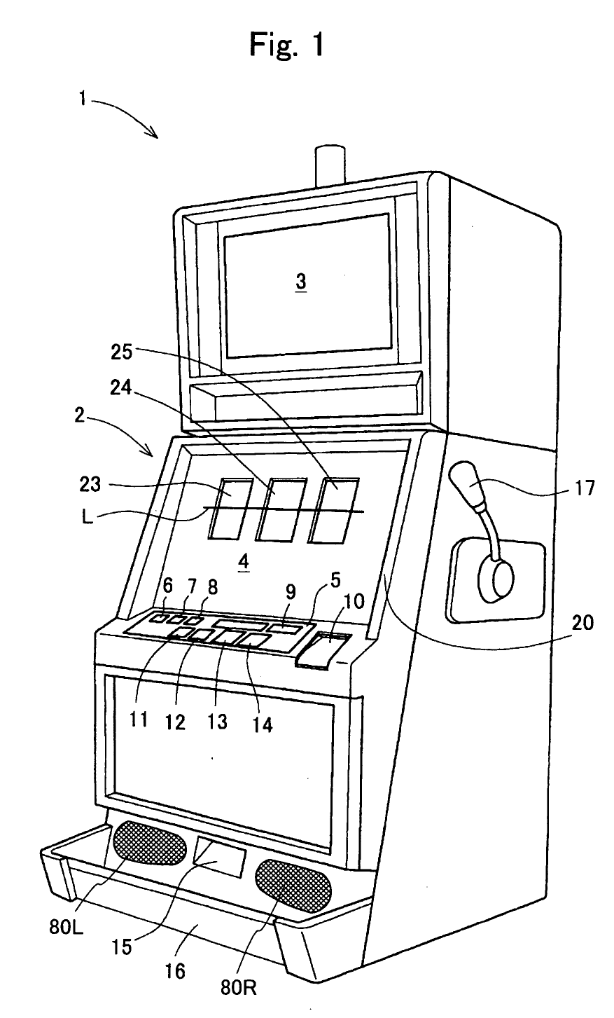

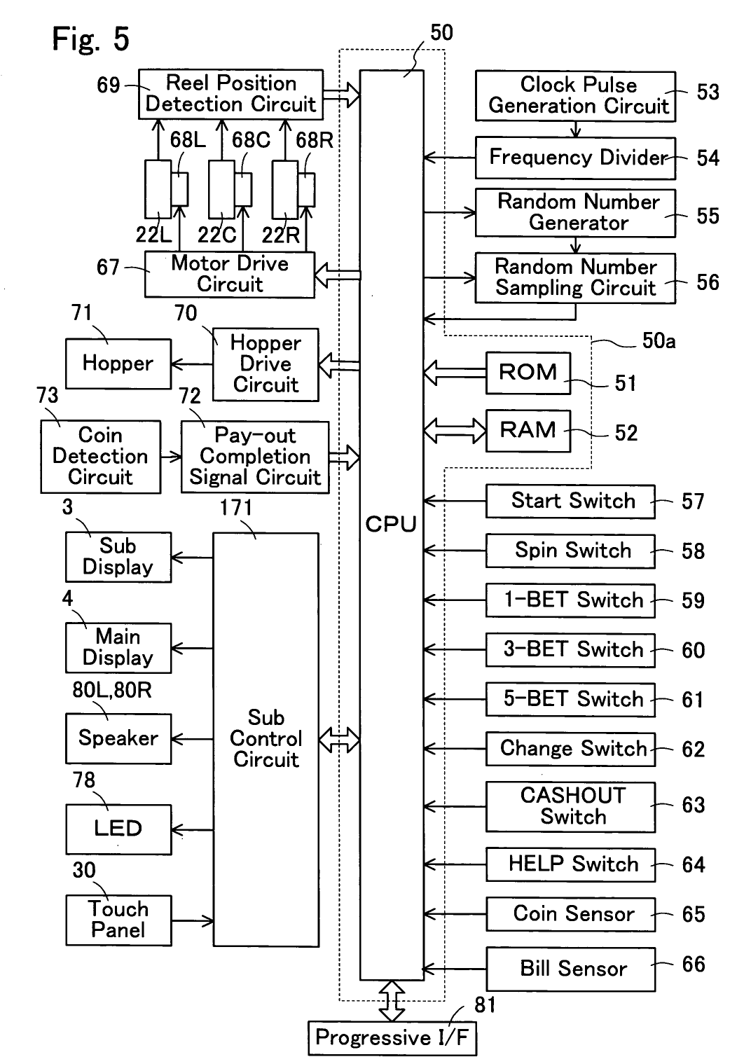

Hereinafter, a slot machine 1 which relates to this embodiment will be described with reference to drawings. Firstly, an outline configuration of the slot machine 1 which relates to the embodiment will be described on the basis of FIGS. 1 and 5. Meanwhile, in this embodiment, as one example of a slot machine, the slot machine 1 will be described as an example. FIG. 1 is a perspective view of the slot machine 1.

[Exterior Appearance of Slot Machine 1]

In FIG. 1, the slot machine 1 has a cabinet 2 which forms the entirety thereof, and a sub display 3 is disposed on a front surface upper portion of the cabinet 2, and in addition, a main display 4 is disposed on a front surface center portion of the cabinet 2. Here, the sub display 3 is configured by a liquid crystal display which is generally used, and in addition, the main display 4 is configured by a so-called transparent liquid crystal display. Meanwhile, a detailed structure of the main display 4 will be described later. On the sub display 3, a payout table, which will be described later, is displayed, in case of a base gaming state and a waiting state.

On a lower side of the main display 4, an operation table 5 being projected to a front side is disposed, and on the operation table 5, a CHANGE button 6, a CASH-OUT button 7, and a HELP button 8 are disposed from a leftmost side, and in addition, on the right side of the HELP button 8, a coin entry section 9, and a paper money entry section 10 are disposed. In addition, on the front side of the operation table 5, an 1-BET button 11, a SPIN/REPEAT-BET button (hereinafter, abbreviated as “SPIN button”) 12, a 3-BET button 13, and a 5-BET button 14 are disposed from a left side.

Here, the CHANGE button 6 is a button which is depressed on the occasion of changing a paper money which was entered into the paper money (or bill) entry section 10, and changed coins are paid out from a coin pay-out opening 15 being disposed at a lower portion of the cabinet 2 to a coin tray 16. A CHANGE switch 62 is disposed in an attached fashion to the CHANGE button 6, and a switch signal is outputted to a CPU 50 from the CHANGE switch 62, on the basis of depression of the CHANGE button 6.

The CASH-OUT button 7 is a button which is depressed at the time of base game completion, and when the CASH-OUT button 7 is depressed, coins having been obtained in a game are paid back from the coin pay-out opening 15 to the coin tray 16. Meanwhile, a CASH-OUT switch 63, which will be described later, is disposed in an attached fashion to the CASH-OUT button 7, and a switch signal is outputted to the CPU 50 on the basis of depression of the CASH-OUT button 7.

The HELP button 8 is a button which is depressed in case that an operation procedure etc. of a game is unclear, and when the HELP button 8 is depressed, various help information is displayed on the sub display 3 and the main display 4. A HELP switch 64, which will be described later, is disposed in an attached fashion to the HELP button 8, and a switch signal is outputted to the CPU 50 from the HELP switch 64 on the basis of depression of the HELP button 8.

Meanwhile, when a payout table, which will be described later, is not displayed on the sub display 3 during a period of gaming, the payout table is displayed on the sub display 3 by depression of the HELP button 8.

A coin sensor 65, which will be described later, is disposed in the coin entry section 9, and when a coin is entered into the coin entry section 9, a coin detection signal is outputted to the CPU 50 through the coin sensor 65. In addition, a paper money sensor 66 is disposed in the paper money entry section 10, and when a paper money is entered into the paper money entry section 10, a paper money detection signal is outputted from the CPU 50 through the paper money sensor 66.

The 1-BET button 11 is a button by which bet is carried out one by one with respect to each one depression, and it is possible to bet by depressing it, up to the maximum three times. A 1-BET switch 59 is disposed in an attached fashion to this 1-BET button 11, and when the 1-BET button 11 is depressed, a switch signal is outputted from the 1-BET switch 59 to the CPU 50 on the basis of its depression.

The SPIN button 12 is a button which initiates spin of reels 22L, 22C, 22R, which will be described later, so as to start a game with a current bet number or a previous bet number on the basis of being depressed. A SPIN switch 58, which will be described later, is disposed in an attached fashion to the SPIN button 12, and when the SPIN button 12 is depressed, a switch signal is outputted from the SPIN switch 58 to the CPU 50 on the basis of its depression. Meanwhile, as the bet number which may be bet by depression of the SPIN button 12, 1, 2, 3, 5 bets may exist.

The 3-BET button 13 is a button which starts a game with 3 bets on the basis of its depression. A 3-BET switch 60, which will be described later, is disposed in an attached fashion to the 3-BET button 13, and at the time of its depression, a switch signal is outputted from the 3-BET switch 60 to the CPU 50. In addition, the 5-BET button 14 is a button which starts a game with 5 bets on the basis of its depression, and is depressed on the occasion of starting a bonus game which will be described later. A 5-BET switch 61, which will be described later, is disposed in an attached fashion to the 5-BET button 14, and a switch signal is outputted from the 5-BET switch 61 to the CPU 50 on the basis of its depression.

In addition, on a lower portion of the cabinet 2, the coin pay-out opening 15 is formed, and the coin tray 16, which receives a coin paid out from the coin pay-out opening 15, is disposed. In an inside of the coin pay-out opening 15, a coin detection section 73, which is configured by a sensor etc., is disposed, and the coin detection section 73 detects the number of coins which are paid out from the coin pay-out opening 15.

Further, on a side surface (right side surface in FIG. 1) of the cabinet 2, a start lever 17 is attached rotatably within a predetermined angle range. A start switch 57 is disposed in an attached fashion to the start lever 17, and at the time of rotation of the start lever 17, a switch signal, which is emitted from the start switch 57, is outputted to the CPU 50.

[Reel and Lower Side Liquid Crystal Display]

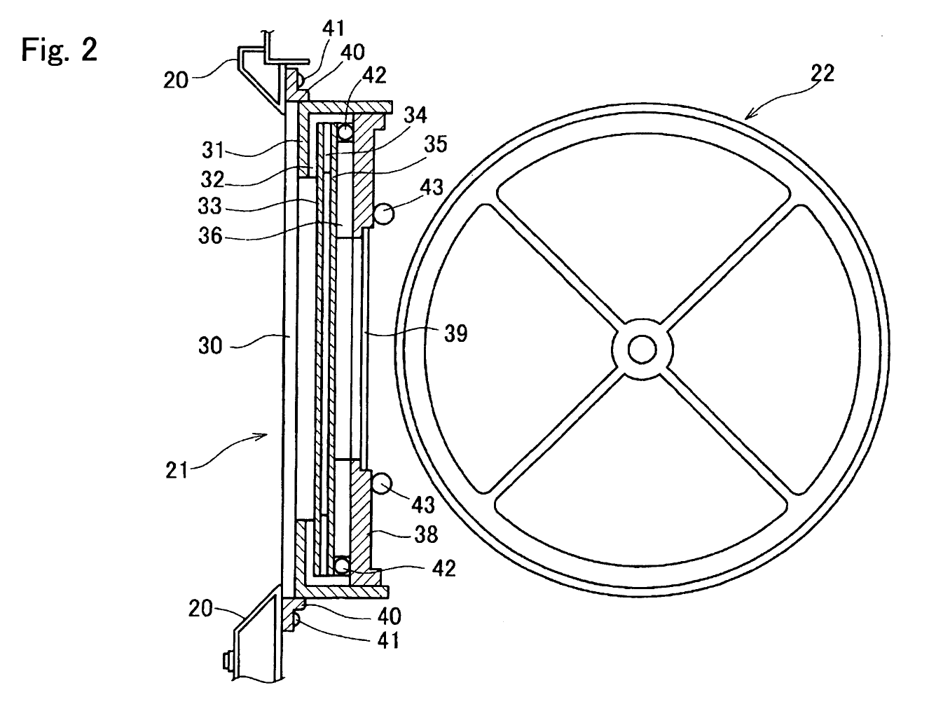

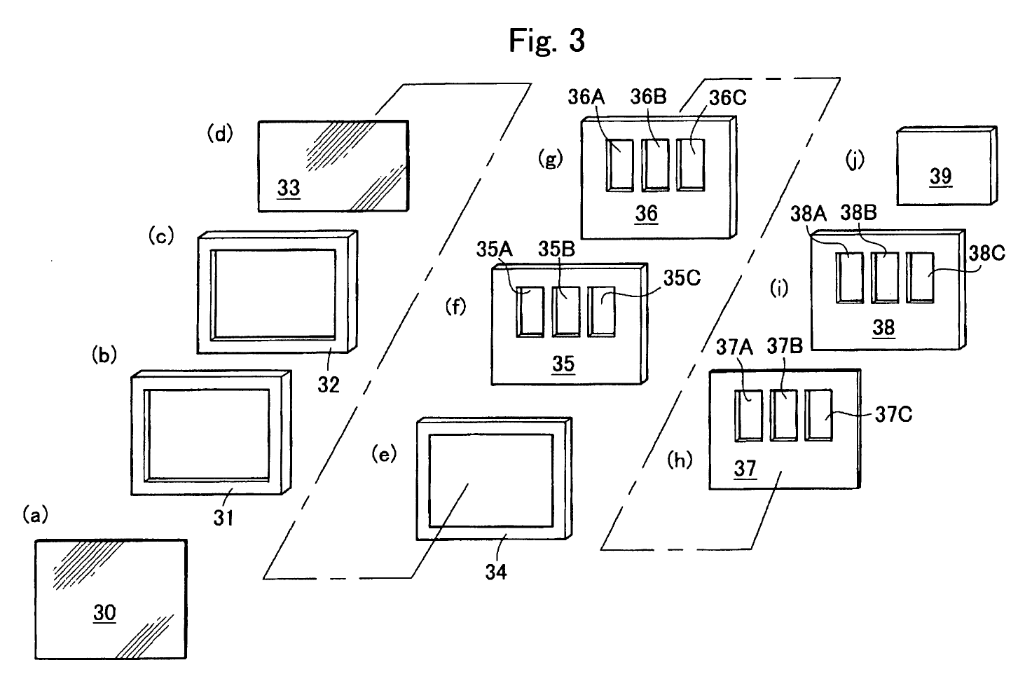

Subsequently, a detailed structure of the main display 4 and three reels 22L, 22C, 22R, which were disposed rotatably in an inside of the cabinet 2 on a back surface side of the main display 4 will be described on the basis of FIGS. 2 and 3. FIG. 2 is a vertical cross-sectional view of the main display 4 and the reels 22L, 22C, 22R, and FIG. 3 is an exploded perspective view of the main display 4.

In FIGS. 2 and 3, the main display 4 is disposed on an inside of a display window section 21 of a device front surface panel 20 having been disposed at a front surface center portion of the cabinet 2 of the slot machine 1, together with a transparent touch panel 30 (hereinafter, abbreviated as “touch panel 30”) having been disposed on its front surface side (left side in FIG. 2), and in addition, on a back surface side (right side in FIG. 2) of the main display 4, the three reels 22L, 22C, 22R (FIG. 2 shows only one reel among the three reels 22L, 22C, 22R) are in a juxtaposed situation, and rotatably supported independently, respectively.

Here, each reel 22L, 22C, 22R will be described. The reel 22L of the slot machine 1 among the three reels 22L, 22C, 22R, is facing a left display window 23 (see, FIG. 1) which is formed in the main display 4, and the reel 22C is facing a center display window 24 (see, FIG. 1) which is formed in the main display 4 in the same manner, and in addition, the reel 22R is facing a right display window 25 (see, FIG. 1) which is formed in the main display 4 in the same manner. Meanwhile, a structure of each display window 23, 24, 25 will be described later.

[Symbol Arrangement of Reels]

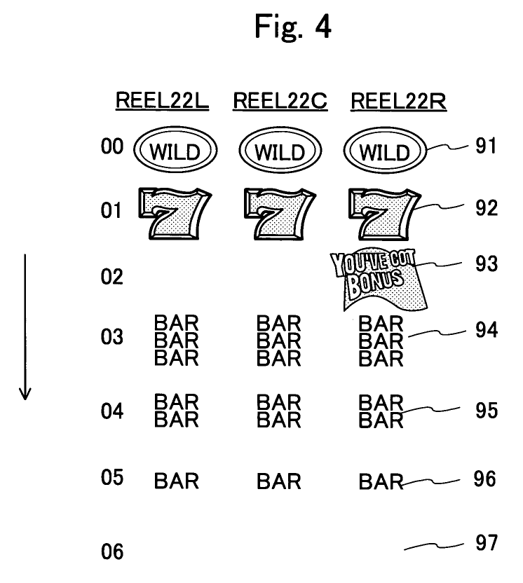

FIG. 4 shows one example of such a symbol row that seven pieces of plural kinds of symbols shown on each reel 22L, 22C, 22R have been arranged, respectively. This arrangement is converted into a table as data, and stored in a ROM 51 (see, FIG. 5) which will be described later. That is, code number of “00” to “06” are given to each symbol, as shown in FIG. 4, and as a data table, stored in the ROM 51 (see, FIG. 5) which will be described later. That is, it is possible to specify a symbol uniquely, by differentiation of the reels 22L, 22C, 22R, and the code number.

On a peripheral surface of each reel 22L, 22C, 22R, seven kinds of symbols including a blank symbol are formed, as shown in FIG. 4. More specifically, the symbols, which are formed on a peripheral surface of each reel 22L, 22C, 22R, are a WILD symbol 91, a RED7 symbol 92, a BONUS trigger symbol 93, a 3BAR symbol 93, a 2BAR symbol 95, a BAR symbol 96, a blank symbol 97. Then, on a peripheral surface of each reel 22L, 22C, 22R, these seven kinds of symbols are arranged in the order shown in FIG. 4. Each reel 22L, 22C, 22R is driven to be spun, in such a manner that a symbol row moves in an arrow direction of FIG. 4.

Meanwhile, various winning combinations have been set up in advance on the basis of a plurality of combinations for each symbol, and such a point that coins are paid out from the coin pay-out opening 15 in accordance with a winning combination, on the occasion that a combination of symbols, which corresponds to a winning combination, has been stopped on a winning line L (see, FIG. 1) is similar to a conventional slot machine, and here, its explanation will be omitted. In addition, as to such a matter that various symbols are formed on a peripheral surface of each reel 22, it is generally carried out to form them by printing out eleven pieces of symbols on a long scale shaped seal which coincides with a width/a peripheral length of each reel 22, and by gluing the seal on a peripheral surface of each reel 22, but it is possible, as a matter of course, to form symbols by a method other than this method.

Here, in this embodiment, the winning line L is described only as a center line, and the winning line L is displayed on the main display 4, on the occasion of carrying out a game due to a spin stop of each reel 22 on the basis of depression of the 1-BET button 11, the SPIN button 12, the 3-BET button 13, and the 5-BET button 14 or rotation of the start lever 17, and on one hand, it is display-erased from the main display 4, on the occasion of carrying out a bonus game on the basis of depression of the 5-BET button when various bonus games, which will be described later, are acquired.

In addition, the BONUS trigger symbol 93 is a thing which operates as a trigger for the purpose of acquiring various bonus games, and in this embodiment, one BONUS trigger symbol 93 is disposed only on a peripheral surface of the reel 22R. On the basis of such a matter that the BONUS trigger symbol 93, which exists on a peripheral surface of the reel 22R, is stopped on the winning line L, it is possible to acquire various bonus games.

[Structure of Main Display 4]

Subsequently, a structure of the main display 4 will be described on the basis of FIGS. 2 and 3. In FIGS. 2 and 3, a touch panel 30, a reel glass base 31, a bezel metal frame 32, a liquid crystal panel 33, a liquid crystal holder 34, a diffusion sheet 35, a light guiding plate 36, a while color reflector 37, a rear holder 38, and an anti-static sheet 39 are disposed from a front surface side of the slot machine 1, and thereby, the main display 4 is configured. In the diffusion sheet 35, opening sections 35A, 35B, 35C are formed, and in the same manner, in the light guiding plate 36, the reflector 37 and the rear holder 38, opening sections 36A, 36B, 36C, opening sections 37A, 37B, 37C, and opening sections 38A, 38B, 38C are formed, respectively, so as to coincide with the opening sections 35A to 35C. On each opening section 35A to 38A, the left display window 23 (see, FIG. 1) is configured by overlapping them so as to coincide with each other, and on each opening section 35B to 38B, the center display window 24 (see, FIG. 1) is configured in the same manner, and in addition, on each opening section 35C to 38C, the right display window (see, FIG. 1) is configured in the same manner.

Here, the opening sections 35A to 35C of the diffusion sheet 35 and the opening sections 36A to 36C of the light guiding plate 36 configure a transparent region which secures visibility of variable display in each reel 22.

In order to attach the main display 4 to the display window section 21 of the device front surface panel 20, it is carried out as shown in FIG. 2, by screw-shutting each bracket 40 having been disposed so as to be projected in a up-and-down direction of the reel glass base 31 to a rear surface of the device front surface panel 20 by a screw 41.

In addition, a pair of cold cathode ray tubes 42 are disposed, as a light source of the liquid crystal panel 33, on upper and lower ends of the light guiding plate 36. In addition, a pair of cold cathode ray tubes 43, which illuminates symbols formed on an outer peripheral surface of each reel 22, are disposed on top and bottom at a rear surface side of each opening section 38A to 38C of the rear holder 38.

The liquid crystal panel 33 is a transparent electric display panel made by ITO etc., which is disposed on a front surface of each reel 22, and through which each reel 22L, 22C, 22R is seen, and a rear side surrounding its display section is held by the liquid crystal holder 34. The light guiding plate 36 is made by an optical transparent resin panel, and a lens cut, which guides light emitted from the cold cathode ray tube 42 located at a side portion, to a rear surface side of the liquid crystal panel 33, is disposed therein. The diffusion sheet 35 is made by an optical transparent resin sheet, and diffuses light having been guided by the light guiding plate 36, and uniformizes light having been irradiated to the liquid crystal panel 33. The liquid crystal holder 34 holding the liquid crystal panel 33, the diffusion sheet 35 and the light guiding plate 36 are integrated, and its periphery is inserted into the bezel metal frame 32. By this insertion, a front surface side of the display section in the liquid crystal panel 33 is held by the bezel metal frame 32.

A periphery of the liquid crystal holder 34, the diffusion sheet 35 and the light guiding plate 36 having been set in the bezel metal frame 32 to be united is additionally inserted into the reel glass base 31, and is held by the reel glass base 31 in such a state that a display front surface of the liquid crystal panel 33 is opened. The reel glass base 31 is attached to the device front surface panel 20 through the screw 41, and thereby, the touch panel 30 is pressure-bonded to a front surface of the reel glass base 31, and overlapped with the display section of the liquid crystal panel 33.

The rear holder 38 is made by a white color resin plate, and holds the bezel metal frame 32 supported by the reel glass base 31, the liquid crystal holder 34 holding the liquid crystal panel 33, the diffusion sheet 35 and the light guiding plate 36 on the reel glass base 31 from behind. This rear holder 38 is also functioning as a reflecting plate which reflects light emitted from the cold cathode ray tube 42 to the light guiding plate 36 to the liquid crystal panel 33 side. The anti-static sheet 39 is transparent and bonded by a double-stick tape to a rear surface of the rear holder 38, and is covering a rear surface of each opening section 38A to 38C formed in the rear holder 38.

[Electric Structure of Slot Machine 1]

Next, a structure which relates to a control system of the slot machine 1 will be described on the basis of FIG. 5. FIG. 5 is a block diagram which schematically shows the control system of the slot machine 1.

In FIG. 5, the control system of the slot machine 1 is configured by nucleating CPU 5, and ROM 51 and RAM 52 are connected to the CPU 50. A main control circuit 50a of the slot machine 1 is configured by the CPU 50, the ROM 51, and the RAM 52. The ROM 51 stores a game control program which will be described later, various demonstration programs and various demonstration data for the purpose of carrying out various demonstrations on the sub display 3 and the main display 4 with a progress of a game, a probability lottery table for carrying out various lotteries including lottery of various winning combinations, other various programs, data tables necessary for control of the slot machine 1, etc. In addition, the RAM 52 is a memory which temporarily stores various data having been calculated by the CPU 50.

In addition, to the CPU 50, a clock pulse generation circuit 53, which generates reference clock pulses, and a divider 54 are connected, and in addition, a random number generator 55, which generates random numbers, and a random number sampling circuit 56 are connected. Random numbers having been sampled through the random number sampling circuit 56 are used for various lotteries of winning combinations, demonstrations etc. Further, to the CPU 50, the start switch 57 which is disposed in an attached fashion to the start lever 17, the SPIN switch 58 which is disposed in an attached fashion to the SPIN button 12 the 1-BET switch 59 which is disposed in an attached fashion to the 1-BET button 11, the 3-BET switch 60 which is disposed in an attached fashion to the 3-BET button 13, the 5-BET switch 61 which is disposed in an attached fashion the 5-BET bottom 14 the CHANGE switch 62 which is disposed in an attached fashion to the CHANGE button 6, the CASH-OUT switch 63 which is disposed in an attached fashion to the CASH-OUT button 7, and the HELP switch 64 which is disposed in an attached fashion to the HELP button 8 are connected, respectively. The CPU 50 carries out control so as to carry out various operations which correspond to each button, on the basis of a switch signal which is outputted from each switch by depression of each button.

Further, to the CPU 50, the coin sensor 65 which is disposed in the coin entry section 9, and the paper money sensor 66 which is disposed in the paper money entry section 10 are connected, respectively. The coin sensor 65 detects a coin having been entered from the coin entry section 9, and the CPU 50 calculates the number of coins having been entered on the basis of a coin detection signal which is outputted from the coin sensor 65. The paper money sensor 66 detects a type and an amount of a paper money having been entered from the paper money entry section 10, and the CPU 50 calculates the number of coins which is equivalent to an amount of a paper money on the basis of a paper money detection signal which is outputted from the paper money sensor 66.

To the CPU 50, three stepping motors 68L, 68C, 68R, which carries out spin of each reel 22L, 22C, 22R respectively, are connected through a motor drive circuit 67, and in addition, a reel position detection circuit 69 is connected. When a motor drive signal is outputted from the CPU 50 to the motor drive circuit 67, each stepping motor 68 is driven so as to rotate, by the motor drive circuit 67. By this means, spin of each reel 22L, 22C, 22R is carried out.

At this time, after spin of each reel 22L, 22C, 22R is started, the number of drive pulses, which are supplied to each of the stepping motors 68, is calculated, and its calculated value is written in a predetermined area of the RAM 52. In addition, a reset pulse is outputted from each reel 22L, 22C, 22R with respect to each one spin, and the reset pulse is inputted to the CPU 50 through the reel position detection circuit 69. When the reset pulse is inputted to the CPU 50 in this manner, the calculated value, which has been written in the RAM 52, is cleared up to “0”, and the CPU 50 recognizes a rotation position of symbols in each reel 22L, 22C, 22R, on the basis of a calculated value which corresponds to a rotation position in a range of one spin of each reel 22L, 22C, 22R, and a symbol table in which a spin position of each reel 22L, 22C, 22R having been stored in the ROM 51 corresponds to a symbol having been formed on a peripheral surface of each reel 22L, 22C, 22R.

To the CPU 50, a hopper 71 is connected through a hopper drive circuit 70. When a drive signal is outputted from the CPU 50 to the hopper drive circuit 70, the hopper 71 pays out a predetermined number of coins from the coin pay-out opening 15.

In addition, to the CPU 50, a coin detection section 73 is connected through a pay-out completion signal circuit 72. The coin detection section 73 is disposed in an inside of the coin pay-out opening 15, and in case that it detected that a predetermined number of coins have been paid out from the coin pay-out opening 15, a coin pay-out detection signal is outputted from the coin detection section 73 to the pay-out completion signal circuit 72, and on the basis of this, the pay-out completion signal circuit 72 outputs a pay-out completion signal to CPU 50.

In addition, to the CPU 50, a sub control circuit 171 is connected. To the sub control circuit, the sub display 3, the main display 4, speakers 80L and 80R, LED 78, and the touch panel 30 are connected. Meanwhile, two-way communication is carried out between the CPU 50 and the sub control circuit 171.

Further, to the CPU 50, a progressive interface (I/F) 81 is disposed in an attached fashion.

[Electric Structure of Sub Control Circuit]

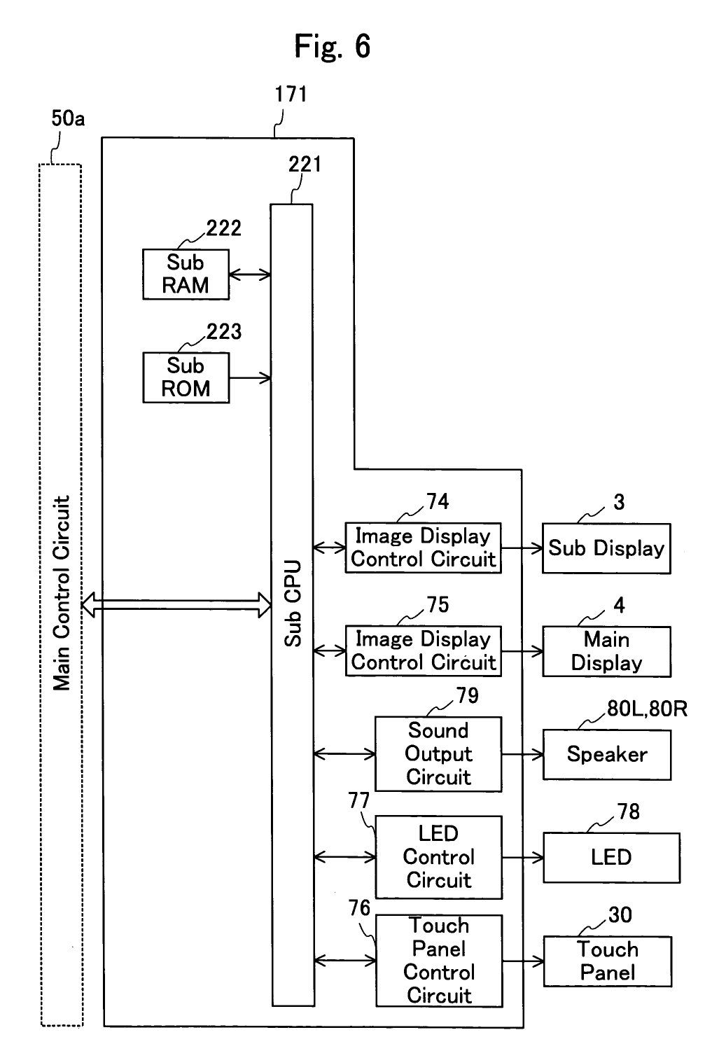

Next, the sub control circuit 171, which is shown in FIG. 6, will be described. The sub control circuit 171 is configured by a sub CPU 221, a sub ROM 223, a sub RAM 222, image display control circuits 74 and 75, a sound output circuit 79, a LED control circuit 77, and a touch panel control circuit 76. Meanwhile, an IN port and an OUT port etc. are disposed arbitrarily, between the main control circuit 50a and the sub control circuit 171, and between the sub CPU 221 and each actuator.

The sub CPU 221 determines what-like display is carried out by the sub display 3 and the main display 4 on the basis of a gaming information command having been transmitted from the main control circuit 50a, and transmits a display content to the image display control circuits 74, 75.

In the sub ROM 223, a communication sequence program with the main control circuit 50a, and a program and data which are necessary for a slot game and a bonus game are stored.

The sub RAM 222 is utilized as a working area on the occasion of executing these control program.

The image display control circuit 74 is configured so as to include a video ROM (not shown in the figure) and a video RAM (not shown in the figure), and controls a display content of the sub display 3. The image display control circuit 75 is also configured so as to include a video ROM (not shown in the figure) and a video RAM (not shown in the figure), and controls a display content of the main display 4. The image display control circuits 74, 75 display predetermined game effects on the sub display 3 and the main display 4, on the basis of various demonstration commands having been transmitted from the main control circuit 50a. Here, the game effects may include graphics, sound effects, etc.

The sound output circuit 79 is configured so as to include a sound source ROM (not shown in the figure) and a work RAM (not shown in the figure), and controls sounds which are outputted to the speakers 80L, 80R. The sound output circuit 79 makes the speakers 80L, 80R generate predetermined audio, on the basis of various audio demonstration commands having been transmitted from the main control circuit 50a.

The LED control circuit 77 controls light generation of various LEDs 78 which decorate a game of the slot machine 1. The LED control circuit 77 makes LED 78 generate light with predetermined timing, on the basis of various LED demonstration commands having been transmitted from the main control circuit 50a.

The touch panel control circuit 76 controls the touch panel 30 and detects that a player touched a predetermined touch area image, and conveys the detection to the sub CPU 221. After that, the sub CPU 221 carries out control of a predetermined image, and thereby, various games are carried out and continued on the sub display 3 and the main display 4.

Meanwhile, in this embodiment, the sub control circuit 171 having been independent from the main control circuit 50a is to carry out controls of the sub display 3, the main display 4, the speakers 80L, 80R etc., and is to be a separate circuit having been independent from the main control circuit 50a and the sub control circuit 171, but this invention is not limited to this, and may be of such a configuration that the main control circuit 50a directly carries out controls of the sub display 3, the main display 4, the speakers 80L, 80R etc.

[Bonus Game Which Gaming Machine has]

The slot machine 1 in this embodiment has the following bonus games. That is, they are MAGIC LAMP BONUS, FORTUNE ISLAND BONUS, and BANDIT'S HIDEOUT BONUS. MAGIC LAMP BONUS, FORTUNE ISLAND BONUS, and BANDIT'S HIDEOUT BONUS are bonus games which are won when a win occurs in a winning combination of a bonus game, as described later, and when a dolphin (or a snake) demonstration is selected in a bonus game demonstration selection lottery which is carried out when a win occurs in a winning combination of a bonus game, MAGIC LAMP BONUS is won, and when a telescope demonstration is selected, BANDIT'S HIDEOUT BONUS is won, and when a bird demonstration is selected, FORTUNE ISLAND BONUS is won. In addition, even in case that the telescope demonstration is selected at this time, when a NUDGE demonstration (which is a demonstration for stopping a BONUS trigger symbol, by having reels spun again, after the reels are stopped once because of a loss. Here, to spin again includes both of to spin reels very little from the once stopped position up to a stop position to be aimed, and to spin reels again as per normal) is carried out, FORTUNE ISLAND BONUS is won. Generation processes and gaming natures of these bonus games will be described later.

[Progressive Game System]

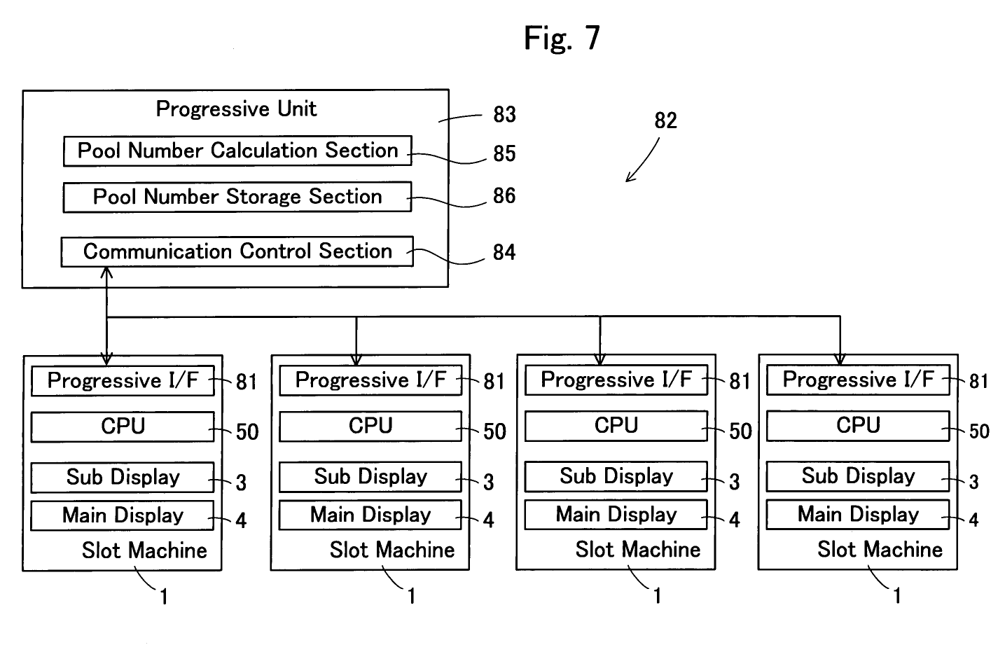

Next, a progressive game system, in which a plurality of units of slot machines 1 are connected through progressive interfaces 81 having been disposed in an attached fashion, respectively, will be described on the basis of FIG. 7. FIG. 7 is an explanatory view which schematically shows a progressive game system 82.

In the progressive game system 82 which is shown in FIG. 7, plural units (four units in this embodiment) of the slot machines 1 are connected to a communication control section 84 of a progressive unit 83 through the progressive interfaces 81 which are disposed in an attached fashion, respectively. Connection of the progressive unit 83 and each slot machine 1 is possible by use of any one of wired connection and wireless connection. By this means, the progressive unit 83 and each slot machine 1 are capable of two-way communication through the communication control section 84.

As information which is transmitted from each slot machine 1 to the progressive unit 83, there are coin entry number information of coins having been bet in each slot machine 1, and information when a character a player operates wins a battle with an enemy, at a final spot of a SUGOROKU (Japanese backgammon) game which is played in a game of FORTUNE ISLAND BONUS which will be described later. In addition, as information which is transmitted from the progressive unit 83 to each slot machine 1, there is coin pool number information which is a total sum of coin entry number information of coins having been bet in each slot machine 1. The suchlike coin pool number information is transmitted from the progressive unit 83 to each slot machine 1 through the communication control section 84, and displayed on the sub display 3 in each slot machine 1 at predetermined timing and time. A part or all of coins having been accumulated as a progressive value which the coin pool number information indicates are given as JACKPOT to a player of the slot machine 1 in which a character which a player operates could win (this is hereinafter called as FORTUNE ISLAND BONUS win) a battle with an enemy, at a final spot of the SUGOROKU game which is played in the game of FORTUNE ISLAND BONUS.

Then, a pool number calculation section 85 in the progressive unit 83 carries out addition of a common bonus, in which 1.7% (this invention is not limited to this) of the number of coins having been entered in each slot machine 1 is cumulatively added to an initial number, by use of 900 (this invention is not limited to this, and it is to be possible to change setup arbitrarily) as an initial number as to FORTUNE ISLAND BONUS, on the basis of coin entry information being transmitted from each slot machine 1.

Meanwhile, in each slot machine 1, in case that a player of any slot machine 1 obtained a payout of JACKPOT, the coin pool number information, which corresponds to the progressive value, is reset to the initial number. In addition, a pool number storage section 86 stores the coin number having been calculated in the pool number calculation section 85 as described above.

The progressive unit 83 having been configured as above transmits coin pool number information of each common bonus which is stored in the pool number storage section 86, from the communication control section 84 to each slot machine 1, on regular basis. In each slot machine 1, coin pool number having been transmitted previouly and coin pool number information having been transmitted this time are compared on regular basis, on the basis of coin pool information which is transmitted from the progressive unit 83, and in case that the this time coin pool number is smaller than the last time coin pool number, it is notified that there is a win as to FORTUNE ISLAND BONUS.

Therefore, even in case that information, which is transmitted from the progressive unit 83 to each slot machine 1, is restricted, it is notified to other slot machines 1 that a win of FORTUNE ISLAND BONUS occurrs, and therefore, it is possible for not only a player who wins but also a player of another slot machine 1 to easily confirm on the sub display 3 or the main display 4 that pools coins are distributed to FORTUNE ISLAND BONUS winning, and by this means, it is possible to increase an interest of a player to FORTUNE ISLAND BONUS to foster a seasoning. In addition, it is possible to carry out notification of winning with respect to each of plural common bonuses, and therefore, it is also possible to easily confirm that coins relating to which common bonus has been acquired.

In addition, in case that a win of FORTUNE ISLAND BONUS occurrs in the slot machine 1, the progressive unit 83 transmits coin pool number information of each progressive bonus which correlates with a bonus game, to each slot machine 1 through the communication control section 84, as described above, and in addition, in the slot machine 1, the coin pool number information is displayed on the sub display 3. By this means, it is possible to increase feeling of expectancy to, an interest in FORTUNE ISLAND BONUS winning and to foster a seasoning.

[Probability Lottery Table for Base Game]

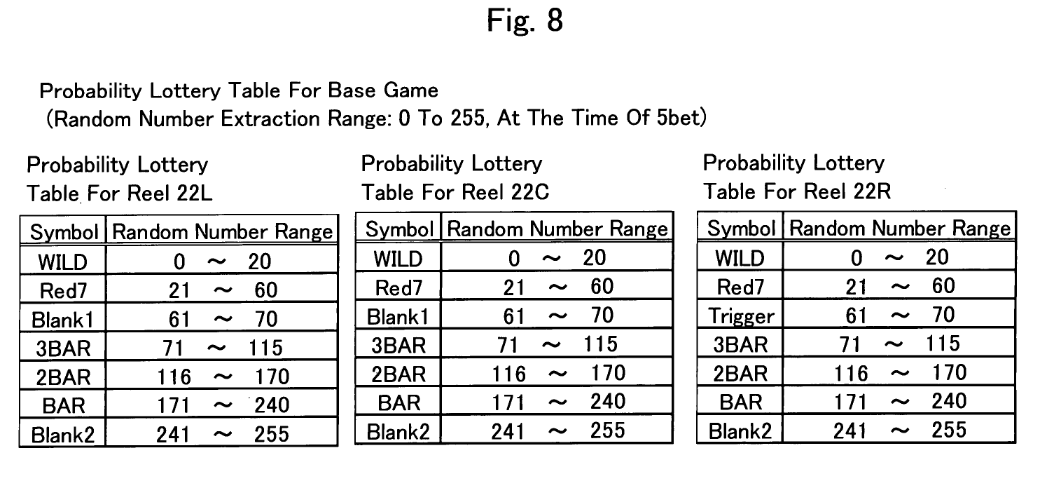

FIG. 8 is a probability lottery table which is used in probability lottery for determining a winning combination in a base game of the slot machine 1. Symbols to be appear are determined by which region an extracted random number value belongs to, for a symbol having been drawn on each reel 22L, 22C, 22R. A symbol of each reel 22L, 22C, 22R is determined on the basis of a random number value having been extracted independently, with respect to each reel 22L, 22C, 22R.

FIG. 8 is a probability lottery table showing which symbol is selected in each reel 22L, 22C, 22R to respective selected random number values, when the number of coins having been BET to the slot machine 1 by a player is 5, in a base game. For example, when a random number values having been selected by lottery to the reel 22L, is “10”, a symbol, which is shown by a stop of the reel 22L, is “WILD”, and when a random number value having been selected by lottery to the reel 22C, is “25”, a symbol, which is shown by a stop of the reel 22C, is “RED7”, and when a random number value having been selected by lottery to the reel 22R is “65”, a symbol, which is shown by a stop of the reel 22R, is the BONUS trigger symbol 93 (see, FIG. 4). In this manner, a symbol to appear for each reel 22L, 22C, 22R is determined.

Meanwhile, correspondence of symbols of a blank 1 and a blank 2 shown in FIG. 8, and a plurality of blank symbols 97 shown in FIG. 4 is not particularly limited. For example, when the blank 1 is selected in the reel 22L of the probability lottery table of FIG. 8, it is stop-controlled in such a matter that, in a symbol row of the reel 22L, any one of a symbol to which a code number “02” has been given and a symbol to which a code number “06” has been given is stopped on the winning line L. In the same manner, when the blank 2 is selected in the reel 22L of the probability lottery table of FIG. 8, it is stop-controlled in such a matter that, in the symbol row of the reel 22L of FIG. 4, any one of the symbol to which the code number “02” has been given and the symbol to which the code number “06” has been given is stopped on the winning line L.

[MAGIC LAMP BONUS Probability Lottery Table]

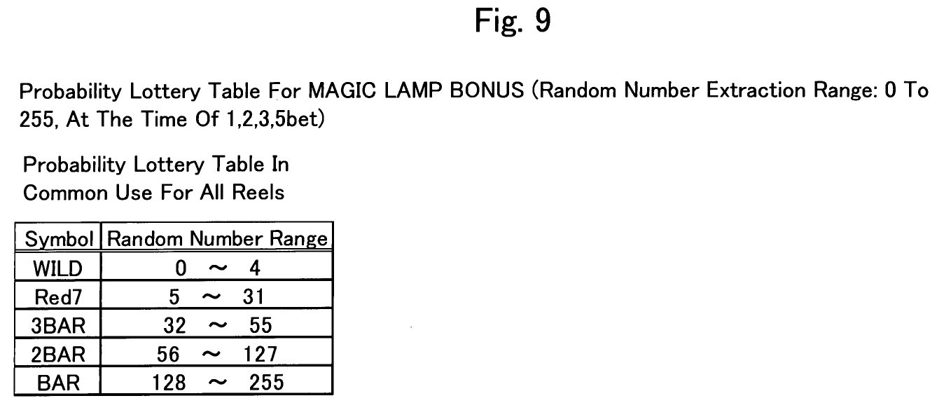

FIG. 9 is a probability lottery table which is used in probability lottery for determining a winning combination in a MAGIC LAMP BONUS game of the slot machine 1. Symbols to appear are determined by which region an extracted random number value belongs to, for a symbol having been drawn on each reel 22L, 22C, 22R. A symbol of each reel 22L, 22C, 22R is determined, on the basis of a random number value having been singly extracted, in common to each reel 22L, 22C, 22R. For example, when a random number value having been selected by lottery is “10”, symbols, which are shown by a stop of the reels 22L, 22C, 22R, are all “RED7”. In this manner, a symbol to appear for each reel 22L, 22C, 22R is uniquely determined to one random number value having been selected by lottery, and symbols having been determined are all identical. That is, in the MAGIC LAMP BONUS game, any one of winning combinations of “WILD”, “RED7”, “3BAR”, “2BAR”, and “BAR” is surely selected in probability lottery of a winning combination.

[Winning Combination Determination Table]

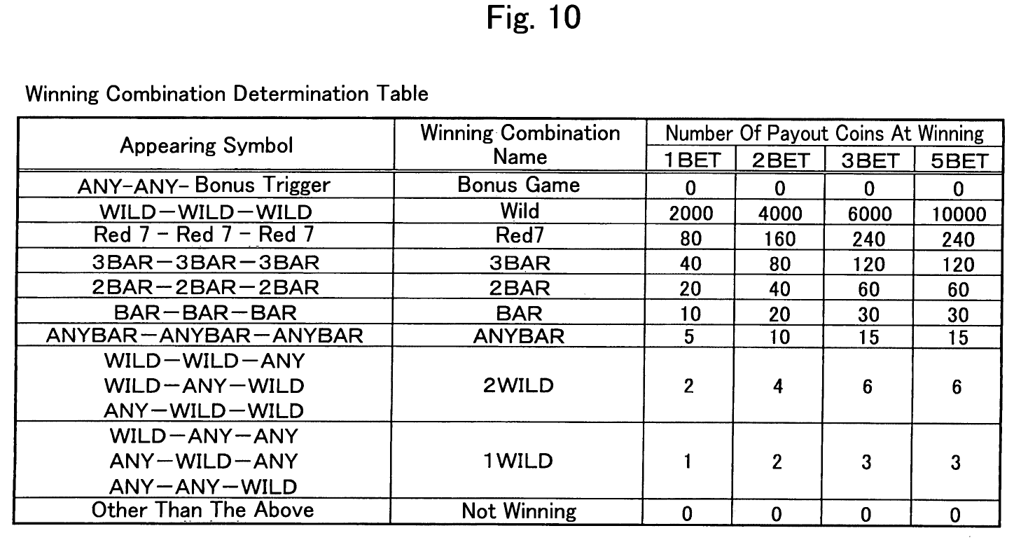

As described above, at the time of the base game of the slot machine 1, random number values, which are independent respectively, are extracted for each reel 22L, 22C, 22R, and on the basis of respective random number values, a stop symbol is determined with respect to each reel 22L, 22C, 22R. On this account, when each reel 22L, 22C, 22R is stopped, it becomes necessary to carry out processing for determining whether its symbol arrangement forms a winning combination or not. A winning combination determination table shown in FIG. 10 is a table which is used for this determination processing. When a symbol arrangement of each reel 22L, 22C, 22R is determined and the symbol arrangement is, for example, “RED7-RED7-RED7”, it is determined that a winning combination is “RED7”, and as shown in FIG. 10, a predetermined payout, which corresponds to BET number, is given to a player. In FIG. 10, such a matter that appearing symbols are of “ANYBAR-ANYBAR-ANYBAR” indicates that each appearing symbol of each reel 22L, 22C, 22R may be any one of “3BAR”, “2BAR”, and “BAR”. When a stop symbol is in other cases than a specific mode shown in FIG. 10, a winning combination is “LOSS” or “not-winning.”

Meanwhile, numerical values of winning time payout numbers which correspond to winning combination, shown in FIG. 10, are information which becomes the basis for information of a payout table which is displayed on the sub display 3 at the time of the base game or at the time of the MAGIC LAMP BONUS game, as described later. That is, at the time of the base game, the numerical values of winning time payout numbers which correspond to winning combination, shown in FIG. 10, are displayed on the payout table as they are, and at the time of the MAGIC LAMP BONUS game, such a numerical value that a numerical value of a payout number to each winning combination, which corresponds to the BET number of coins having been bet by a player when the MAGIC LAMP BONUS game is won, has been one-multiplied (i.e., in this case, there is no change of the numerical value), doubled or tripled is displayed on the payout table. For example, in case a player bets 2BET in a unit gaming in which the MAGIC LAMP BONUS game has been won and it is determined to double a payout as a result of a predetermined lottery, doubled numerical values for 2BET corresponding to each winning combination,in FIG. 10 are displayed on the payout table.

[Normal Image Selection Probability Table]

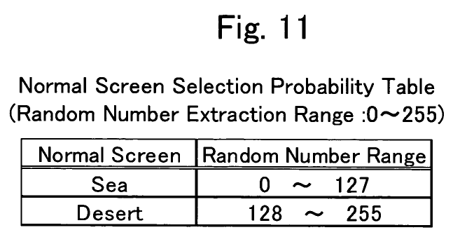

FIG. 11 is a probability lottery table which is used in lottery for selecting a demonstration screen to be displayed on the main display 4, when the base game is played in the slot machine 1. On the basis of an extracted random number value, lottery for selecting a demonstration screen to be displayed on the main display 4 is carried out, and on the basis of a normal screen having been determined at this time, demonstration, which is displayed on the main display 4, differs during a period of predetermined unit gaming. For example, when “SEA” is selected as the normal screen, such a demonstration that a main character comes across various events in the course of traveling in the sea is carried out on the main display 4, and when “DESERT” is selected as the normal screen, such a demonstration that a main character comes across various events in the course of traveling in the desert is carried out on the main display 4. When one random number is extracted and the random number is, for example, “100”, “SEA” is selected as the normal screen.

[Reel Stopping Order Determination Probability Lottery Table]

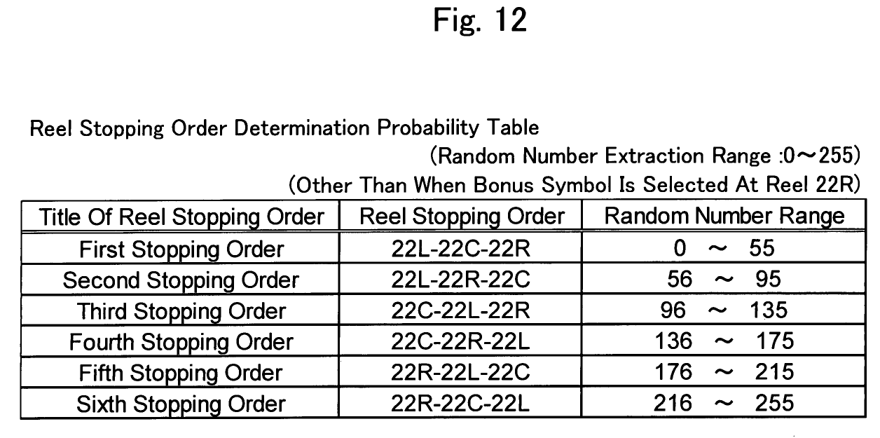

FIG. 12 is a probability lottery table which is referred to when reel stopping order determination probability lottery is carried out. A stopping order of the reels 22L, 22C, 22R is determined by lottery. This lottery is carried out at the time other than time when the BONUS trigger symbol 93 is selected for the reel 22R (i.e., when a winning combination is a bonus game). By such a matter that one random number is selected by lottery and the random number is included in a range relating to which stopping order, a stopping order of the reels 22L, 22C, 22R is determined in this embodiment. A stopping order in which a stopping order of the reels is 22L, 22C, 22R is called as a first stopping order, and a stopping order in which a stopping order of the reels is 22L, 22R, 22C is called as a second stopping order, and a stopping order in which a stopping order of the reels is 22C, 22L, 22R is called as a third stopping order, and a stopping order in which a stopping order of the reels is 22C, 22R, 22L is called as a fourth stopping order, and a stopping order in which a stopping order of the reels is 22R, 22L, 22C is called as a fifth stopping order, and a stopping order in which a stopping order of the reels is 22R, 22C, 22L is called as a sixth stopping order. For example, when an extracted random number value is “95”, the second stopping order (i.e., such a stopping order that the reels 22L, 22R, 22C are stopped in this order) is selected. The slot machine 1 stop-controls the reels 22L, 22C, 22R sequentially, in accordance with this selected stopping order.

[Bonus Game Demonstration Selection Probability Lottery Table]

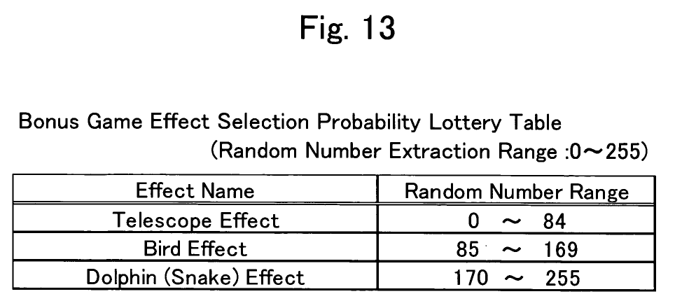

FIG. 13 shows a probability lottery table which is used for a selection of a demonstration which is carried out on the main display 4, when the BONUS trigger symbol 93 is selected for the reel 22R (i.e., when a winning combination is a bonus game) and the BET number of coins (the number of coins having been bet by a player to the normal game) is 5BET (5 coins). When demonstration is determined by this probability lottery, and thereby, it is determined that the BONUS trigger symbol 93 stops for the reel 22R, sorting of whether MAGIC LAMP BONUS is won, whether FORTUNE ISLAND BONUS is won, or whether BANDIT'S HIDEOUT BONUS is won is determined. For example, when one random number is extracted and the random number is “80”, a telescope demonstration is carried out on the main display, and BANDIT'S HIDEOUT BONUS is won for the last time. In this regard, however, as described later, in case of carrying out the NUDGE demonstration even if the telescope demonstration is carried out on the main display 4, FORTUNE ISLAND BONUS is won for the last time. In addition, when one random number is extracted and the random number is “150”, a bird demonstration is carried out on the main display 4, and FORTUNE ISLAND BONUS is won for the last time. In addition, when one random number is extracted and the random number is “200”, a dolphin (snake) effect is carried out on the main display 4, and MAGIC LAMP BONUS is won for the last time.

Meanwhile, When the BONUS trigger symbol 93 is selected for the reel 22R, and when the BET number of coins is 1BET(one coin), 2BET(two coins), or 3BET(three coins), lottery of a selection of a demonstration, which is carried on the main display 4, is not carried out, and when it is determined to stop the BONUS trigger symbol 93 for the reel 22R, it is necessarily controlled to win BANDIT'S HIDEOUT BONUS.

[NUDGE Demonstration Determination Probability Lottery Table at the Time of BONUS Trigger Symbol Selection]

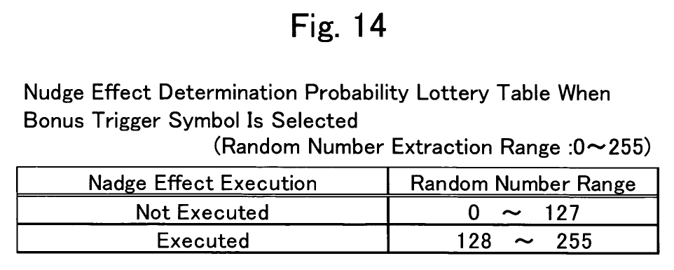

FIG. 14 shows a probability lottery table which is used on the occasion of determining whether NUDGE demonstration is carried out or not, when the BONUS trigger symbol 93 is selected for the reel 22R (i.e., when a winning combination is a bonus game). For example, when one random number is extracted, and the random number value is “100”, it is determined not to carry out the NUDGE demonstration, and on one hand, when it is “130”, it is determined to carry out the NUDGE demonstration. In accordance with this determination, the NUDGE demonstration is carried out so as to visually cooperate with each other, in the reel 22R and the main display 4 of the slot machine 1.

[Demonstration Which is Displayed on Main Display 4, Which Visually Cooperates with Base Game of Slot Machine 1]

As a demonstration which is displayed on the main display 4, which visually cooperates with the base game of the slot machine 1, there are following things. When spin of the reels 22L, 22C, 22R is started, demonstrations may be classified depending on a winning combination which has been already determined before spin of the reels 22L, 22C, 22R is stopped. Demonstrations are roughly classified into “telescope demonstration” and “bird demonstration” which are carried out when a winning combination is “a bonus game”, “succeeding game effect” which is carried out when a winning combination is “WILD”, “RED7”, “3BAR”, “2BAR”, “BAR”, and “ANYBAR”, and “failing game effect” which is carried out when a winning combination is “a loss”.

As to the “telescope demonstration” and “bird demonstration”, since a winning combination is “a bonus game” and it is determined in advance to stop the BONUS trigger symbol 93 on the reel 22R, they are demonstrations which are carried out when the BONUS trigger symbol 93 is brought to a stop.

As described above, whether either of “telescope demonstration” or “bird demonstration” is carried out is determined by the probability lottery, Further, “telescope demonstration” is basically a demonstration winning “BANDIT'S HIDEOUT BONUS”, and when the NUDGE demonstration is carried out, the “telescope demonstration” is a demonstration that “FORTUNE ISLAND BONUS” is won.

The “succeeding game effect” is a demonstration which is carried out when a winning combination is any one of “WILD”, “RED7”, “3BAR”, “2BAR”, “BAR”, and “ANYBAR”, and is further classified into a “dolphin succeeding game effect”, a “snake succeeding game effect”, a “seagull succeeding game effect”, a “buzzard succeeding game effect”, and a “monkey succeeding game effect”. The “dolphin succeeding game effect”, the “seagull succeeding game effect” and the “monkey succeeding game effect” are demonstrations which are carried out when “SEA” is selected as the normal screen. The “snake succeeding game effect”, the “buzzard succeeding game effect”, and the “monkey succeeding game effect” are demonstrations which are carried out when “DESERT” is selected as the normal screen.

The “dolphin succeeding game effect” and the “snake succeeding game effect” are such demonstrations that, in the base game, a dolphin or a snake appears on the main display 4 in tune with a stop of the reels 22L, 22C, 22R, and the dolphin or the snake hands a “lamp” over to a main character, in tune with before and after a spin stop of a reel which stops at the last. Then, a “spirit of lamp” appears from the “lamp”, and MAGIC LAMP BONUS is won.

Meanwhile, in such a method that a game effect, which is displayed on the main display 4, is controlled in tune with before and after a spin stop of a reel which stops, there are following three modes for details. In case a game effect, which is displayed on the main display 4, is controlled around when a reel stops spinning, there are three modes as follows.

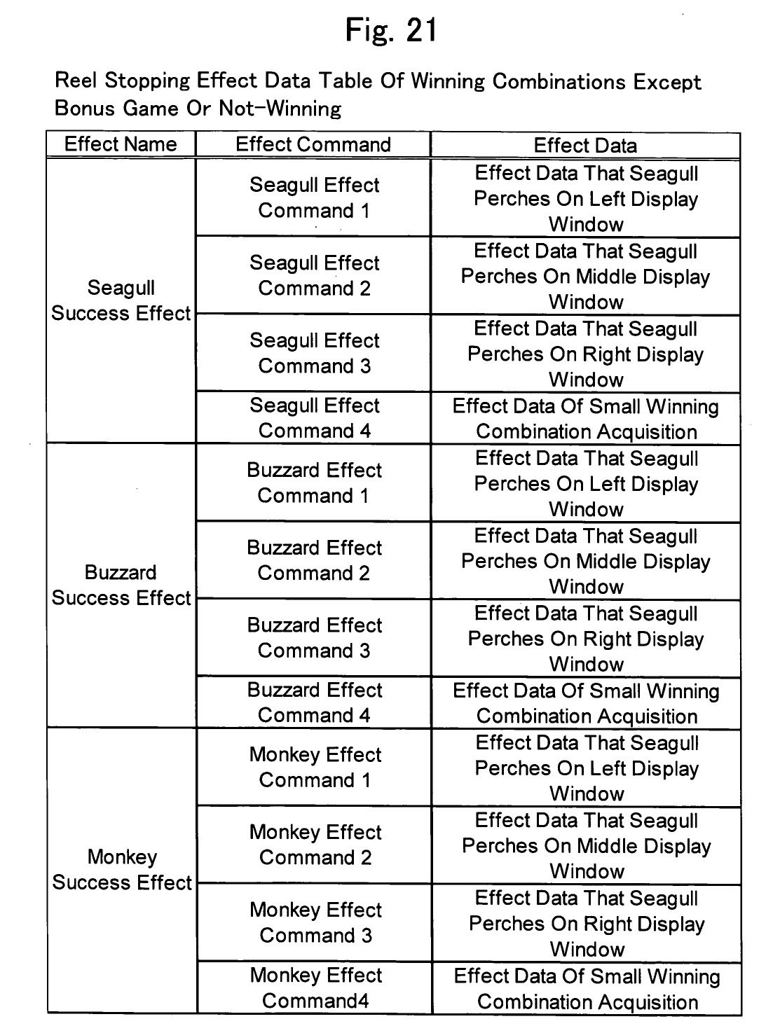

First one is of a case for carrying out an image demonstration after the reel stops. In this case, stop control of the reel is carried out, and at the same time, a demonstration command is transmitted. For example, when stop control of the reel 22C is carried out and at the same time, a demonstration command (e.g., seagull demonstration command 2 etc. of FIG. 21) relating to the reel 22C is transmitted, an image demonstration is started after the reel 22C stopped. Meanwhile, a similar control method is also applicable to the reels 22L, R. AS an example of this case, there are the seagull succeeding (or failing) demonstration etc.

Second one is of a case for carrying out an image demonstration before stop control of the reel. Predetermined demonstration execution time is defined for an image demonstration based on demonstration data which corresponds to each reel, respectively, and stop control of the reel is carried out after a demonstration command is transmitted and the predetermined demonstration execution time elapses. For example, demonstration execution time of two seconds is defined for an image demonstration based upon a demonstration command of the reel 22C, and after the lapse of the demonstration execution time of two seconds, stop control of the reel 22C is carried out. Meanwhile, a similar control method is also applicable to the reels 22L, R. As an example of this case, there are the monkey success (or failure) demonstration, the seagull succeeding (or failing) demonstration etc.

Third one is of a case for carrying out an image demonstration before and after stop control of a reel. Predetermined demonstration execution time is defined for an image demonstration based on demonstration data which corresponds to each reel, respectively, and stop control of a reel is carried out after a demonstration command is transmitted and the predetermined demonstration execution time elapses. For example, demonstration execution time of four seconds is defined for an image demonstration based upon a demonstration command of the reel 22C, and after the lapse of the demonstration execution time of two seconds, stop control of the reel 22C is carried out. Even after the reel 22C is stop-controlled, the image demonstration is carried out over remaining two seconds. Meanwhile, a similar control method is also applicable to the reels 22L, R.

The “seagull succeeding game effect” and the “buzzard succeeding game effect” are such demonstrations that, in the base game, a seagull or a “buzzard” appears on the main display 4 in tune with a stop of the reels 22L, 22C, 22R, and the “seagull” or the “buzzard” stays in frames of the display windows 23, 24, 25 of the reels, in tune with before and after respective spin stops of the reels 22L, 22C, 22R. According to this demonstration, the “seagull” or the “buzzard” stays in frames of the display windows 23, 24, 25, and thereby, it is possible to notify to a player that there is such a possibility that a specific winning combination is realized.

The “monkey succeeding game effect” is such a demonstration that, in the base game, a “monkey” appears on the main display 4 in tune with stops of the reels 22L, 22C, 22R, and the “monkey” hangs down on any one of the display windows 23, 24, 25 of a reel which stops next, right before respective spin stops of the reels 22L, 22C, 22R. According to this demonstration, the “monkey” hangs down on any one of the display windows 23, 24, 25 of a reel which stops next, and thereby, it is possible to notify to a player a reel which stops next, and it is possible to notify to a player that there is such a possibility that a specific winning combination is realized.

The “failing game effect” is a demonstration which is carried out when a winning combination is a “loss”, and is further classified into “dolphin failing game effect”, “snake failing game effect”, “seagull failing game effect”, “buzzard failing game effect”, “monkey failing game effect”, “telescope failing game effect”, and “bird failing game effect”. The “dolphin failing game effect”, the “seagull failing game effect”, the “monkey failing game effect”, the “telescope failing game effect”, and the “bird failing game effect” are demonstrations which are carried out when “SEA” is selected as the normal screen. The “snake failing game effect”, the “buzzard failing game effect”, the “monkey failing game effect”, the “telescope failing game effect”, and the “bird failing game effect” are demonstrations which are carried out when “DESERT” is selected as the normal screen. The “failing game effect” which is carried here is dependent on a stopping order of the reels 22L, 22C, 22R. When a stopping order of the reels 22L, 22C, 22R is the first stopping order, one demonstration is selected by lottery out of the “dolphin (snake) failing game effect”, the “seagull (buzzard) failing game effect”, the “monkey failing game effect”, the “telescope failing game effect”, and the “bird failing game effect”, but when a stopping order of the reels 22L, 22C, 22R is other than the first stopping order, one demonstration is selected by lottery out of the “dolphin (snake) failing game effect”, the “seagull (buzzard) failing game effect”, and the “monkey failing game effect”. When it is determined to stop the BONUS trigger symbol 93 for the reel 22R, spin of the reels 22L, 22C, 22R is surely stopped in the first stopping order, and therefore, inversely, even when spin of the reels 22L, 22C, 22R are stopped in the first stopping order, in case that a winning combination is a “loss” or “not-winning”, this has such an advantage that feeling of expectancy is given to a player as to such a possibility that the BONUS trigger symbol 93 stops for the reel 22R.

[Demonstration Selection Probability Lottery Table Which Corresponds to Winning Combination (Except for Bonus Game and Loss)]

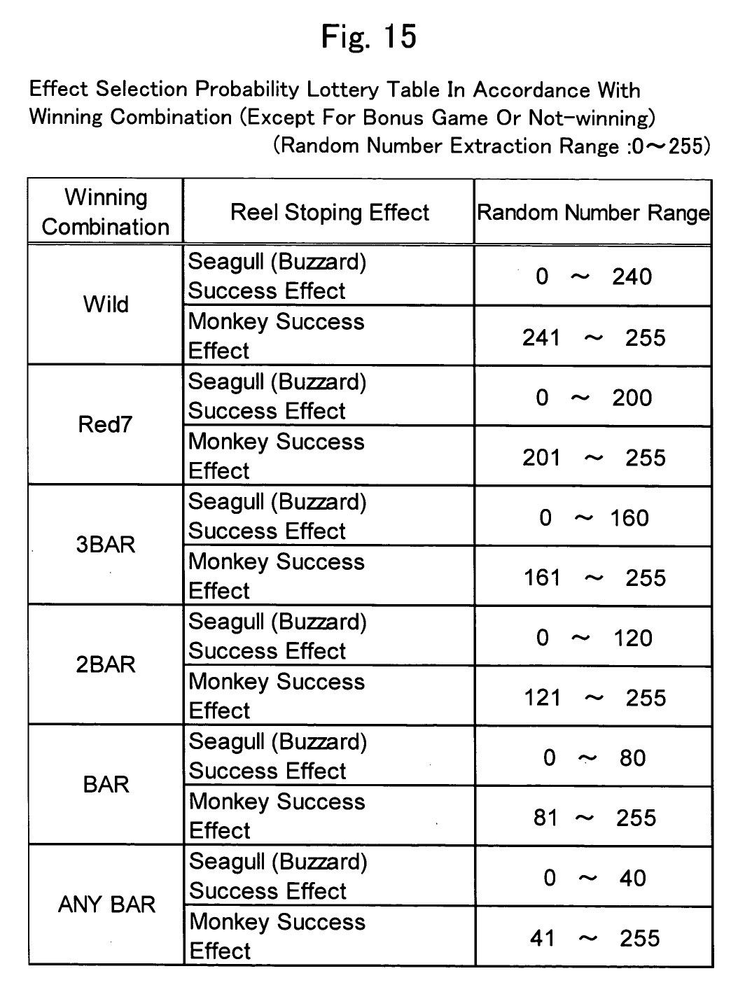

FIG. 15 is a probability lottery table used for lottery, in which the “succeeding game effect” is selected in accordance with a winning combination other than a bonus game and a loss.

When the normal screen is of “SEA”, a demonstration is selected by lottery with predetermined probability from three demonstrations of the “dolphin succeeding game effect”, the “seagull succeeding game effect”, and the “monkey succeeding game effect”, and when the normal screen is of “DESERT”, a demonstration is selected by lottery with predetermined probability from three demonstrations of the “buzzard succeeding game effect”, the “snake succeeding game effect”, and the “monkey succeeding game effect”. Which demonstration is selected by lottery differs depending on a winning combination as shown in FIG. 15. A feature of probability distribution of the lottery is that such probability that the “seagull (buzzard” succeeding game effect” is selected by lottery is high, in case of a winning combination having low winning probability like “WILD”. In this manner, by differentiating such probability that a demonstration is selected, with respect to each winning combination, it is possible to improve versatility of demonstrations.

[Failure Demonstration Selection Probability Lottery Table when Winning Combination is Loss (or Not-Winning)]

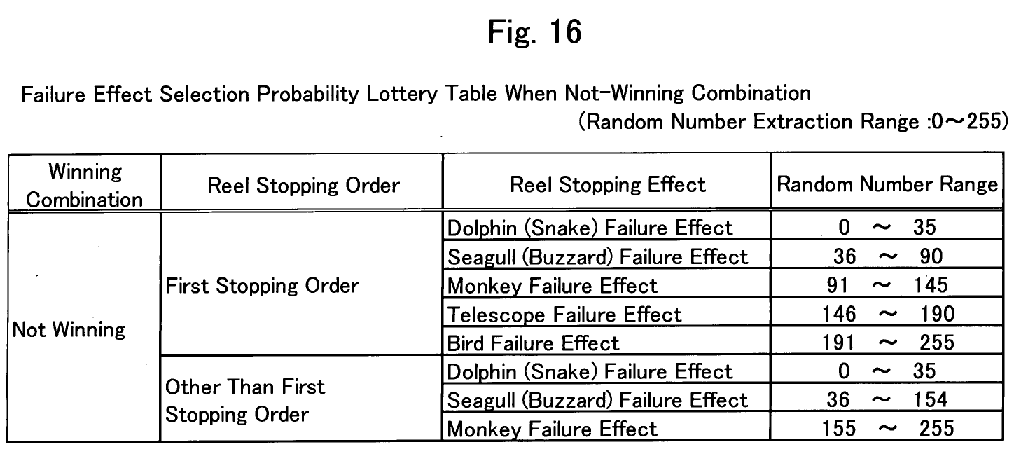

FIG. 16 is a probability lottery table used for lottery, in which the “failing game effect” is selected in accordance with a stopping order of the reels 22L, 22C, 22R.

When a stopping order of the reels 22L, 22C, 22R is the first stopping order and the normal screen is of “SEA”, a demonstration is selected by lottery with predetermined probability from five demonstrations of the “dolphin failure game effect”, the “seagull failure game effect”, the “monkey failure game effect”, the “telescope failure game effect”, and the “bird failure game effect”, and when the normal screen is of “DESERT”, a demonstration is selected by lottery with predetermined probability from five demonstrations of the “buzzard failure game effect”, the “snake failure game effect”, the “monkey failure game effect”, the “telescope failure game effect”, and the “bird failure game effect”. Which demonstration is selected for one extracted random number value is as shown in FIG. 16.

In addition, when a stopping order of the reels 22L, 22C, 22R is other than the first stopping order and the normal screen is of “SEA”, a demonstration is selected by lottery with predetermined probability from three demonstrations of the “dolphin failure game effect”, the “seagull failure game effect”, and the “monkey failure game effect”, and when the normal screen is of “DESERT”, a demonstration is selected by lottery with predetermined probability from three demonstrations of the “buzzard failure game effect”, the “snake failure game effect”, and the “monkey failure game effect”. Which demonstration is selected for one extracted random number value is as shown in FIG. 16.

[MAGIC LAMP BONUS Completion Prediction Demonstration Probability Lottery Table]

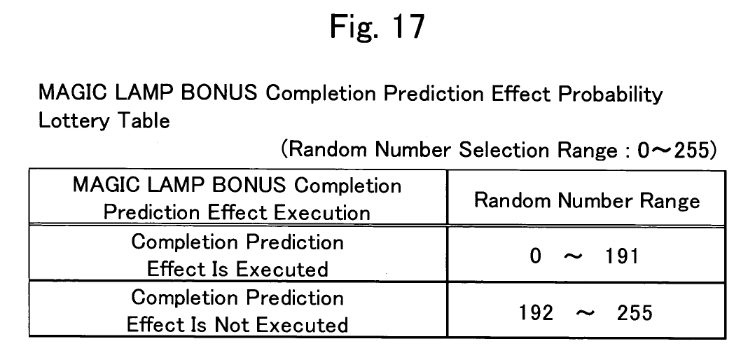

FIG. 17 shows a probability lottery table which is used for lottery which determines whether a demonstration showing such prediction that MAGIC LAMP BONUS is completed is carried out or not, after MAGIC LAMP BONUS was carried out and execution of predetermined number of times (three times in this embodiment, but not limited to this) elapses. A selection of whether MAGIC LAMP BONUS completion prediction is carried out or not for one extracted random number value is determined in accordance with what is shown in FIG. 17.

[MAGIC LAMP BONUS Completion Probability Lottery Table when MAGIC LAMP BONUS Completion Prediction Demonstration is Carried Out]

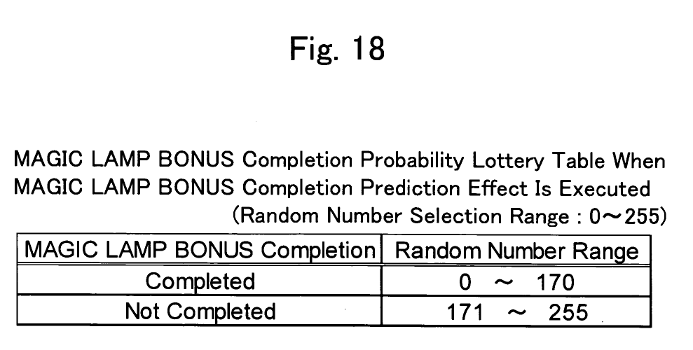

FIG. 18 shows a probability lottery table which is used for lottery which determines whether MAGIC LAMP BONUS is actually completed or not, when it is determined to carry out a demonstration which shows such prediction that MAGIC LAMP BONUS is completed, after MAGIC LAMP BONUS is carried out and execution of predetermined number of rounds (three times (or three rounds) in this embodiment, but not limited to this) is made. A selection of whether MAGIC LAMP BONUS is completed or not for one extracted random number value is determined in accordance with what is shown in FIG. 18.

[Payout Display Change Pattern Probability Lottery Table]

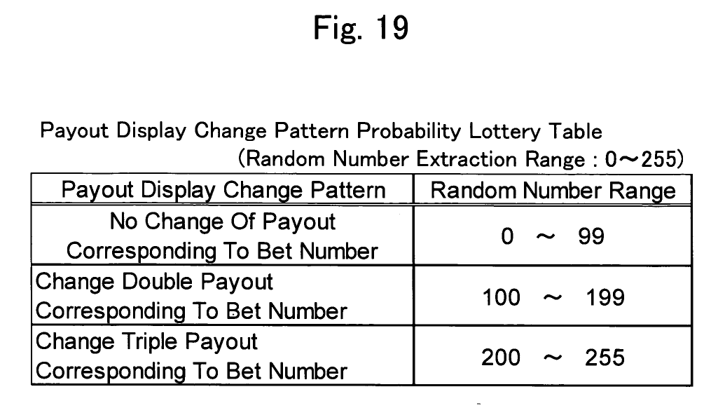

FIG. 19 shows a payout table which is used for lottery which determines a change pattern for changing payout information relating to a payout which is given to a player in accordance with BET number, when MAGIC LAMP BONUS is won. On the basis of this changed payout information, a payout table, which is displayed on the sub display 3, is changed. Payout information, which is changed when MAGIC LAMP BONUS is won, is only payout information which corresponds to BET number in a unit game in which MAGIC LAMP BONUS is won. For example, in a game in which MAGIC LAMP BONUS is won, in case a player bets 2BET (two coins are bet for a game), only payout information in case of 2BET is changed. As a change pattern of payout information, there are three patterns of “No Change of Payout which corresponds to relevant BET number”, “Change Payout, which corresponds to relevant BET number to Double”, and “Change Payout, which corresponds to relevant BET number to Triple”, in this embodiment (this invention is not limited to this, and it is all right even if various methods such as magnification being selected by lottery and payout number being determined by lottery are used). Which change pattern is selected for one extracted random number is as shown in FIG. 19.

As above, various probability lottery tables are described, but this invention is not limited to these, and as to probability distribution and variations of options which may be selected by lottery, it is possible to carry out design changes for them, in order to heighten a gaming nature.

[Normal Screen Demonstration Data Table]

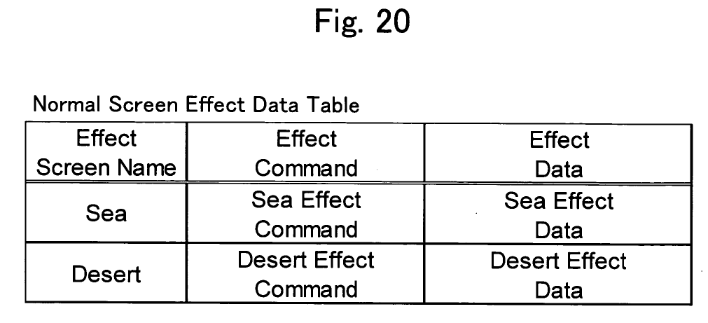

FIG. 20 is a view showing a table storing demonstration commands for instructing normal screen demonstrations and demonstration data. This table is stored in the sub ROM 223 of the sub control circuit 171 in a predetermined data format. In addition, demonstration commands are stored in ROM 51 of the main control circuit 50a. When the main control circuit 50a instructs the sub control circuit 171 execution of a predetermined demonstration, a relevant demonstration command is read out from ROM 51, and the demonstration command is transmitted to the sub control circuit 171. In the sub control circuit 171 receiving the command, the sub CPU 221 reads out demonstration data which corresponds to the received command, from ROM 223, and displays a game effect to be aimed, on the main display 4, by driving the image display control circuit 75. Meanwhile, a storing method of a demonstration data table, a transmission method of a demonstration command, each processing which is carried out in accordance with reception of the demonstration command, etc. are similar in “a reel stop demonstration data table of a winning combination except for a bonus game and a loss”, “a reel stop demonstration data table when a winning combination is a loss”, “a MAGIC LAMP BONUS state game demonstration data table”, “a MAGIC LAMP BONUS completion demonstration data table”, “a bonus game demonstration data table”, “a BANDIT'S HIDEOUT BONUS demonstration data table”, and “a FORTUNE ISLAND BONUS demonstration data table”, which will be described later. As normal screens, there are “SEA” and “DESERT”, and demonstration commands and demonstration data of them are “a SEA demonstration command” and “SEA demonstration data”, “a DESERT demonstration command” and “DESERT demonstration data”.

[Reel Stop Demonstration Data Table of Winning Combination Except for Bonus Game and Loss]

FIG. 21 is a view showing a table storing a demonstration command, which instructs a reel stop demonstration, and demonstration data of a winning combination except for a bonus game or a loss. In this table, a demonstration command and demonstration data relating to the “succeeding game effect” are placed. As a reel stop demonstration of a winning combination except for a bonus game or a loss, there are the “seagull succeeding game effect”, the “buzzard succeeding game effect”, and the “monkey succeeding game effect”, and respective demonstration commands and demonstration data are as shown in FIG. 21.

[Reel Stop Demonstration Data Table when Winning Combination is Loss]

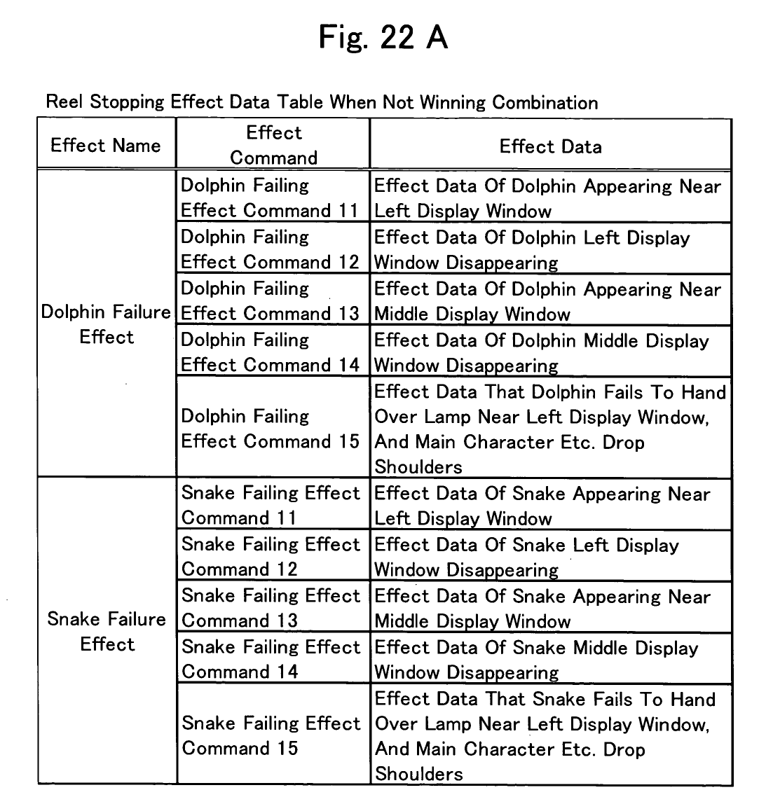

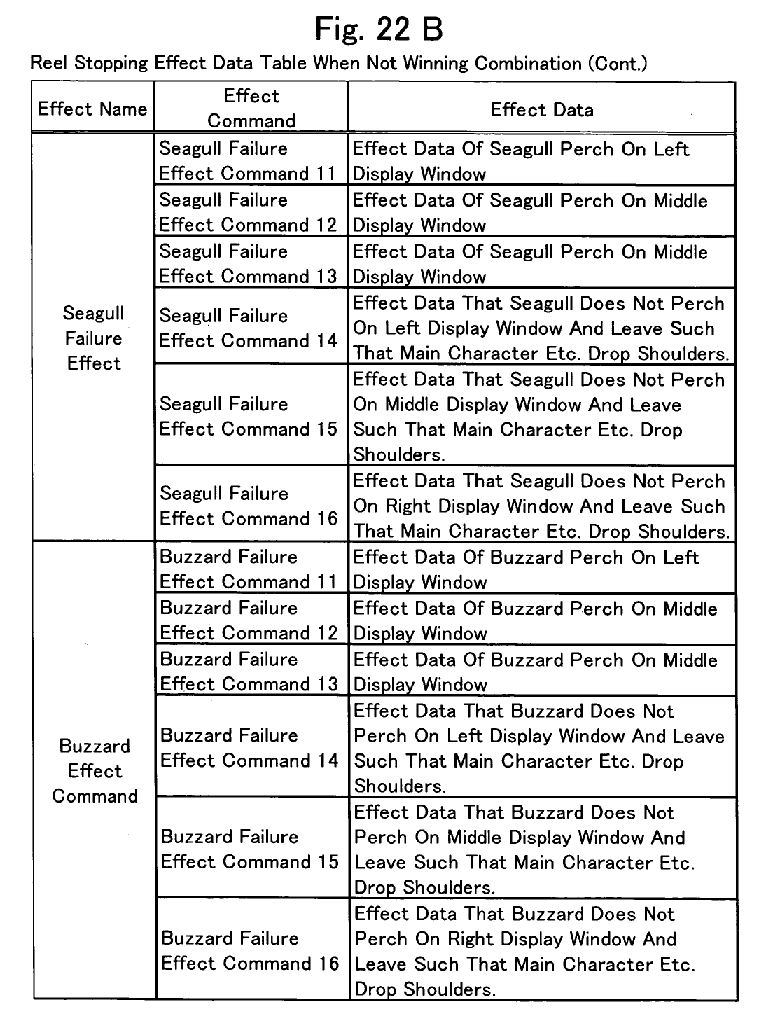

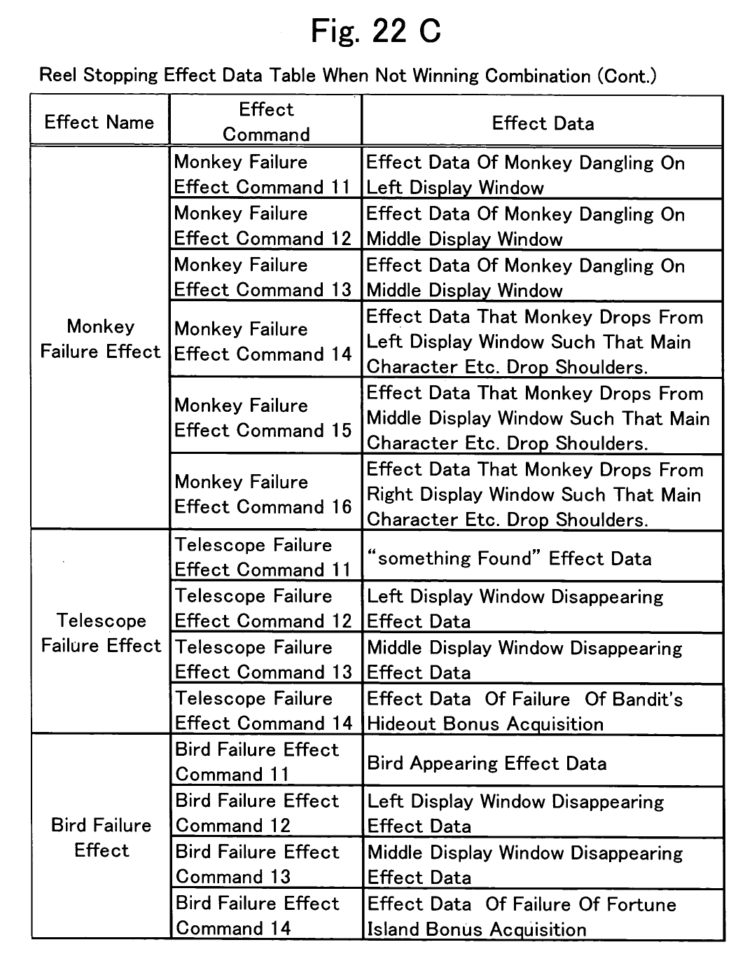

FIG. 22 is a view showing a table which stored a demonstration command, which instructs a reel stop demonstration when a winning combination is a loss, and demonstration data. In this table, demonstration commands and demonstration data relating to the “failure game effect” are placed. As a reel stop demonstration when a winning combination is a loss, there are the “dolphin failing game effect”, the “snake failing game effect”, the “seagull failing game effect”, the “buzzard failing game effect”, the “monkey failing game effect”, the “telescope failing game effect”, and the “bird failing game effect”, and respective demonstration commands and demonstration data are as shown in FIGS. 22A-C.

[MAGIC LAMP BONUS State Game Demonstration Data Table]

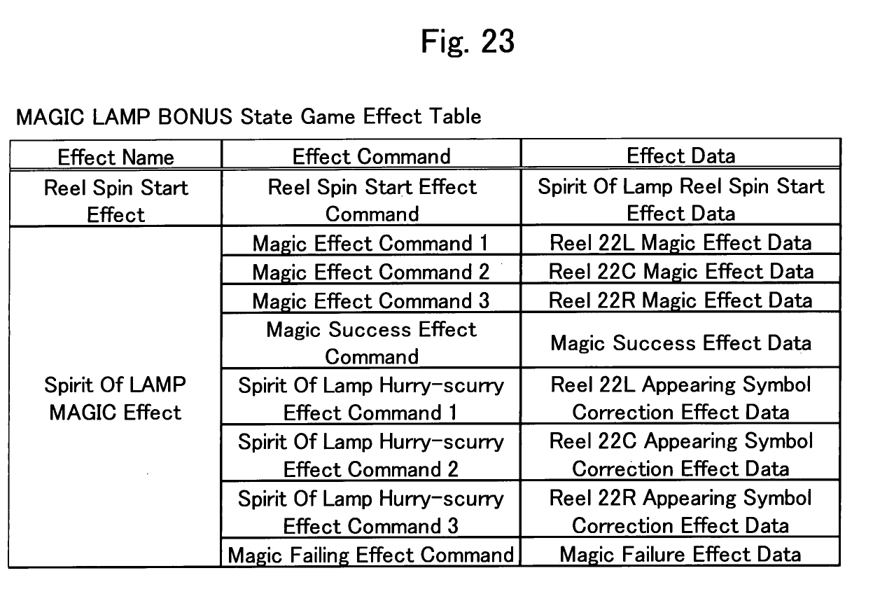

FIG. 23 is a view showing a table storing a demonstration command, which instructs a MAGIC LAMP BONUS state game demonstration, and demonstration data. In this table, data of game effect which are displayed on the main display 4 during a period of MAGIC LAMP BONUS execution. As a MAGIC LAMP BONUS state game demonstration, there are “reel rotation start demonstration”, and “spirit of lamp magic demonstration”, and respective demonstration commands and demonstration data are as shown in FIG. 23.

[MAGIC LAMP BONUS Completion Demonstration Data Table]

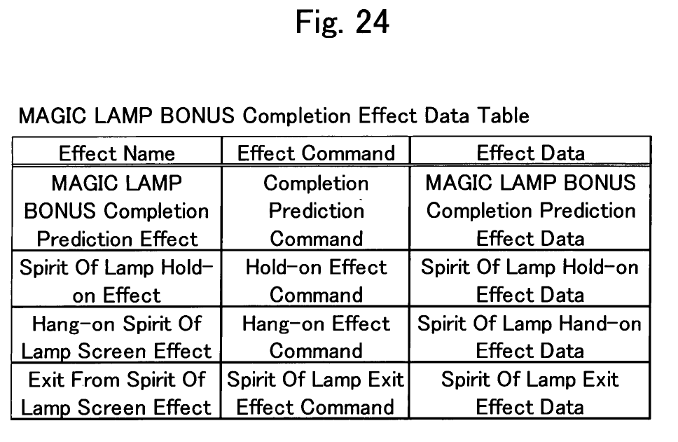

FIG. 24 is a view showing a table storing a demonstration command, which instructs a MAGIC LAMP BONUS completion demonstration, and demonstration data. This table has data of game effect for displaying a demonstration of such prediction that MAGIC LAMP BONUS is completed during a period of MAGIC LAMP BONUS execution and a demonstration of completing MAGIC LAMP BONUS, on the main display 4. As a MAGIC LAMP BONUS completion demonstration, there are “MAGIC LAMP BONUS completion prediction demonstration”, “spirit of lamp holding-on demonstration”, “demonstration of hanging on a spirit of lamp screen”, and “demonstration of exiting from the spirit of lamp screen”, and respective demonstration commands and demonstration data are as shown in FIG. 24.

[Bonus Game Demonstration Data Table]

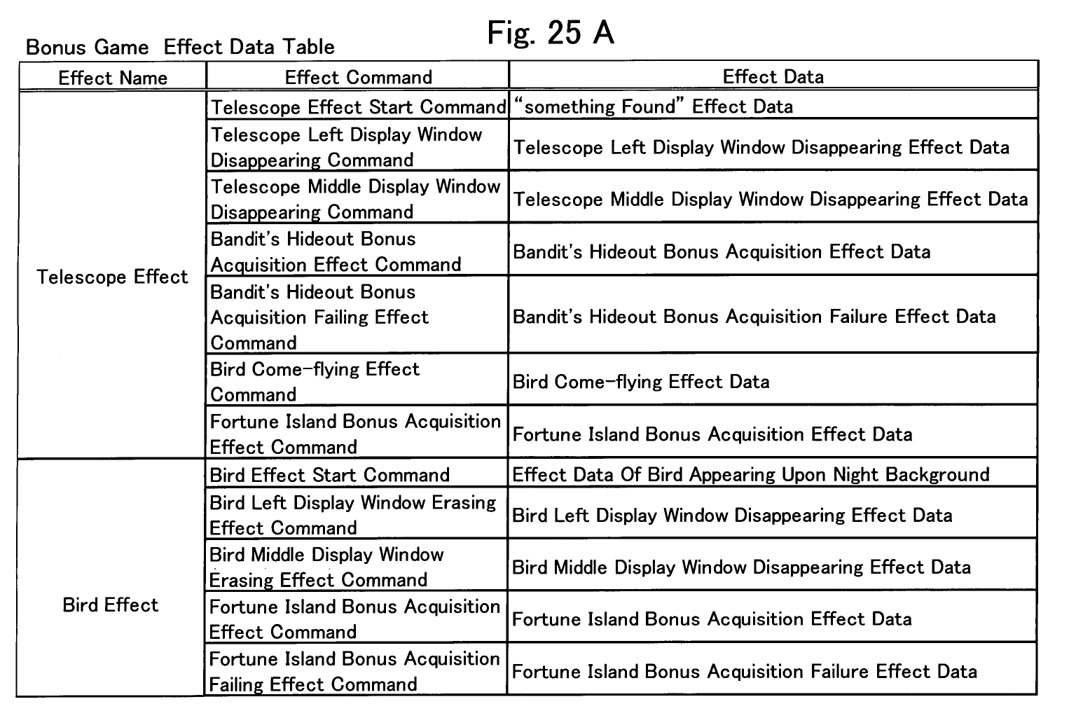

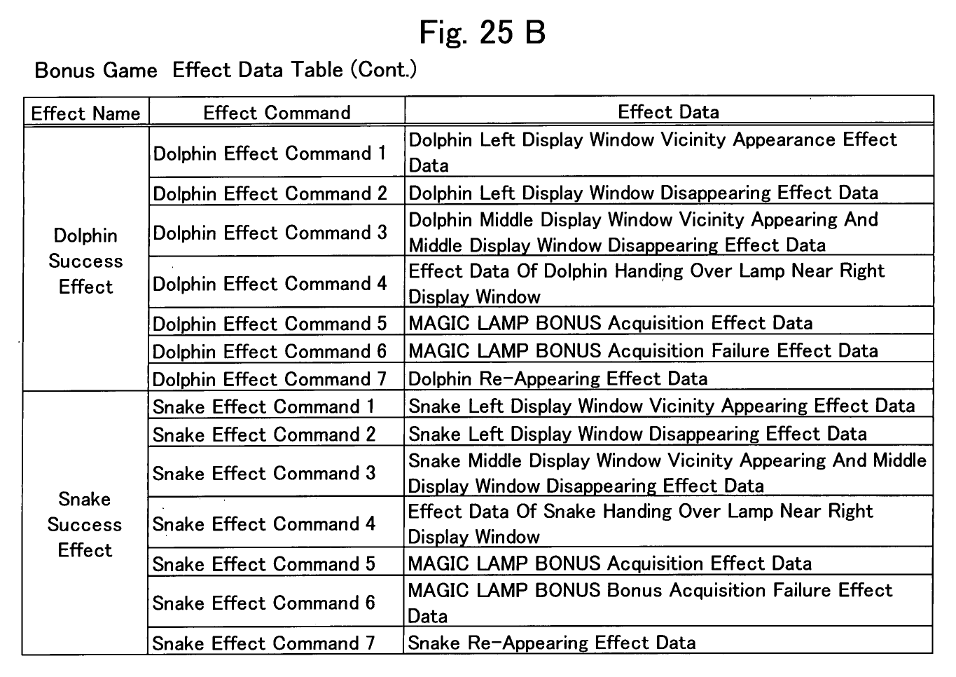

FIG. 25 is a view showing a table storing a demonstration command, which instructs a bonus game demonstration and demonstration data. This table has data of game effect for displaying a demonstration at the time of when the “bonus game” is selected as a winning combination, or when the “loss” is selected as a winning combination but a stopping order of the reels 22L, 22C, 22R is the first stopping order and the “telescope failing game effect”, the “bird failing game effect”, the “dolphin succeeding game effect”, or the “snake succeeding game effect” is selected as the “failing game effect”, on the main display 4. Demonstration commands and demonstration data for respective bonus game demonstrations are as shown in FIG. 25.

[BANDIT'S HIDEOUT BONUS Demonstration Data Table]

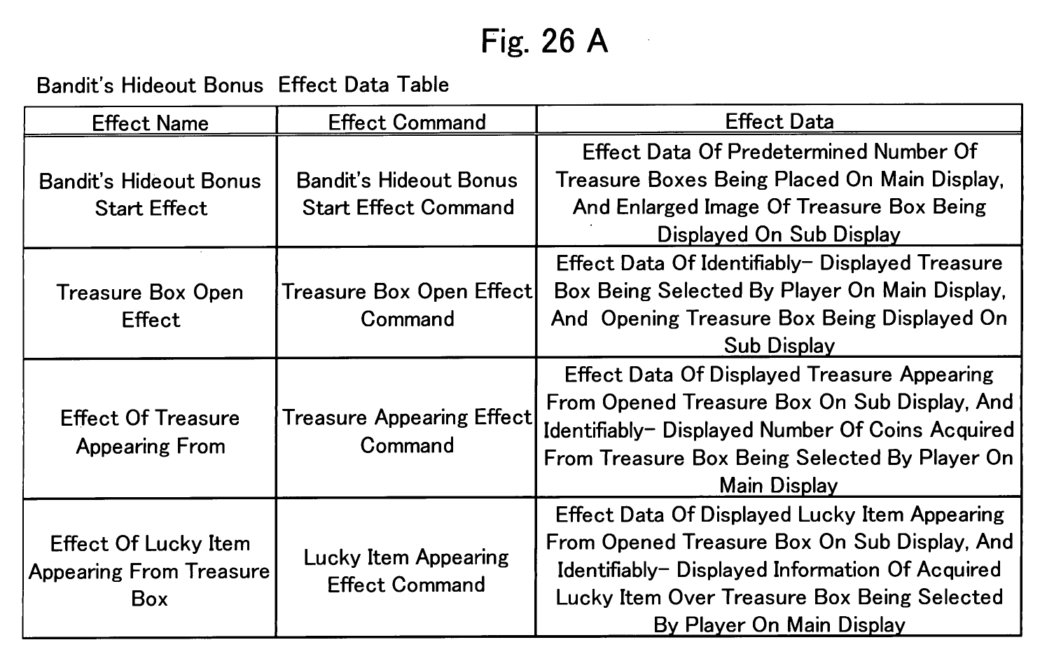

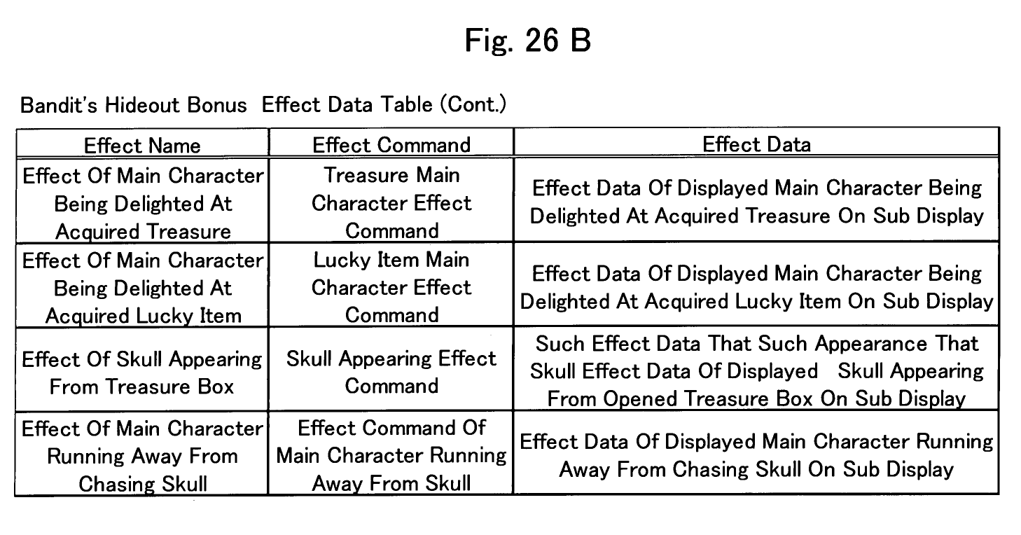

FIG. 26 is a view showing a table storing a demonstration command, which instructs a BANDIT'S HIDEOUT BONUS execution demonstration and demonstration data. This table has data of game effect for displaying execution game effect of BANDIT'S HIDEOUT BONUS on the main display 4, when a bonus game is selected as a winning combination and the telescope demonstration is further selected in bonus game demonstration selection probability lottery (this lottery is carried out only at the time of 5BET) and BANDIT'S HIDEOUT BONUS occurs and is carried out. As a BANDIT'S HIDEOUT BONUS execution demonstration, there are “BANDIT'S HIDEOUT BONUS start demonstration”, “treasure box open demonstration”, “such a demonstration that treasure appears from the treasure box”, “a lucky item appears from the treasure box”, “demonstration of a main character who has obtained the treasure box to feels delight”, “such a demonstration that a skeleton appears from the treasure box”, and “demonstration of a main character who is chased by a skull and runs away”, and respective demonstration commands and demonstration data are as shown in FIGS. 26A-B.

[FORTUNE ISLAND BONUS Demonstration Data Table]

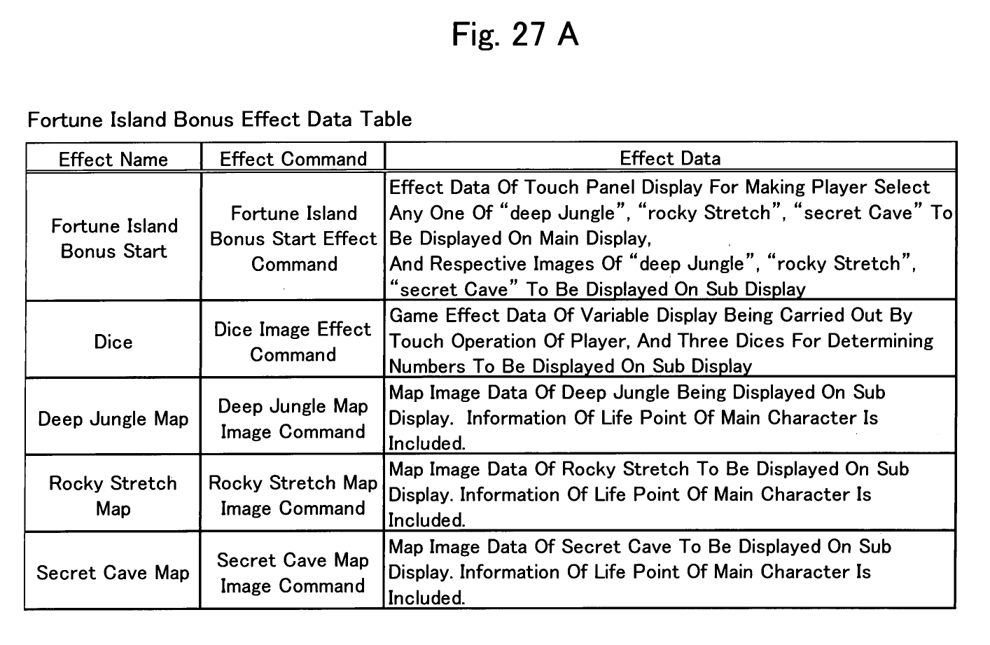

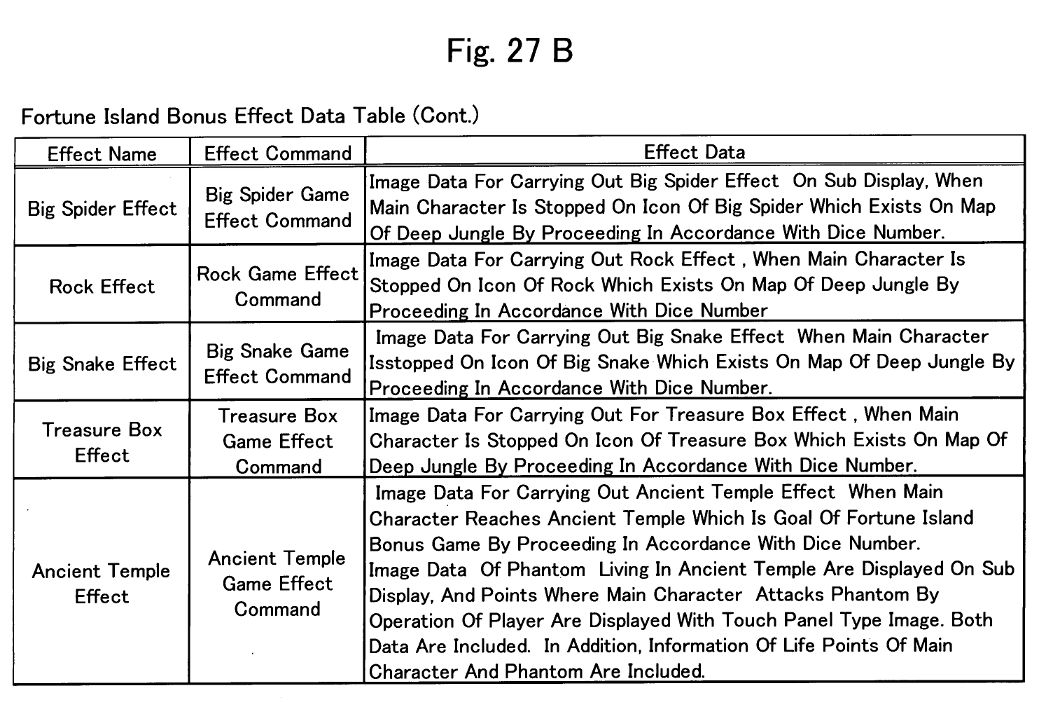

FIGS. 27A-B show a table storing a demonstration command, which instructs execution of FORTUNE ISLAND BONUS demonstration, and demonstration data. This table has data of game effects for displaying FORTUNE ISLAND BONUS execution game effects on the main display 4, in case that a bonus game is selected as a winning combination and the bird demonstration is further selected in bonus game demonstration selection probability lottery (this lottery is carried out only at the time of 5BET), or when the telescope demonstration was selected in the bonus game demonstration selection probability lottery at the time of 5BET, but it is determined to carry out the NUDGE demonstration and therefore, FORTUNE ISLAND BONUS is won for the last time and is carried out. As a FORTUNE ISLAND BONUS execution demonstration, there are “FORTUNE ISLAND BONUS start demonstration”, “dice”, “DEP JUNGLE map”, “ROCKY STRETCH map”, “SECRET CAVE map”, “big spider demonstration”, “rock demonstration”, “big snake demonstration”, “treasure box demonstration”, and “temple demonstration”, and respective demonstration commands and demonstration data are as shown in FIGS. 27A-B.

[Control Operation of Slot Machine 1]

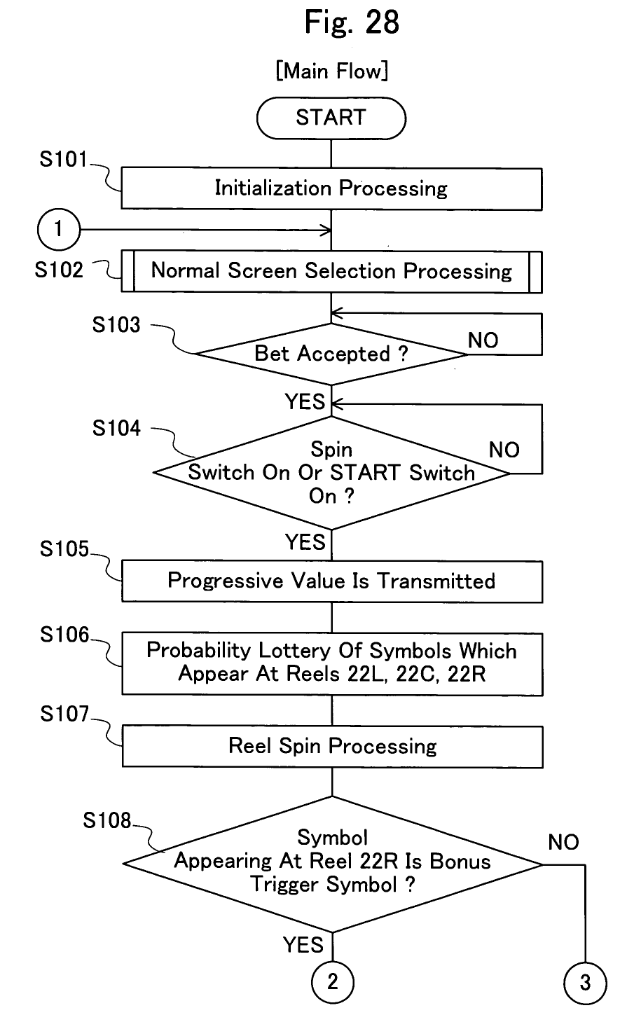

With reference to FIGS. 28 to 41, flows of various control operations, which are carried out in the main control circuit 50a and the sub control circuit 171 of the slot machine 1, will be described.

[Main Flow Chart of Main Control Circuit 50a]

With reference to FIG. 28, main processing, which is carried out in the main control circuit 50a, will be described.

In a step S101, various initialization processing at the time of power-on is carried out. The main control circuit 50a (see, FIG. 5) carries out initialization etc. of various variables (normal screen selection counter etc.) which are stored in RAM 52 (see, FIG. 5).

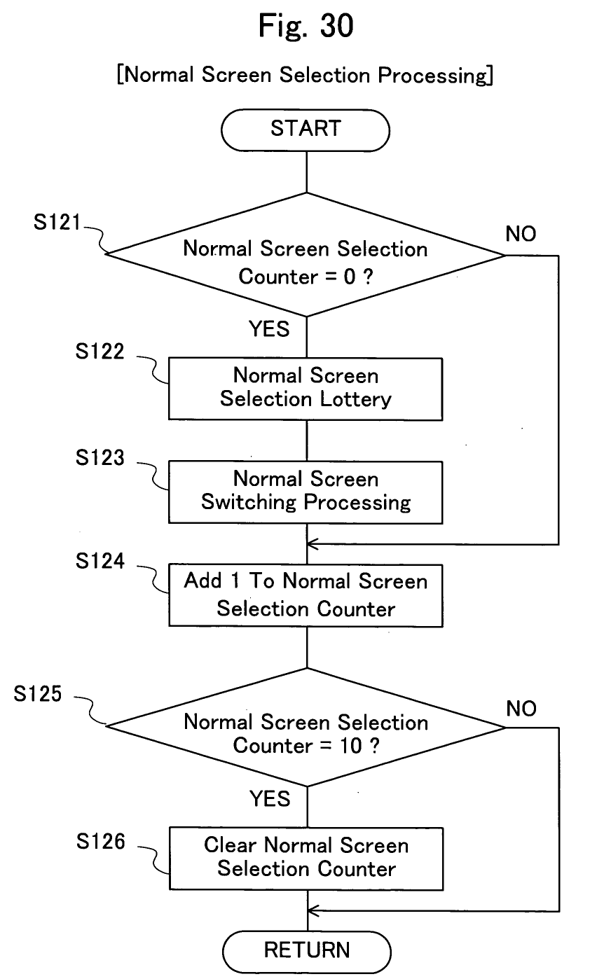

Next, in a step S102, normal screen selection processing is carried out. Details of this processing will be described in details of normal screen selection processing of FIG. 30, which will be described later.

Next, in a step S103, BET reception processing is carried out. Determination of whether or not the main control circuit 50a detected that a BET operation was made by such a matter that various BET switches of the 1-BET switch 59 (see, FIG. 5), the 3-BET switch 60 (see, FIG. 5) and the 5-BET switch 61 (see, FIG. 5) are operated by a player, is carried out. When this determination is Yes, processing is shifted to a step S104, and when it is NO, the step S103 is repeated.

Next, in the step S104, determination of whether the SPIN switch 58 (see, FIG. 5) or the start switch 57 (see, FIG. 5) has been turned ON or not is carried out. The main control circuit 50a determines whether the SPIN switch 58 or the start switch 57 has been turned ON or not. When this determination is YES, processing is shifted to a step S105, and when it is NO, the step S104 is repeated.

Next, in the step Si 05, transmission processing of a progressive value is carried out. The main control circuit 50a transmits a predetermined proportion out of BET number having been accepted in the step S103, as a progressive value, to the progressive unit 83 through the progressive I/F 81 (see, FIG. 5).

Next, in a step S106, processing for determining symbols which appear on the reels 22L, 22C, 22R (see, FIG. 5) by probability lottery is carried out. The main control circuit 50a controls the random number sampling circuit 56 (see, FIG. 5) and extracts three in total of random number values which corresponds to the reels 22L, 22C, 22R, respectively, from random number values which the random number generator 55 (see, FIG. 5) generates. The main control circuit 50a further determines an appearing symbol of each reel 22L, 22C, 22R, on the basis of respective random number values, and with reference to respective probability lottery tables of the reels 22L, 22C, 22R for a base game, shown in FIG. 8. As to the determined appearing symbols, code numbers shown in FIG. 4, which correspond to respective symbols, are stored in RAM 52.

Next, in a step S107, reel spin processing is carried out. The main control circuit 50a controls the motor drive circuit 67 (see, FIG. 5) to start drive of the stepping motors 68L, 68C, 68R, and thereby, starts spin of the reels 22L, 22C, 22R.

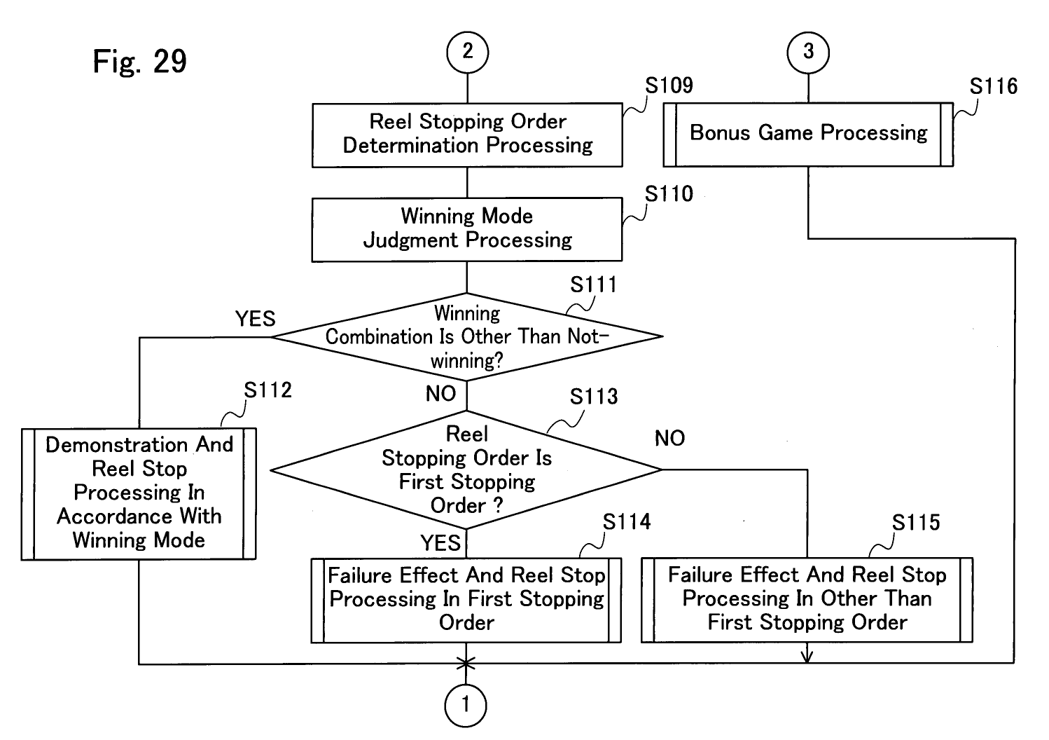

Next, in a step S108, determination processing of whether a symbol, which stops at the reel 22R, is the BONUS trigger symbol is carried out. The main control circuit 50a carries out determination of whether a symbol, which appears at the reel 22R, is the BONUS trigger symbol 93 (i.e., a code number is “02” (see, FIG. 4)) or not, with reference to code numbers of reels which are stored in RAM 52. When this determination is YES, processing is shifted to a step S109 of FIG. 29, and when it is NO, processing is shifted to a step S116 of FIG. 29.

Next, in the step S109, reel stop order determination processing is carried out. The main control circuit 50a controls the random sampling circuit 56 (see, FIG. 5), and extracts one random number value from random number values that the random number generator 55 (see, FIG. 5) generates. The main control circuit 50a further determines a stopping order of each reel 22L, 22C, 22R, on the basis of that random number value, and with reference to the reel stop order determination probability lottery table shown in FIG. 12. The determined stopping order of the reels 22L, 22C, 22R is stored in RAM 52.

Next, in a step S110, winning combination determination processing is carried out. The main control circuit 50a carries out such determination that a combination of symbols which appear corresponds to which winning combination, on the basis of code numbers of symbols which appear at the reels 22L, 22C, 22R, respectively, which are stored in RAM 52 in the step S106, and with reference to the winning combination determination table shown in FIG. 10.

Next, in a step Sill, determination processing of whether a winning combination is other than a “loss”. The main control circuit 50a carries out determination of whether a winning combination, which was determined in the step S110, is other than the “loss”. When this determination is YES, processing is shifted to a step S112, and when it is NO, processing is shifted to a step S113.

Next, in the step S112, “demonstration which corresponds to a winning combination and reel stop processing” is carried out. Details of this processing will be described in details of “demonstration which corresponds to a winning combination and reel stop processing” which will be described later. When this processing is finished, processing is shifted to the step S102 in the main flow of FIG. 28.

On one hand, in a step S113, determination of “whether a reel stopping order is the first stopping order” is carried out. The main control circuit 50a carries out this determination of whether a reel stopping order is the first stopping order or not, with reference to reel stopping orders which are determined in the step S109 and stored in RAM 52. When this determination is YES, processing is shifted to a step S114, and when it is NO, processing is shifted to a step S115.

Next, in the step S114, “failure game effect in the first stopping order and reel stop processing” is carried out. Details of this processing will be described in details of “failing game effect in the first stopping order and reel stop processing” which will be described later. When this processing is finished, processing is shifted to the step S102 in the main flow of FIG. 28.

On one hand, in the step S115, “failure game effect in a case other than the first stopping order and reel stop processing” is carried out. Details of this processing will be described in details of “failing game effect in a case other than the first stopping order and reel stop processing” which will be described later. When this processing is finished, processing is shifted to the step S102 in the main flow of FIG. 28.

On one hand, in a step S116, bonus game processing is carried out. Details of this processing will be described in details of bonus game processing which will be described later. When this processing is finished, processing is shifted to the step S102 in the main flow of FIG. 28.

[Details of Normal Screen Selection Processing]

With reference to FIG. 30, details of normal screen selection processing, which is carried out in the step S102 in the main flow of FIG. 28, will be described. The normal screen indicates a demonstration screen which is displayed on the main display 4 at the time of the normal base of the slot machine 1.

In a step S121, determination of whether a normal screen selection counter is “0” or not is carried out. The main control circuit 50a (see, FIG. 5) carries out determination of whether the value is “0” or not, with reference to a value of the normal screen selection counter, which is a variable stored in RAM 52 (see, FIG. 5). When this determination is YES, processing is shifted to a step S122, and when it is NO, processing is shifted to a step S124.

Next, in the step S122, normal screen selection lottery processing is carried out. The main control circuit 50a controls the random sampling circuit 56 (see, FIG. 5), and extracts one random number value from random number values that the random number generator 55 (see, FIG. 5) generates. The main control circuit 50a further determines a normal screen, on the basis of that random number value, and with reference to a normal screen selection probability table shown in FIG. 11.

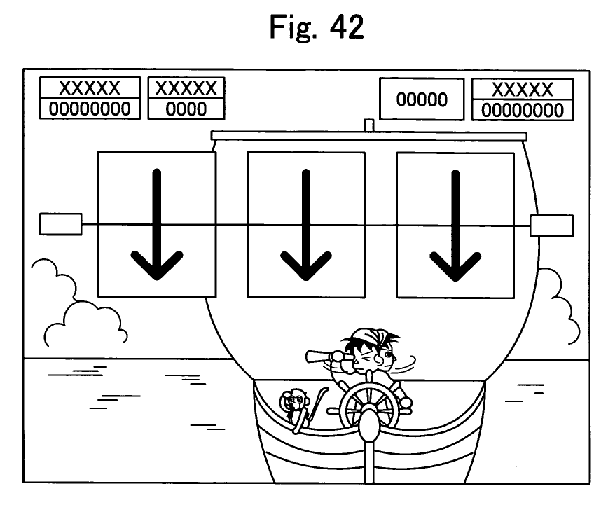

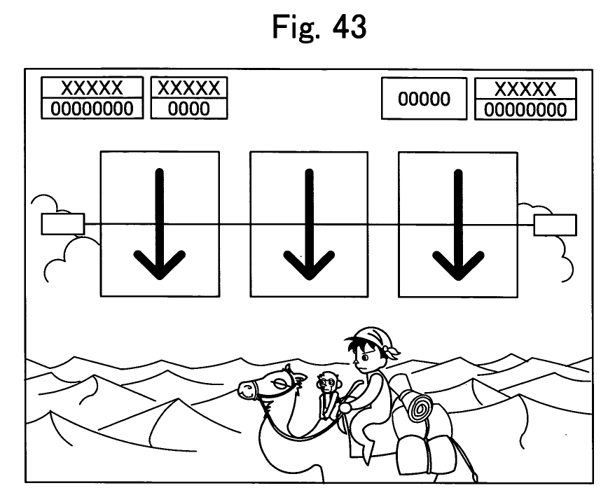

Next, in a step S123, normal screen switching processing is carried out. The main control circuit 50a starts display of a normal screen having been determined in the step S122 and being displayed on the main display 4 at the time of the base game. The main control circuit 50a transmits a demonstration command (see, FIG. 20) which corresponds to the normal screen having been determined in the step S122, to the sub control circuit 171 (see, FIG. 6), and the sub control circuit 171 receiving the demonstration command reads out demonstration data which corresponds to the demonstration command, from the sub ROM 223 (see, FIG. 6), and the sub CPU 221 (see, FIG. 6) controls the image display control circuit 75, and displays a relevant normal screen on the main display 4. Meanwhile, FIG. 42 is an image for displaying “SEA” on the main display 4 as the normal screen. In addition, FIG. 43 is an image for displaying “DESERT” on the main display 4 as the normal screen.

Next, in the step S124, processing for adding the normal screen selection counter 1 is carried out. The main control circuit 50a adds “1” to the normal screen selection counter which is a variable stored in RAM 52.

Next, in a step S125, processing of whether the normal screen selection counter is equivalent to “10” or not is carried out. The main control circuit 50a determines, with reference to the normal screen selection counter which is a variable to be stored in RAM 52, whether its value is equivalent to “10” or not. When this determination is YES, processing is shifted to a step S126, and when it is NO, this subroutine is finished, and processing is shifted to the step S103 of FIG. 28.

Next, in the step S126, processing of clearing the normal screen selection counter is carried out. The main control circuit 50a sets “0” (clears) to the normal screen selection counter which is a variable to be stored in RAM 52. When this processing is finished, this subroutine is finished, and processing is shifted to the step S103 of FIG. 28.

[Details of Bonus Game Processing]

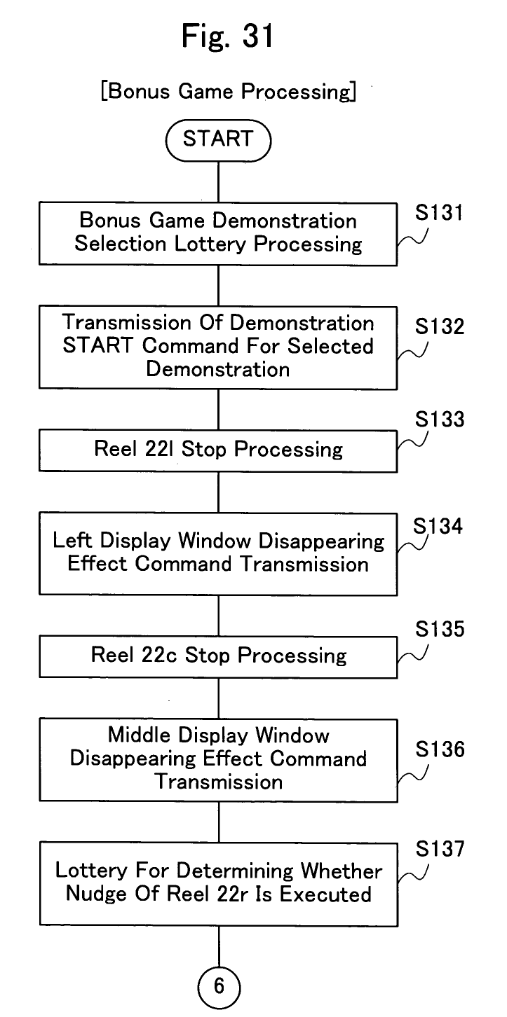

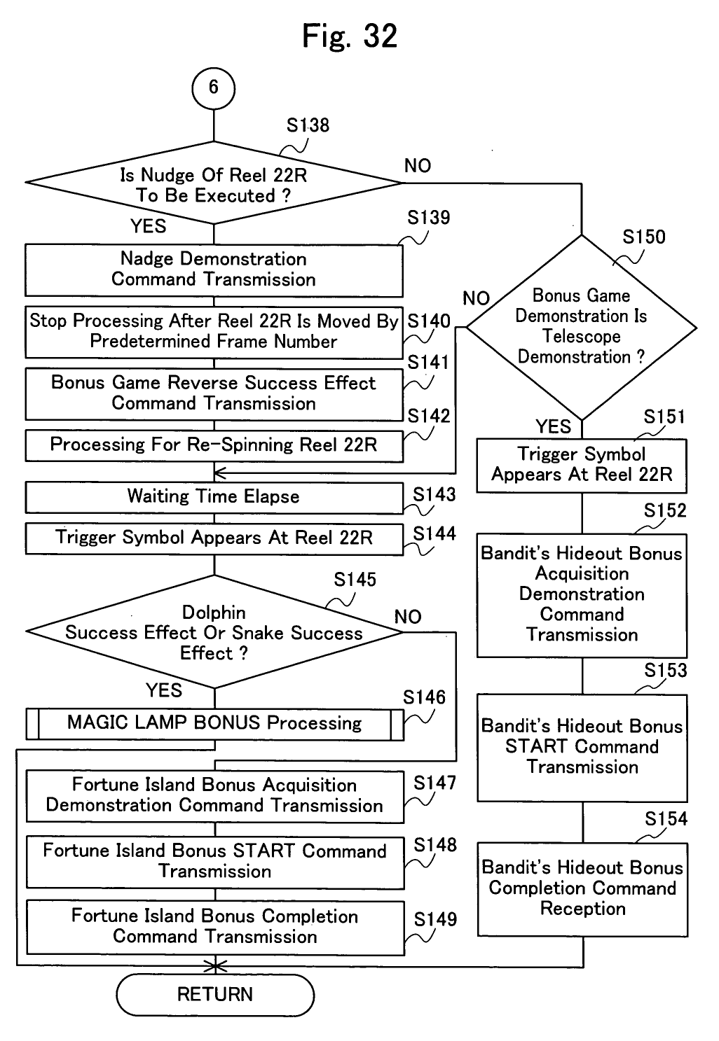

With reference to FIGS. 31 and 32, details of bonus game processing which is carried out in the step S116 of FIG. 29 will be described.

In a step S131 of FIG. 31, bonus game demonstration selection processing is carried out. The main control circuit 50a controls the random sampling circuit 56 (see, FIG. 5), and extracts one random number value from random number values which the random number generator 55 (see, FIG. 5) generates. On the basis of that random number value, the main control circuit 50a (see, FIG. 5) further determines to carry out the “telescope demonstration”, to carry out “bird demonstration”, or to carry out “dolphin (snake) demonstration”, with reference to the bonus game demonstration selection probability lottery table which is shown in FIG. 13. Meanwhile, when BET number is not 5, this lottery is not carried out, and it determines to carry out the “telescope demonstration” without condition.

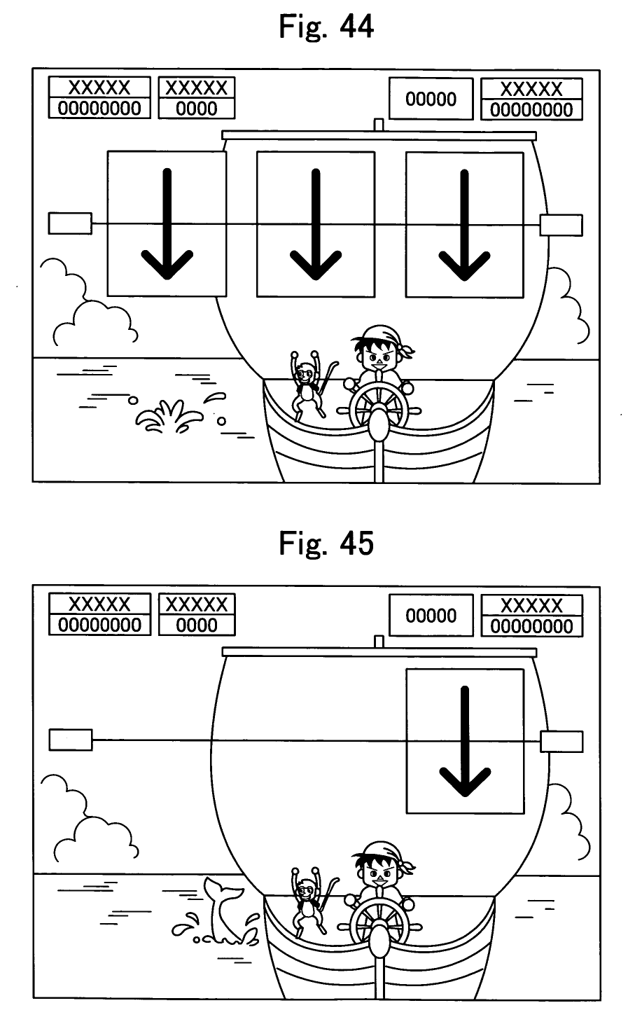

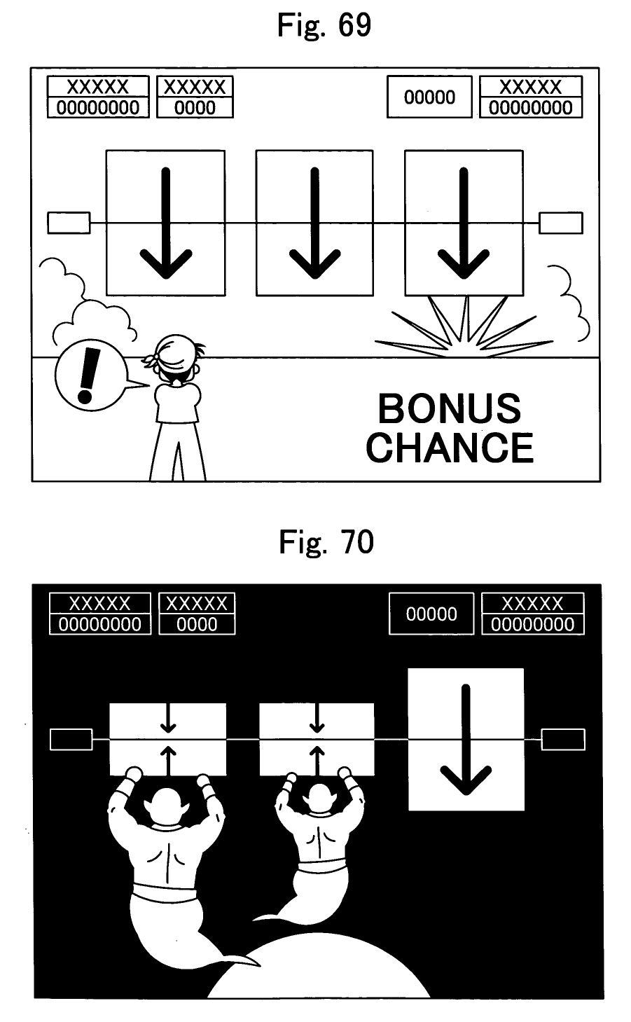

Next, in a step S132, processing of transmitting a demonstration start command which corresponds to the demonstration selected in the step S131 is carried out. The main control circuit 50a transmits the demonstration start command (“telescope demonstration start command”, “bird demonstration start command”, “dolphin demonstration command” or “snake demonstration command” (see, FIG. 25)) which corresponds to the demonstration determined in the step S131, to the sub control circuit 171 (see, FIG. 6), and the sub control circuit 171 having received that demonstration command reads out demonstration data (see, FIG. 25) which corresponds to that demonstration command, from the sub ROM 223 (see, FIG. 6), and the sub CPU 221 (see, FIG. 6) controls the image display control circuit 75, to display a relevant demonstration screen on the main display 4. Meanwhile, FIG. 69 shows an image of a demonstration screen which is displayed on the main display 4, on the basis of ““find something” demonstration data” (see, FIG. 25) which corresponds to the “telescope demonstration start command”. In addition, FIG. 76 shows an image of a demonstration screen which is displayed on the main display 4, on the basis of “background becomes night, and bird appears demonstration data” which corresponds to the “bird demonstration start command”. In addition, FIG. 44 shows an image of a demonstration screen which is displayed on the main display 4, on the basis of “dolphin left display window vicinity appearance demonstration data” (see, FIG. 25) which corresponds to the “dolphin demonstration command”.

Next, in a step S133, stop processing of the reel 22L is carried out. The main control circuit 50a controls the motor drive circuit 67 (see, FIG. 5), to carry out processing of the reel 22L, on the basis of information of a an appearing symbol for the reel 22L having been stored in RAM 52 (see, FIG. 5) in the step S106 of FIG. 28.

Next, in a step S134, left display window disappearing effect command transmission processing is carried out. The main control circuit 50a transmits a left display window disappearing effect command (“telescope left display window disappearing command”, “bird demonstration left display window disappearing command”, “dolphin demonstration command 2” (see, FIG. 25)) which corresponds to a demonstration determined in the step S131, to the sub control circuit 171, and the sub control circuit 171, which received that demonstration command, reads out demonstration data (see, FIG. 25), which corresponds to that demonstration command, from the sub ROM 223 (see, FIG. 6), and the sub CPU 221 (see, FIG. 6) controls the image display control circuit 75, to erase the left display window 23. Meanwhile, FIG. 70 shows such an image that a character (spirit of lamp) makes the left display window 23 disappear, on the main display 4, on the basis of “telescope left display window disappearing demonstration data” which corresponds to “telescope left display window disappearing command”. In addition, FIG. 77 shows such an image that a character (spirit of lamp) erases the left display window 23, on the main display 4, on the basis of “bird demonstration left display window disappearing demonstration data” which corresponds to “bird demonstration left display window disappearing command”.

Next, in a step S135, stop processing of the reel 22C is carried out, by processing which is similar to that of the step S133.

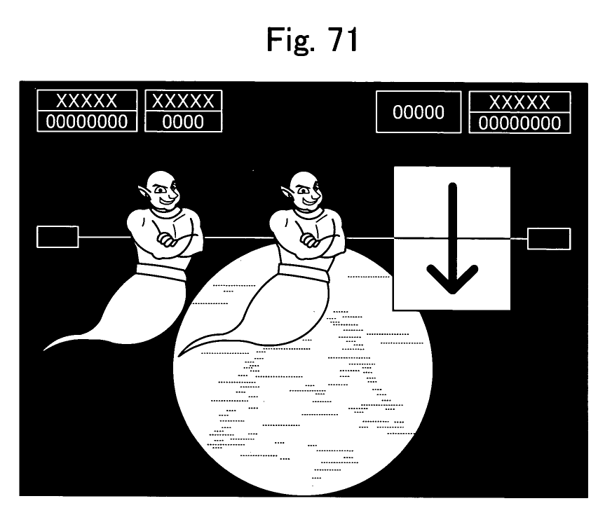

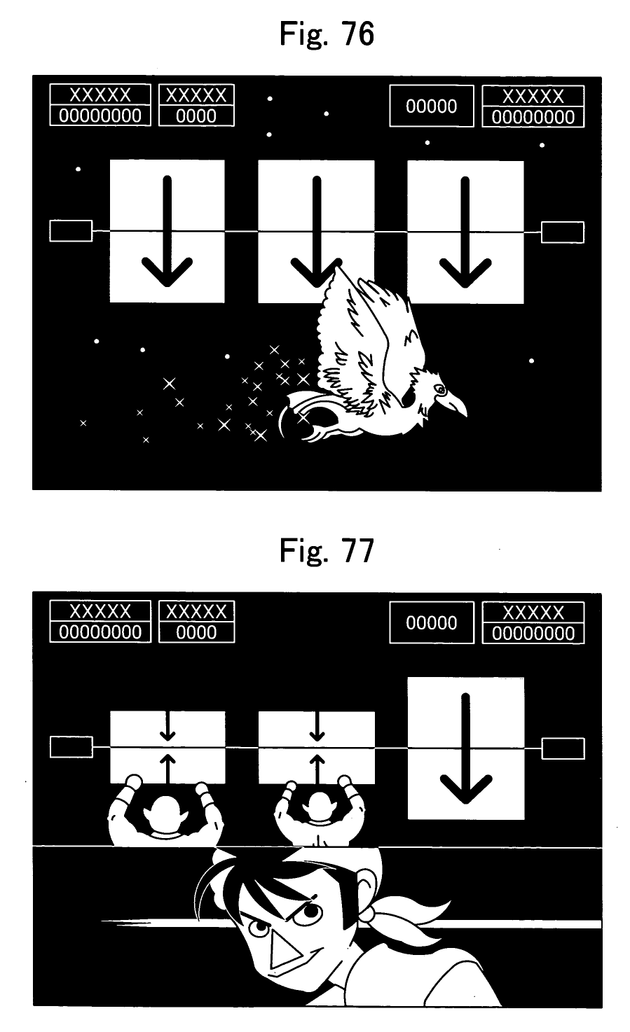

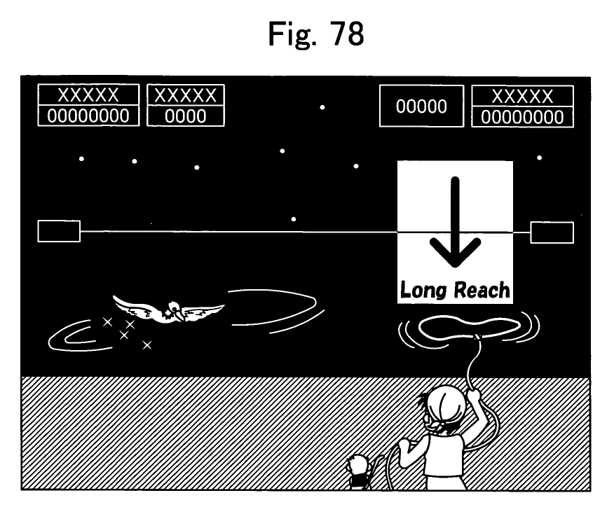

Next, in a step S136, middle display window disappearing effect command transmission processing is carried out. On the basis of “telescope middle display window disappearing command”, “bird effect middle display window disappearing command”, and “dolphin effect command” (see, FIG. 25), processing, which is similar to that of the step S134, is carried out. Meanwhile, FIG. 45 shows such an image that the left display window 23 disappears on the main display 4, on the basis of “dolphin middle display window vicinity appearance and middle display window disappearing effect data” which corresponds to “dolphin effect command 3”. In addition, FIG. 70 shows such an image that a character (spirit of lamp) erases the middle display window 24 on the main display 4, on the basis of “bird effect left display window disappearing effect data” which corresponds to “bird demonstration left display window disappearing command”. Further, FIGS. 71 and 78 are images of such an appearance that the reel 22R rotates, after the left display window and the middle display window disappear on the main display 4.

Next, in a step S137, lottery processing of whether NUDGE of the reel 22R is carried out or not is carried out. The main control circuit 50a controls the random number sampling circuit 56 (see, FIG. 5) and extracts one random number value from random number values that the random number generator 55 (see, FIG. 5) generates. On that random number value, the main control circuit 50a further determines whether NUDGE is carried out or not, with reference to “NUDGE demonstration determination probability lottery table at the time of BONUS trigger symbol selection”. Meanwhile, when BET number is not 5, it determines not to carry out NUDGE without condition.

Next, in a step S138, determination of whether NUDGE of the reel 22R is carried out or not the main control circuit 50a carries out determination of whether NUDGE of the reel 22R is carried out or not, on the basis of a result of determination having been determined in the step S137. When this determination is YES, processing is shifted to a step S139, and when it is NO, processing is shifted to a step S148.

Next, in the step S139, NUDGE demonstration command transmission processing is carried out. The main control circuit 50a transmits a bonus acquisition failure command (“BANDIT'S HIDEOUT BONUS acquisition failure game effect command”, “FORTUNE ISLAND BONUS acquisition failure command”, “dolphin effect command 6” or “snake demonstration command” (see, FIG. 25)) which corresponds to a demonstration determined in the step S131, and the sub control circuit 171, which received that demonstration command, reads out demonstration data (see, FIG. 25) which corresponds to that demonstration command, from the sub ROM 223 (see, FIG. 6), and the sub CPU 221 (see, FIG. 6) controls the image display control circuit 75, to display a relevant demonstration screen. Meanwhile, FIG. 73 shows an image of notifying bonus acquisition failure to a player on the main display 4, on the basis of “BANDIT'S HIDEOUT BONUS acquisition failure game effect data” which corresponds to “BANDIT'S HIDEOUT BONUS acquisition failure game effect command”. In addition, FIG. 80 shows an image of notifying bonus acquisition failure to a player on the main display 4, on the basis of “FORTUNE ISLAND BONUS acquisition failure game effect data” which corresponds to “FORTUNE ISLAND BONUS acquisition failure command”.

Next, in a step S140, stop processing is carried out by moving the reel 22R by predetermined frame number. The main control circuit 50a controls the motor drive circuit 67 to move the reel 22R by predetermined frame number (e.g., it is one frame (i.e., one symbol) but this invention is not limited to this) on the basis of information of an appearing symbol of the reel 22R having been stored in RAM 52 (see, FIG. 5) in the step S106 of FIG. 28, and thereby, stop processing of the reel 22R is carried out. As a result of this, an appearing symbol of the reel 22R becomes a symbol with a previous code number or a subsequent code number, to a symbol which corresponds to a code number stored in RAM 52 (see, FIG. 5) in the step S106.

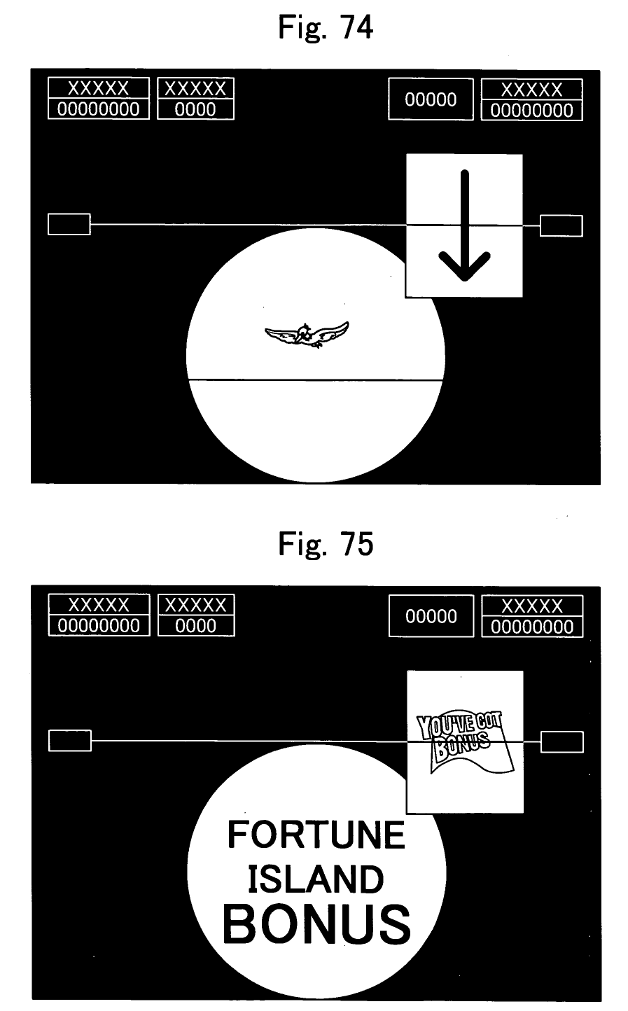

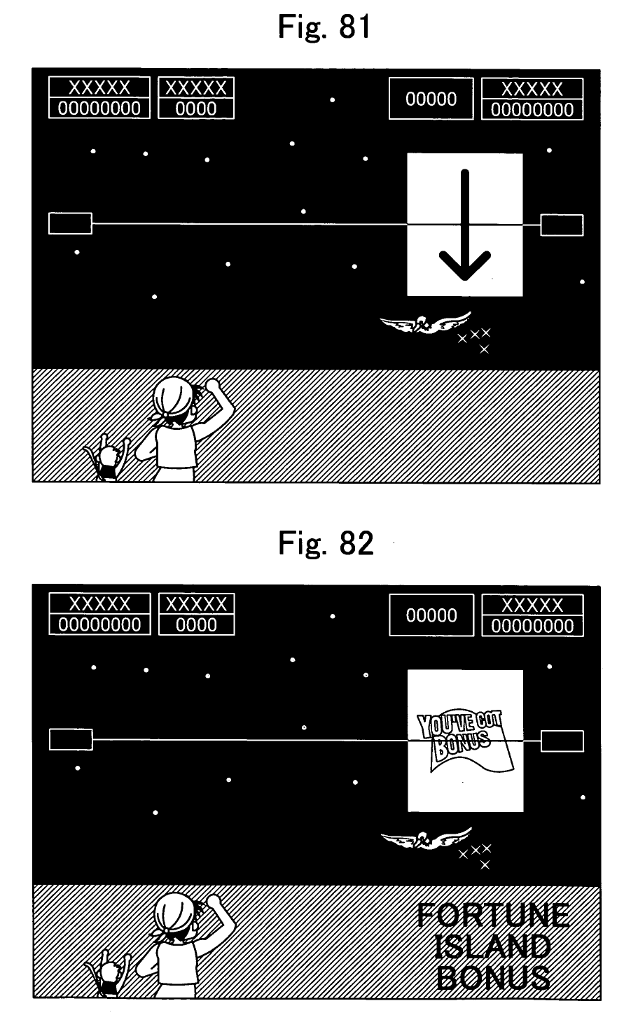

Next, in a step S141, bonus reversal succeeding game effect command transmission processing is carried out. The main control circuit 50a transmits a bonus reversal acquisition command (“bird come-flying effect command”, “bird come-flying-again command”, “dolphin effect command 7” or “snake effect command 7” (see, FIG. 25)) which corresponds to an effect determined in the step S131, to the sub control circuit 171, and the sub control circuit 171 receiving that demonstration command, reads out demonstration data (see, FIG. 25) which corresponds to that demonstration command, from the sub ROM 223 (see, FIG. 6), and the sub CPU 221 (see, FIG. 6) controls the image display control circuit 75 to display a relevant demonstration screen. Meanwhile, FIG. 74 shows an image for suggesting bonus reversal acquisition to a player on the main display 4, on the basis of “bird come-flying effect data” which corresponds to “bird come-flying effect command”. In addition, FIG. 81 shows an image for suggesting bonus reversal acquisition to a player on the main display 4, on the basis of “bird come-flying-again effect data” which corresponds to “bird come-flying-again command”.

Next, in a step S142, processing for spinning the reel 22R again is carried out. The main control circuit 50a controls the motor drive circuit 67 (see, FIG. 5) to start drive of the stepping motor 68R, and thereby, spin of the reel 22R is re-started.

Next, in a step S143, waiting time digestion processing is carried out. The main control circuit 50a is turned in a waiting state for a given length of time, to maintain spin of the reel 22R having been started in the step S142.

Next, in a step S144, stop processing of the reel 22R is carried out by processing which is similar to that of the step S133 of FIG. 31. In this way, the BONUS trigger symbol 93 stops at the reel 22R.

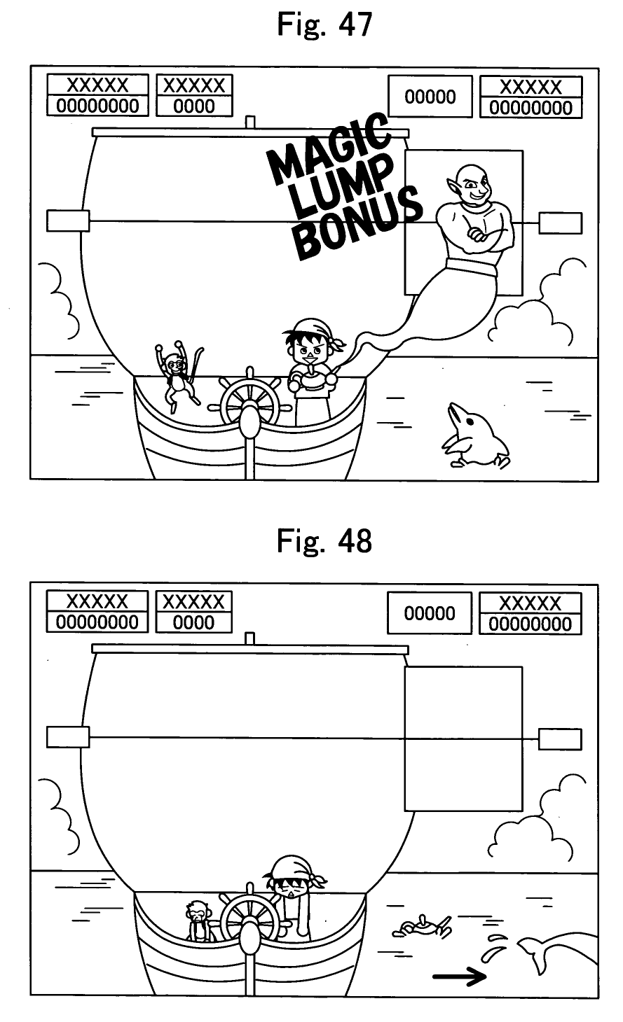

Next, in a step S145, determination processing of whether a demonstration is the dolphin succeeding game effect or the snake succeeding game effect or not is carried out. The main control circuit 50a carries out determination of whether the demonstration having been determined in the step S191 is the dolphin succeeding game effect or the snake succeeding game effect or not. When this determination is YES, processing is shifted to a step S146, and when it is NO, processing is shifted to a step S147. Meanwhile, FIG. 47 shows an image of demonstration display in which a third stop reel is the reel 22R, and “succeeding game effect” is the “dolphin succeeding game effect”, and which is displayed when it is determined to be YES, in the determination of this step S145.

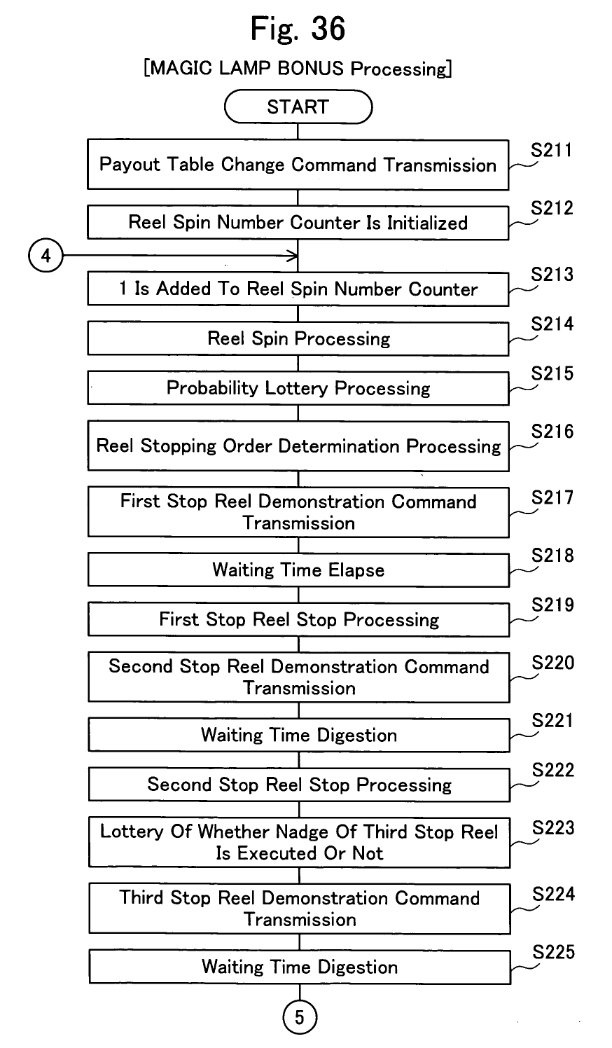

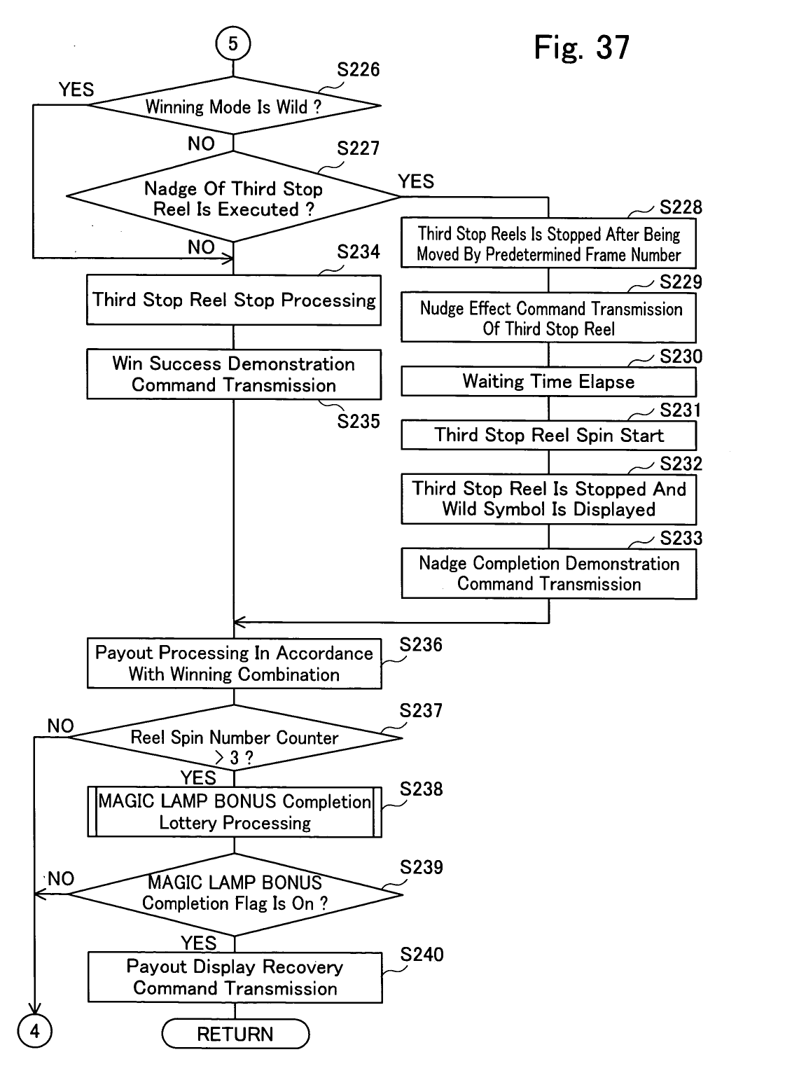

Next, in the step S146, MAGIC LAMP BONUS processing is carried out. Details of this processing will be described in details of MAGIC LAMP BONUS processing of FIGS. 36 to 37, which will be described later. When this processing is finished, this subroutine is finished, and processing is shifted to the step S102 of FIG. 28.

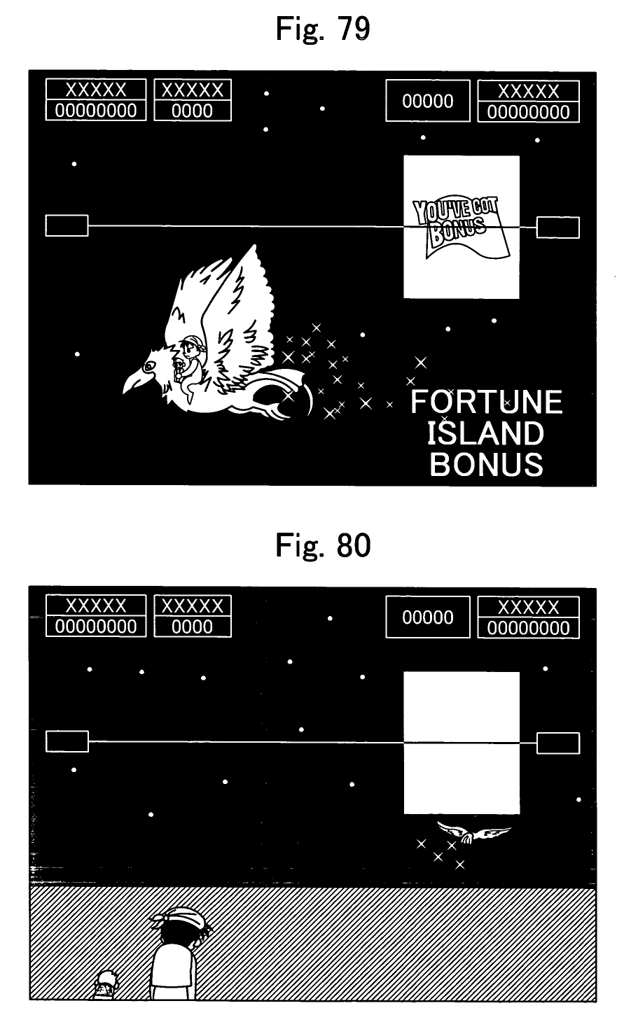

On one hand, in the step S147, FORTUNE ISLAND BONUS acquisition demonstration command transmission processing is carried out. The main control circuit 50a transmits a bonus acquisition command (“FORTUNE ISLAND BONUS acquisition demonstration command” (see, FIG. 25)) which corresponds to the bird demonstration, to the sub control circuit 171, and the sub control circuit 171, which receives that demonstration command, reads out demonstration data (see, FIG. 25) which corresponds to that demonstration command, from the sub ROM 223 (see, FIG. 6), and the sub CPU 221 (see, FIG. 6) controls the image display control circuit 75, to display a relevant demonstration screen. Meanwhile, FIGS. 75, 79 and 82 show images of notifying bonus acquisition to a player on the main display 4, on the basis of “FORTUNE ISLAND BONUS acquisition effect data” which corresponds to “FORTUNE ISLAND BONUS acquisition effect command”. FIG. 75 shows an image of notifying bonus acquisition of FORTUNE ISLAND BONUS, which is reversed from “telescope demonstration” and acquired. FIG. 79 shows an image of notifying bonus acquisition of FORTUNE ISLAND BONUS, which is acquired from the “bird demonstration” without NUDGE effect, to a player. FIG. 82 shows an image of notifying bonus acquisition of FORTUNE ISLAND BONUS, which is acquired from the “bird effect” through the NUDGE effect, to the player.

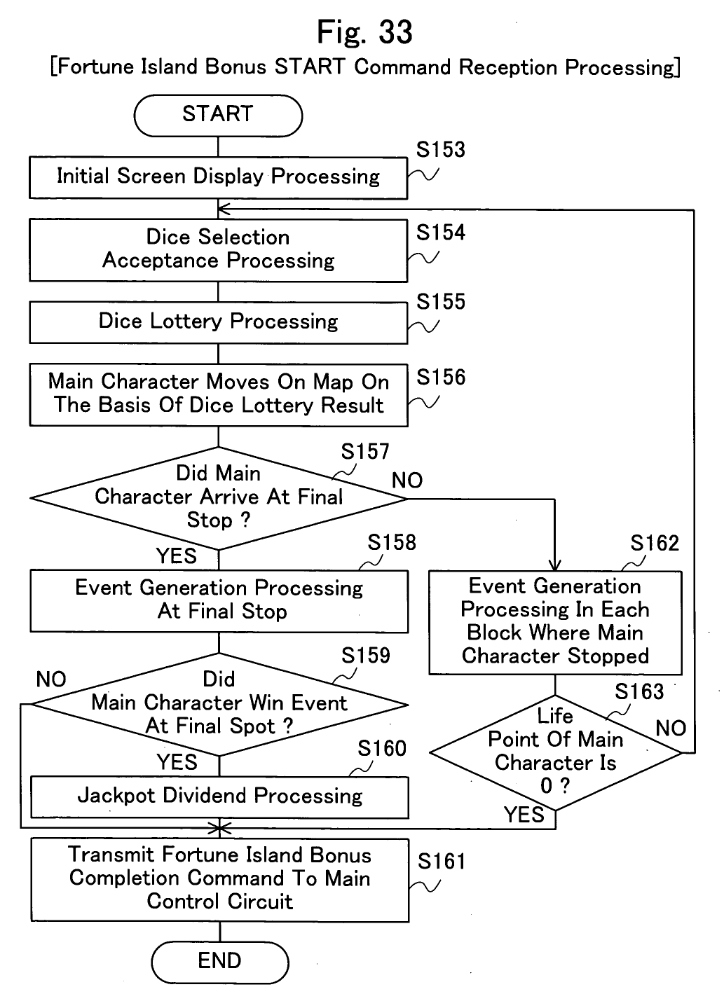

Next, in a step S148, FORTUNE ISLAND BONUS start command transmission processing is carried out. The main control circuit 50a transmits a FORTUNE ISLAND BONUS start command to the sub control circuit 171. The sub control circuit 171, which receives this FORTUNE ISLAND BONUS start command, carries out FORTUNE ISLAND BONUS start command reception processing of FIG. 33 which will be described later.

Next, in a step S149, FORTUNE ISLAND BONUS completion command reception processing is carried out. The main control circuit 50a receives a FORTUNE ISLAND BONUS completion command which is transmitted from the sub control circuit 171. The main control circuit 50a, which receives this FORTUNE ISLAND BONUS completion command, completes this subroutine, and processing is shifted to the step S102 in the main flow of FIG. 28.

On one hand, in a step S150, determination of whether a bonus game effect is the telescope effect or not is carried out. The main control circuit 50a carries out determination of whether a bonus game effect having been determined in the step S131 is the telescope demonstration or not. When this determination is YES, processing is shifted to the step S149, and when it is NO, processing is shifted to the step S143.

Next, in a step S151, stop processing of the reel 22R is carried out by processing which is similar to that of the step S133 of FIG. 31. In this way, the BONUS trigger symbol 93 stops at the reel 22R.

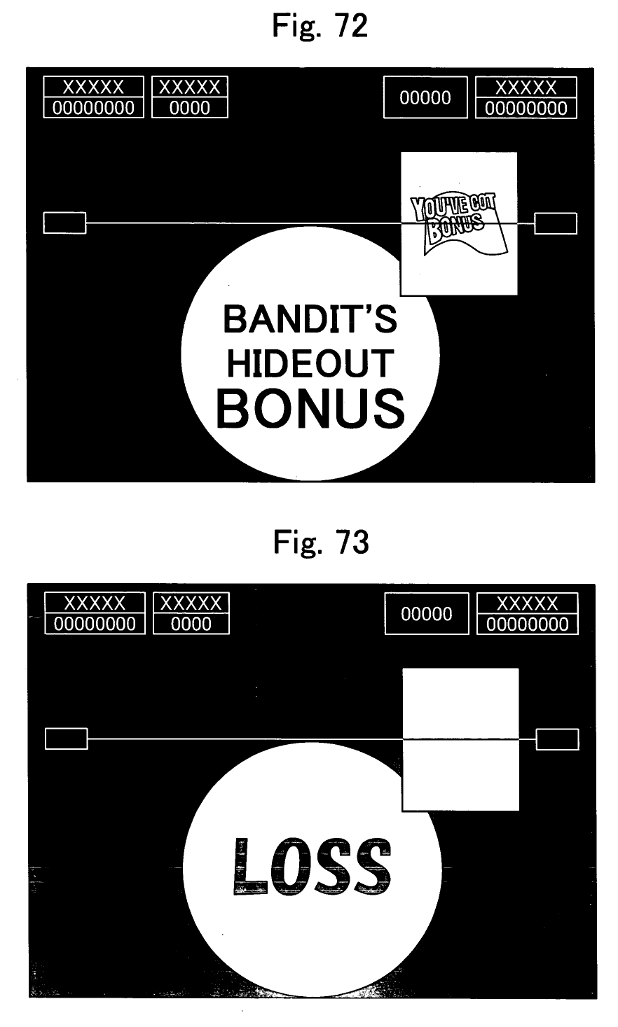

Next, in a step S152, BANDIT'S HIDEOUT BONUS acquisition effect command transmission processing is carried out. Processing, which is similar to that of the step S147, is carried out except for such a matter that it is based on “BANDIT'S HIDEOUT BONUS acquisition effect command (see, FIGS. 25A-B)”. Meanwhile, FIG. 72 shows an image of notifying bonus acquisition to the player on the main display 4, on the basis of “BANDIT'S HIDEOUT BONUS acquisition effect data” which corresponds to “BANDIT'S HIDEOUT BONUS acquisition effect command”.

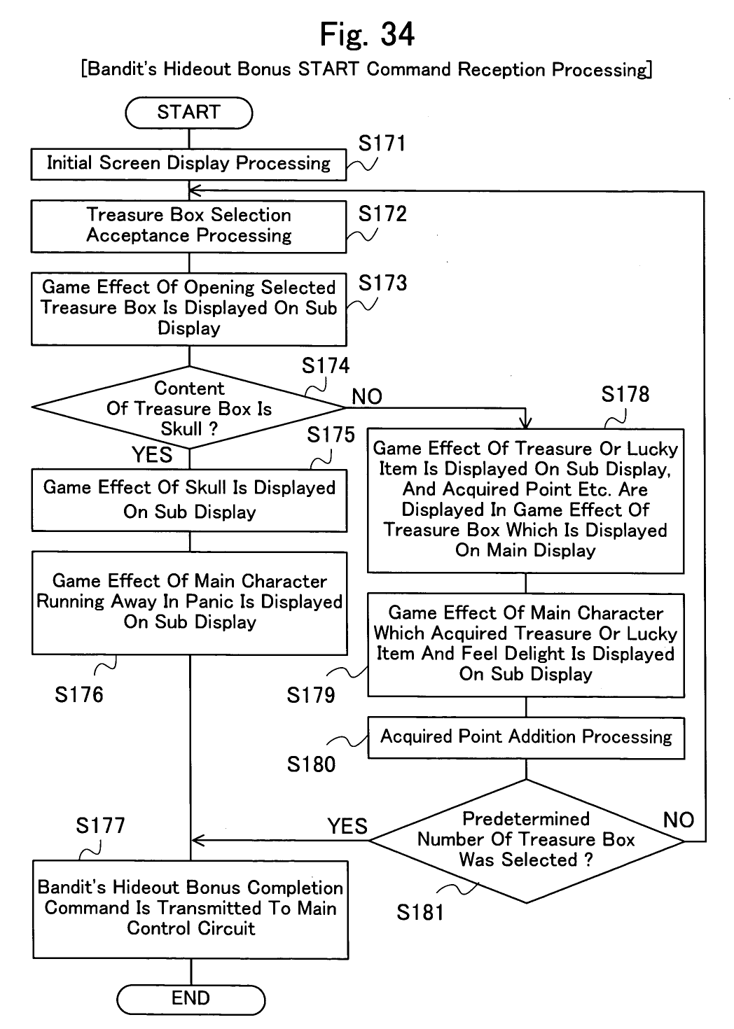

Next, in a step S153, BANDIT'S HIDEOUT BONUS start command transmission processing is carried out. The main control circuit 50a transmits a BANDIT'S HIDEOUT BONUS start command to the sub control circuit 171. The sub control circuit 171, which receives this BANDIT'S HIDEOUT BONUS start command, carries out BANDIT'S HIDEOUT BONUS start command reception processing of FIG. 34 which will be described later.

Next, in a step S154, BANDIT'S HIDEOUT BONUS completion command reception processing is carried out. The main control circuit 50a receives a BANDIT'S HIDEOUT BONUS completion command which is transmitted from the sub control circuit 171. The main control circuit 50a, which receives this BANDIT'S HIDEOUT BONUS completion command, completes this subroutine, and processing is shifted to the step S102 in the main flow of FIG. 28.

[Details of FORTUNE ISLAND BONUS Start Command Reception Processing]

FIG. 33 shows the step S146 of bonus game processing of FIG. 31, which is processing to be carried out by the sub control circuit 171, when the sub control circuit 171 (see, FIG. 6) receives a FORTUNE ISLAND BONUS start command which is transmitted from the main control circuit 50a (see, FIG. 5). This processing is, i.e., processing of FORTUNE ISLAND BONUS.

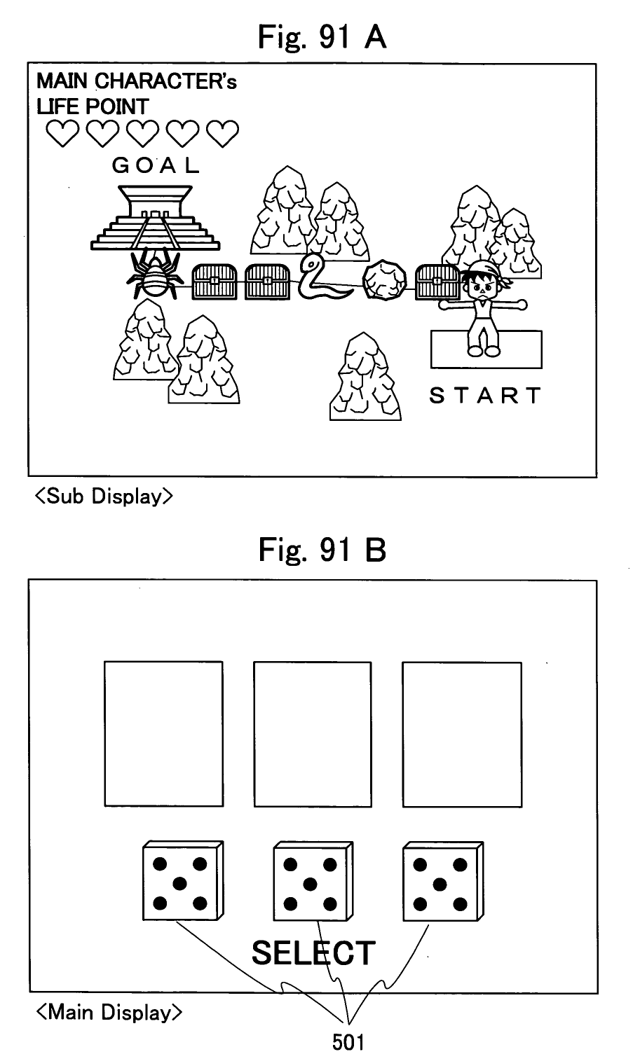

FORTUNE ISLAND BONUS is a bonus game which may imitate a SUGOROKU game. A SUGOROKU board is displayed on the sub display 3, and a main character makes its way on blocks of the SUGOROKU board, and thereby, the game goes on. A player selects one from three dices which are displayed on the main display 4, and its dice carries out variable display, and by a number of spots on the dice which is finally displayed, the number of blocks on which a main character goes on the SUGOROKU board is determined. The number of spots, which are finally displayed on the dice, is determined by probability lottery which may differ in three dices, respectively, after the variable display is started. A face of the dice is not shown to the player at the beginning, but it is configured in such a manner that the player selects one among the three dices arbitrarily and the selected dice carries out variable display, and when the variable display stopped finally, spots on the dice are shown. Meanwhile, designation of a selection of the dice is carried out by a touch panel system. A player touches display of an arbitrary one dice, and thereby, the touch panel 30 detects that touch, to transmit a detection signal to the touch panel control circuit 76 (see, FIG. 6), and thereby, the sub control circuit 171 (see, FIG. 6) recognizes that image display is touched by a player. Meanwhile, control of the dice and spots thereof which are displayed on the main display 4 is a arbitrary design changeable matter, and it is carried out by any system, if it is a system of displaying to the player the number of spots on the dice which is determined randomly in advance, by a combination of a liquid crystal display device and a touch panel, taking acceptance of an operation by a player as a trigger. Display 501 on a lower side figure in FIG. 91B is an image of the above-described dice.

In addition, in FORTUNE ISLAND BONUS, a main character starts a game with five life points. The life point increases or decreases by such a matter that it goes on blocks of the SUGOROKU board and comes across various events. Then, when the game of all FORTUNE ISLAND BONUS is completed at a final spot, if the life point is not “0”, a player can acquire JACKPOT as a special payout. When the life point becomes “0” before the main character arrives at the final spot on the SUGOROKU board, FORTUNE ISLAND BONUS is finished when the life point becomes “0.”

Hereinafter, such a system that a player inputs any input operation on the main display 4 is to be a touch panel system in which a display image is selected and touched, and the touch panel 30 detects that touch, and a detection signal is transmitted to the touch panel control circuit 76, and thereby, the sub control circuit 171 recognizes that image display is touched by the player.

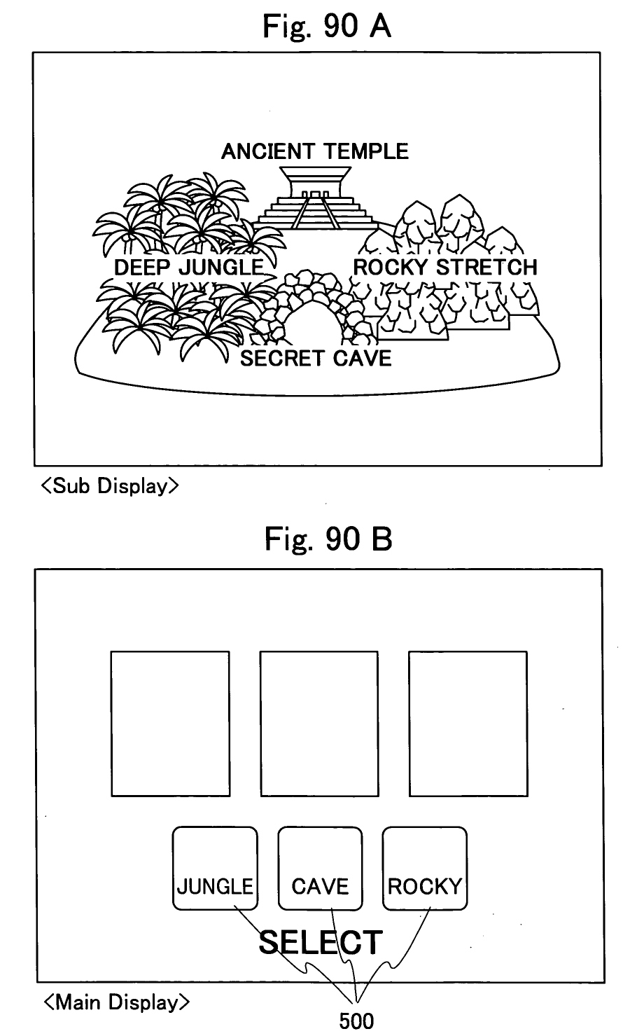

In a step S153, initial screen display processing is carried out. The sub control circuit 171 reads out a FORTUNE ISLAND BONUS start effect command from a FORTUNE ISLAND BONUS effect table (see, FIG. 27) which is stored in the sub ROM 223 (see, FIG. 6), and transmits it to the sub CPU 221, and the sub CPU 221, which receives that effect command, reads out effect data which correspond to the FORTUNE ISLAND BONUS effect command, with reference to the FORTUNE ISLAND BONUS effect data table, to display a corresponding game effect on the main display 4. FIG. 90 shows an image of its initial screen. Meanwhile, “PALACE”, “DEEP JUNGLE”, “SECRET CAVE”, and “ROCKY STRETCH” are displayed on the sub display 3 of the initial screen, and this means that a player selects any one route of “DEEP JUNGLE”, “SECRET CAVE”, and “ROCKY STRETCH” and reaches “PALACE”. As to the route selection, in display on the main display in a lower side figure of FIG. 90, a player touches any one of display images 500 which are displayed as “JUNGLE”, “CAVE”, and “ROCKY”, and thereby, SUGOROKU boards, which correspond to respective routes, are selected and displayed. By selecting any one of them, the sub control circuit 171 reads out a map image command (“DEEP JUNGLE map image command”, “SECRET CAVE map image command”, “ROCKY STRETCH map image command”) from the FORTUNE ISLAND BONUS demonstration data table (see, FIG. 27) which is stored in the sub ROM 223 (see, FIG. 6), and transmits it to the sub CPU 221, and the sub CPU 221, which receives that effect command, reads out effect data which corresponds to the FORTUNE ISLAND BONUS start effect command, with reference to the FORTUNE ISLAND BONUS effect data table, to display a corresponding game effect on the main display 4. FIG. 91 shows such an image that “ROCKY STRETCH” is selected by the player and its SUGOROKU board is displayed.

In addition, in the SUGOROKU board of “ROCKY STRETCH”, there are six blocks from a start spot to “PALACE” which is a goal spot. They are “TREASURE BOX”, “ROCK”, “BIG SNAKE”, “TREASURE BOX”, “TREASURE BOX”, and “BIG SPIDER” from a side which is close to the start spot. In respective blocks, various events occur, but details thereof will be described in an explanation of a step S162.

Next, in a step S154, dice selection acceptance processing is carried out. A player touches an arbitrary one among three dice images which are displayed on the-main display 4, and the touch panel 30 detects it, and a detection signal is transmitted to the touch panel control circuit 76, and thereby, the sub control circuit 171 recognizes that display is touched by a player.

Next, in a step S155, dice lottery processing is carried out. The sub control circuit 171 selects one random number value by software control, and on the basis of that random number value, a final spot on the dice is determined with reference to a probability lottery table (not shown in the figure) of spots on the dice which corresponds to a dice image having been touched and selected by the player. Then, the sub control circuit 171 controls the image display control circuit 75 to start variable display of the dice image, and after a while, that variable display is stopped. When the variable display is stopped, spots on the dice are not finally displayed to the player at this stage, but after that, variable display of the dice image is carried out, and for the first time when the variable display is stopped, spots on the dice is finally displayed to the player.

Next, in a step S156, such processing that a main character, which is displayed on the sub display 3, goes on blocks of the SUGOROKU board, by number of spots on the dice which is finally determined in the step S155 is carried out. The sub control circuit 177 controls the image display control circuit 74 on the basis of the number of spots on the dice which is determined in the step S155, to make a main character, which is displayed on the sub display 3, go on blocks of the SUGOROKU board.

Next, in a step S157, determination processing of whether a main character arrives at the final spot is carried out. The sub control circuit 171 carries out determination of whether a main character arrives at “PALACE” which is a goal of the SUGOROKU. When this determination is YES, processing is shifted to a step S158, and when it is NO, processing is shifted to a step S162.

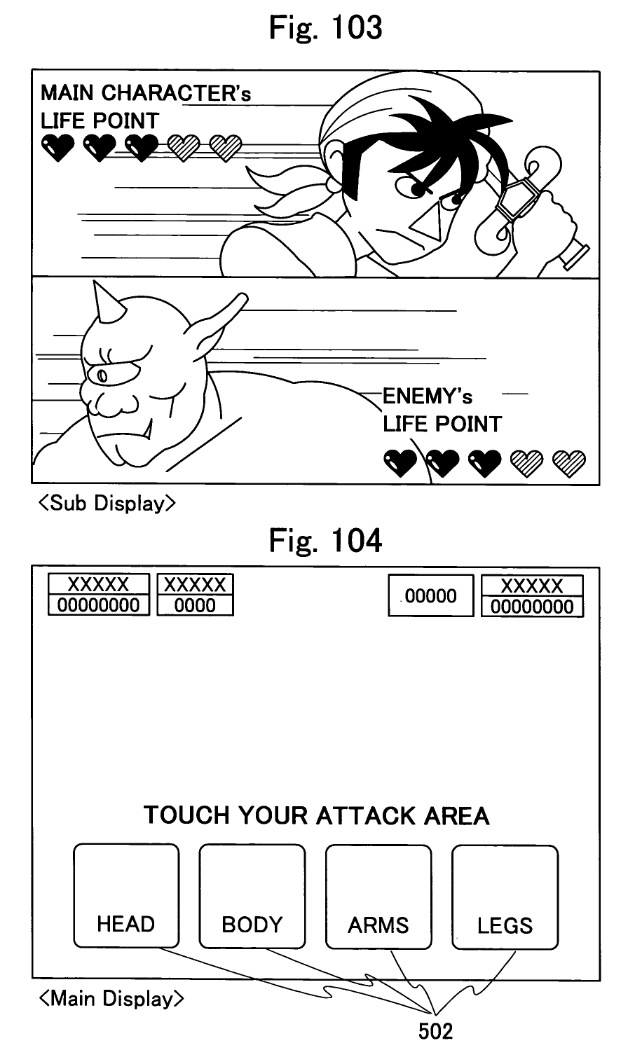

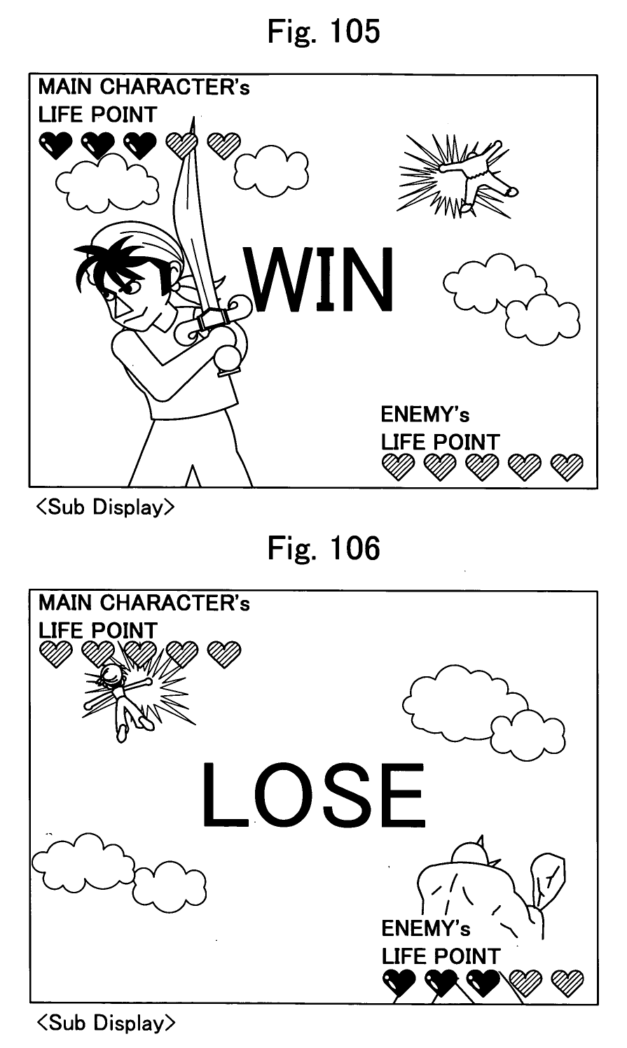

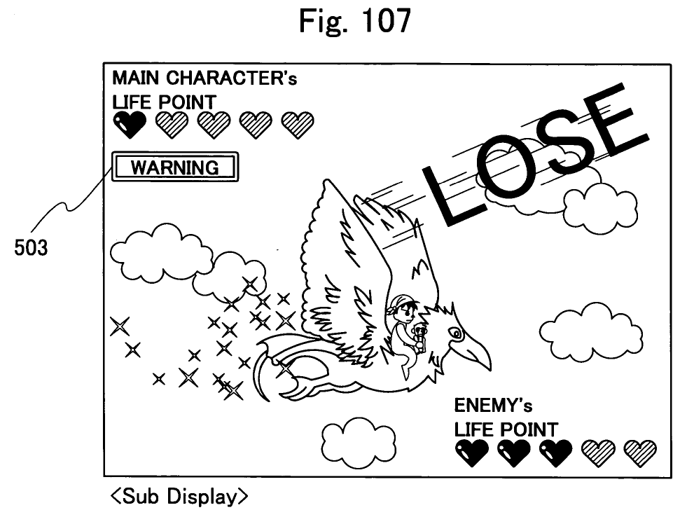

Next, in the step S158, event generation processing at the final spot is carried out. The sub control circuit 171 controls the image display control circuit 74, to make a main character, which is displayed on the sub display 3, carry out confrontation (PALACE battle) with “DEMON” which is a master of “PALACE”. The sub control circuit 171 reads out an PALACE game effect command from the FORTUNE ISLAND BONUS demonstration data table which is stored in the sub ROM 223 (see, FIG. 6) and transmits it to the sub CPU 221, and the sub CPU 221, which receives that demonstration command, reads out demonstration data which corresponds to the PALACE game effect command, with reference to the FORTUNE ISLAND BONUS demonstration data table, to display a corresponding game effect on the main display 4. FIG. 103 shows an image of confrontation of a main character and “DEMON” on the sub display 3. FIG. 104 shows a display image which is displayed on the main display 4 simultaneously with the screen of FIG. 103, for having the main character selected a point of attacking “DEMON”. This selection is carried out by a touch panel system, and an attack point is selected from four attack points (display images 502) of “HEAD”, “BODY”, “ARMS”, and “LEGS”. When any one of the display images 502 is selected, the sub control circuit 171 selects one random number value by software control, and on the basis of that random number value, success and failure of the attack is determined, with reference to a probability lottery table (not shown in the figure) for determining success and failure of an attack, which corresponds to the attack point having been touched and selected by the player. Meanwhile, the main character and “DEMON” repeat attacks alternately, and when the attack is successful, a life point (five heart marks shown in FIG. 103) of the other party decreases by one. A side which makes a life point of the other side “0” is a winner in the PALACE battle. FIG. 105 shows an image of a display image which is displayed on the sub display 3, when the main character made a life point of “DEMON” “0” and thereby, wins the PALACE battle. FIG. 106 shows an image of a display image which is displayed on the sub display 3, when a life point of a main character became “0”, and thereby the main character lost the PALACE battle. In this regard, however, there is such a reversal effect that, as shown in FIG. 107, in case the player win a predetermined lottery in the sub control circuit 171, even if the main character is beaten by “DEMON”, a bird appears to save the main character, and the life point of the main character is restored with only one, and thereby, it is possible to carry out the battle with “DEMON” again. The above-shown images are all stored in the FORTUNE ISLAND BONUS demonstration data table as predetermined data.

Next, in a step S159, determination processing of whether a main character wins an event at a final spot or not is carried out. The sub control circuit 171 determines whether a main character has won in the past, in the processing of the step S158. When this determination is YES, processing is shifted to a step S160, and when it is NO, processing is shifted to a step S161.

Next, in the step S160, JACKPOT payout processing is carried out. The sub control circuit 171 transmits a signal of a JACKPOT payout request, to the main control circuit 50a. The main control circuit 50a, which receives that signal, transmits a request signal for JACKPOT payout, to the progressive unit 83, through the progressive I/F 81. The progressive unit 83, which receives the request signal for JACKPOT payout, transmits a signal for giving a predetermined progressive value to a player as a JACKPOT payout, to the main control circuit 50a. The main control circuit 50a, which receives the signal for giving it to a player as the JACKPOT payout, adds the number of coins which corresponds to the given JACKPOT payout, to a credit value of the slot machine 1(the number of coins which is trapped in the slot machine 1).

Next, in the step S161, processing of transmitting a FORTUNE ISLAND completion command to the main control circuit 50a is carried out. The sub control circuit 171 transmits the FORTUNE ISLAND BONUS completion command to the main control circuit 50a. In addition, display of the sub display 3 is restored to payout display. When this processing is finished, this routine is finished.

On one hand, in a step S162, “event generation processing in each block where a main character stopped” is carried out. As described above, for example, when “ROCKY STRETCH” is selected as a route leading to “PALACE”, there are six blocks from a start spot to “PALACE” which is a goal spot. They are “TREASURE BOX”, “ROCK”, “BIG SNAKE”, “TREASURE BOX”, “TREASURE BOX”, and “BIG SPIDER” from a side which is close to the start spot.

When the main character stopped at a block of “TREASURE BOX”, the sub control circuit 171 reads out a treasure box game effect command from the FORTUNE ISLAND BONUS demonstration data table (see, FIG. 27) which is stored in the sub ROM 223 (see, FIG. 6), and transmits it to the sub CPU 221, and the sub CPU 221, which receives that demonstration command, reads out demonstration data which corresponds to the FORTUNE ISLAND BONUS start demonstration command, with reference to the FORTUNE ISLAND BONUS demonstration data table, to display a corresponding game effect on the main display 4. When the main character stops at a block of “TREASURE BOX”, a life point of the main character increase with only one.

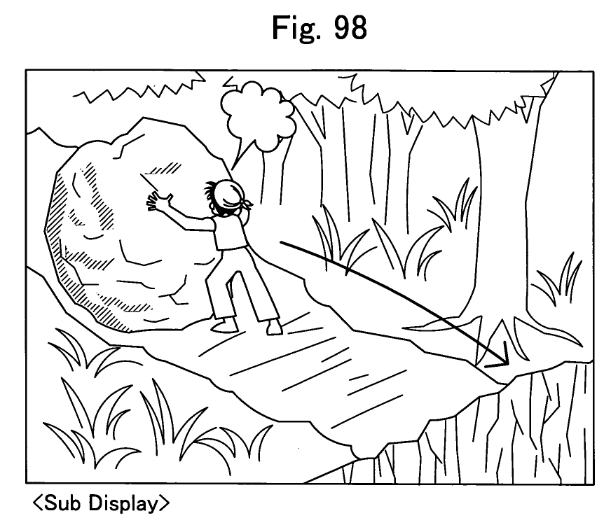

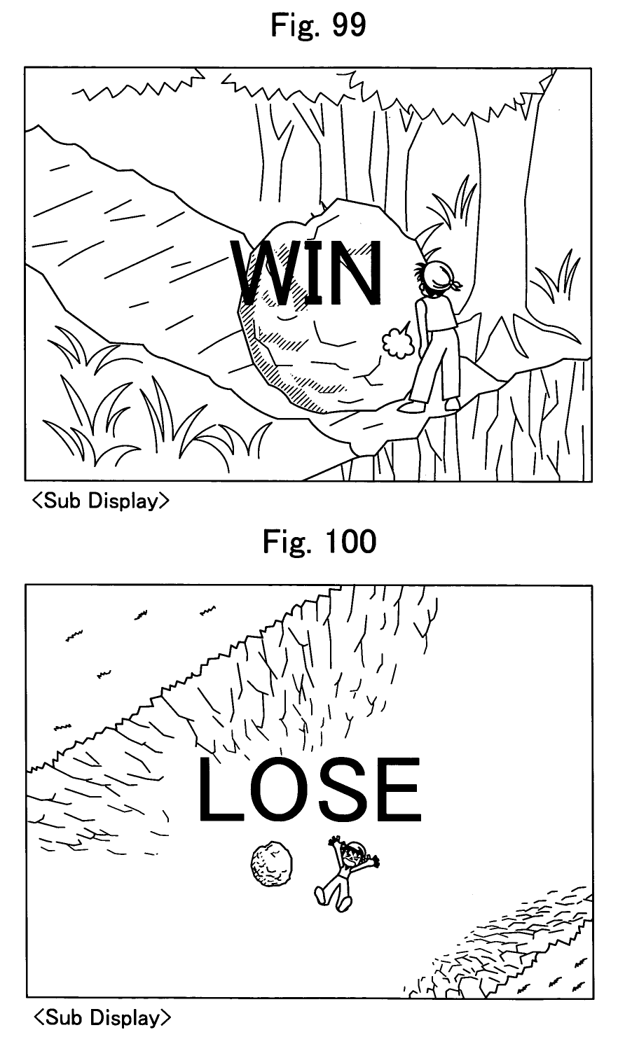

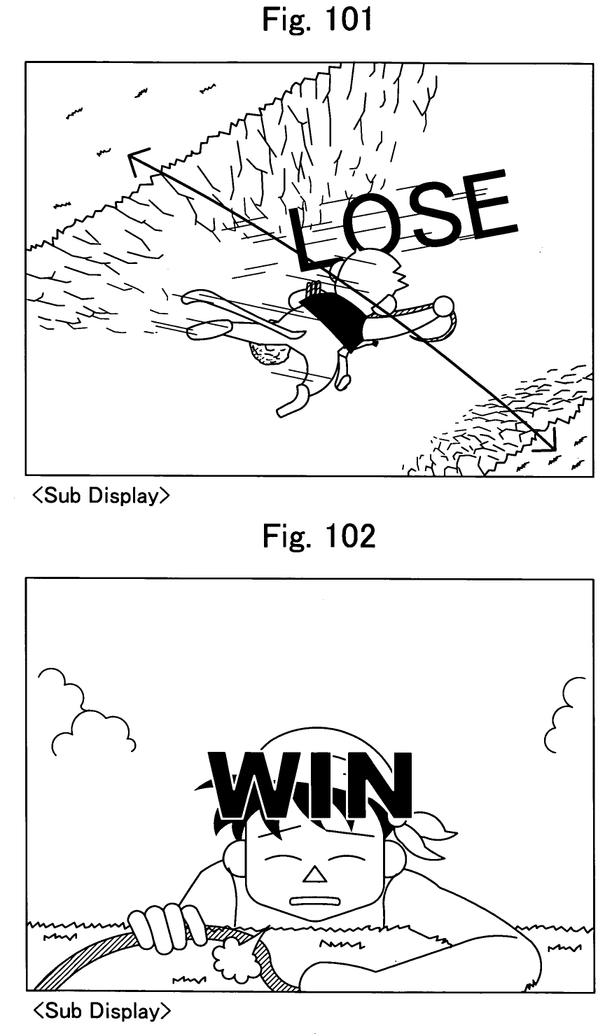

When the main character stops at a block of “ROCK”, the sub control circuit 171 reads out a rock game effect command from the FORTUNE ISLAND BONUS demonstration data table (see, FIG. 27) which is stored in the sub ROM 223 (see, FIG. 6), and transmits it to the sub CPU 221, and the sub CPU 221, which receives that demonstration command, reads out demonstration data which corresponds to the FORTUNE ISLAND BONUS start demonstration command, with reference to the FORTUNE ISLAND BONUS demonstration data table, to display a corresponding game effect on the sub display 3. FIG. 98 shows an image of a corresponding game effect, which is displayed on the sub display 3. In case the main character could stop the “ROCK”, a life point of the main character does not decrease (see, FIG. 99). However, in case the main character could not stop the “ROCK”, the life point of the main character decreases by one (see, FIG. 100). In this regard, however, there is such a case as in FIG. 101 that “MONKEY”, which is a sub character of the main character, appears, and saves the main character, and blocks the decrease of the life point of the main character (see, FIG. 102). Whether the “MONKEY” appears or not is determined, on the basis of one random number value which is selected by software control in the sub control circuit 171, and with reference to a predetermined probability lottery table (not shown in the figure).

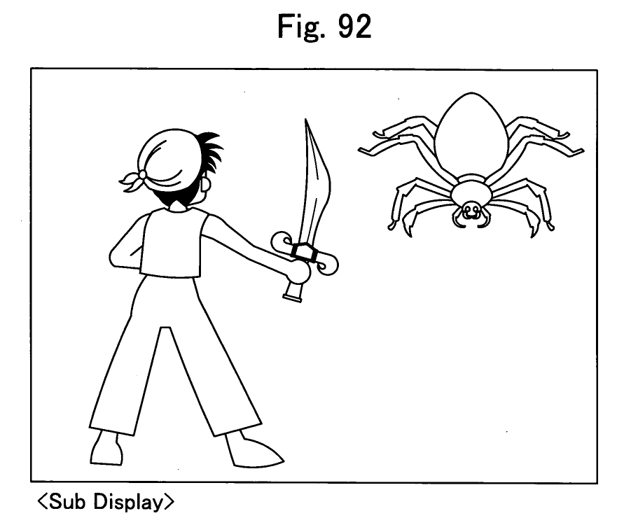

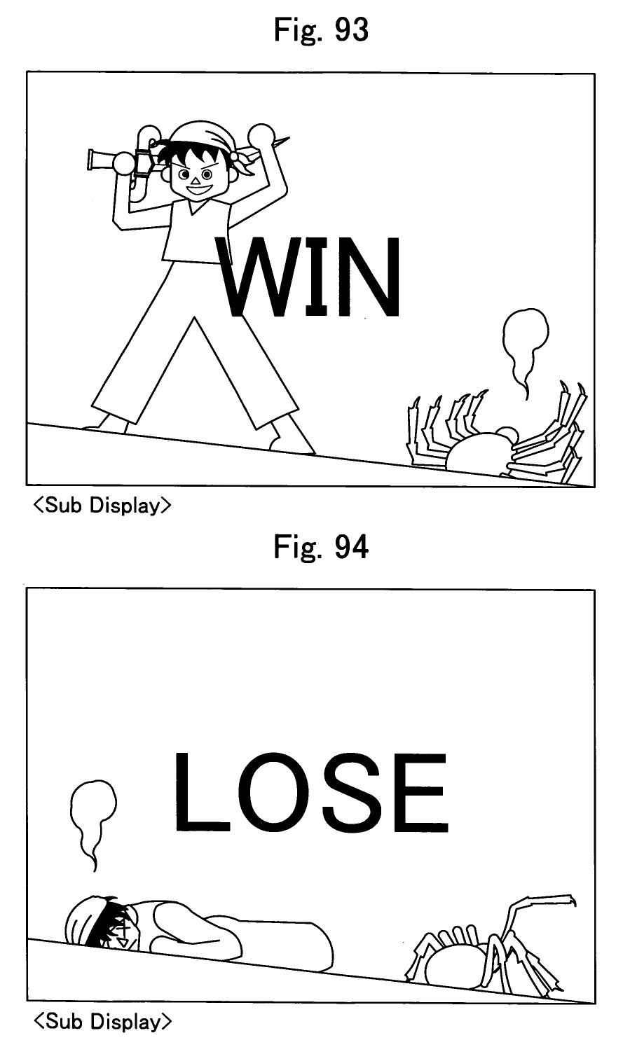

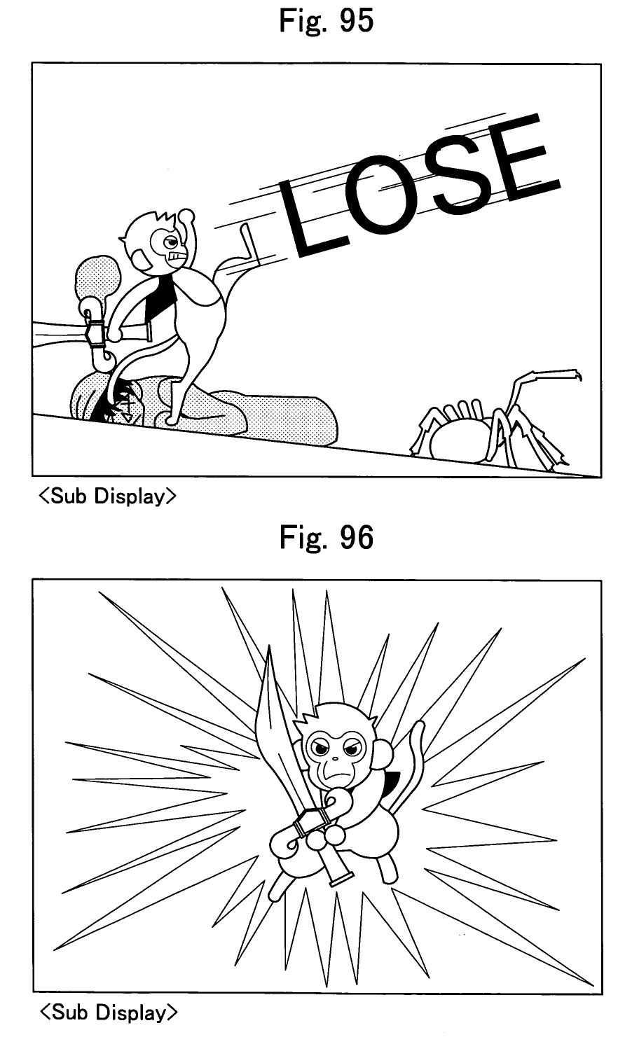

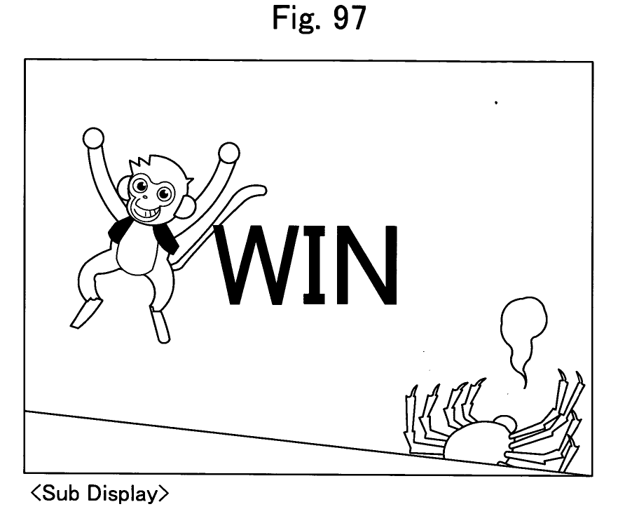

When the main character stops at a block of “BIG SPIDER”, the sub control circuit 171 reads out a big spider game effect command from the FORTUNE ISLAND BONUS effect data table (see, FIG. 27) which is stored in the sub ROM 223 (see, FIG. 6), and transmits it to the sub CPU 221, and the sub CPU 221, which receives that demonstration command, reads out demonstration data which corresponds to the FORTUNE ISLAND BONUS start effect command, with reference to the FORTUNE ISLAND BONUS effect data table, to display a corresponding game effect on the sub display 3. FIG. 92 shows an image of a corresponding game effect which is displayed on the sub display 3. In case the main character wins a battle with “BIG SPIDER”, a life point o the main character does not decrease (see, FIG. 93). However, in case the main character could not win the battle with the “BIG SPIDER”, the life point of the main character decreases by one (see, FIG. 94). In this regard, however, there is such a case as in FIG. 95 that “MONKEY”, which is a sub character of the main character, appears, and fights with the “BIG SPIDER” in lieu of the main character (see FIG. 96), and wins the battle, to block the decrease of the life point of the main character (see FIG. 97). Whether the “MONKEY” appears or not is determined, on the basis of one random number value which is selected by software control in the sub control circuit 171, and with reference to a predetermined probability lottery table (not shown in the figure).

When the main character stops at a block of “BIG SNAKE”, the sub control circuit 171 reads out a big snake game effect command from the FORTUNE ISLAND BONUS effect data table (see, FIG. 27) which is stored in the sub ROM 223 (see FIG. 6), and transmits it to the sub CPU 221, and the sub CPU 221, which receives that demonstration command, reads out demonstration data which corresponds to the FORTUNE ISLAND BONUS start effect command, with reference to the FORTUNE ISLAND BONUS demonstration data table, to display a corresponding game effect on the sub display 3. A factor of increase and decrease of a life point when the main character stopped at the block of “BIG SNAKE” is similar to that when the main character stopped at the block of “BIG SPIDER”.

Next, in a step S163, it is determined whether a life point of the main character is “0” or not. The sub control circuit 171 determined whether the life point of the main character is “0” or not. When this determination is YES, processing is shifted to the step S161, and when it is NO, processing is shifted to the step S154.

[Details of BANDIT'S HIDEOUT BONUS Start Reception Processing]

FIG. 34 shows the step S151 of bonus game processing of FIG. 31, which is processing to be carried out by the sub control circuit 171, when the sub control circuit 171 (see FIG. 6) receives a BANDIT'S HIDEOUT BONUS start command which is transmitted from the main control circuit 50a (see FIG. 5). This processing is, i.e., processing of BANDIT'S HIDEOUT BONUS.

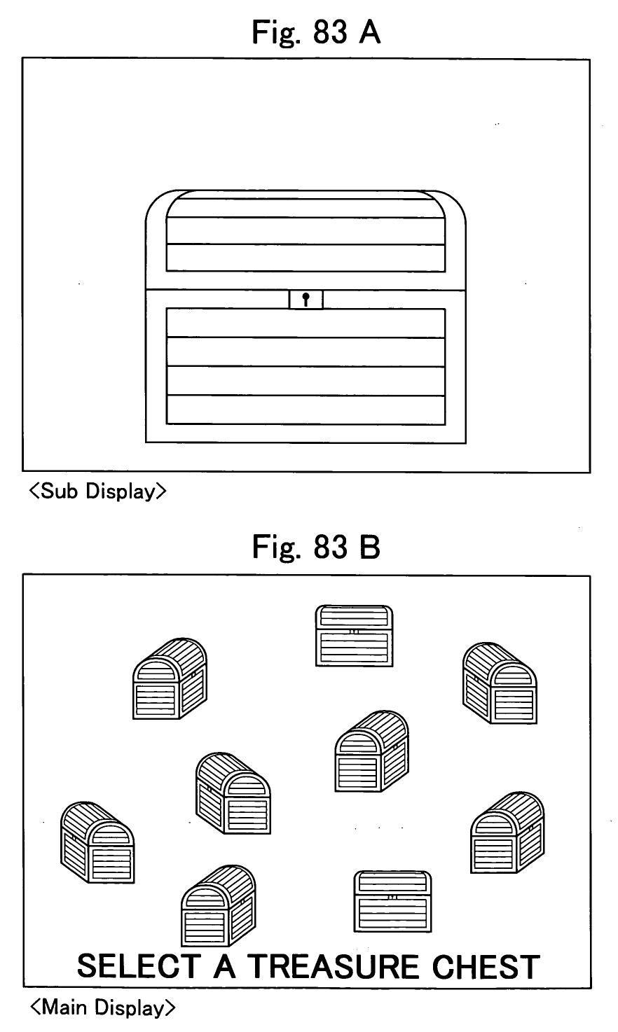

In a step S171, initial screen display processing is carried out. The sub control circuit 171 reads out the BANDIT'S HIDEOUT BONUS start effect command from a BANDIT'S HIDEOUT BONUS effect table (see FIG. 26) which is stored in the sub ROM 223 (see FIG. 6), and transmits it to the sub CPU 221, and the sub CPU 221, which receives that demonstration command, reads out demonstration data which corresponds to the BANDIT'S HIDEOUT BONUS demonstration command, with reference to the BANDIT'S HIDEOUT BONUS demonstration data table, to display a corresponding game effect on the sub display 3 and the main display 4. FIG. 83 shows an image of its initial screen. Meanwhile, “TREASURE BOX” is displayed on the sub display 3 with the initial screen, and a plurality of “TREASURE BOXES” are displayed on display of the main display 4 in a lower side figure of FIG. 83. A player selects any one of those “TREASURE BOXES”, and thereby, a bonus game goes on. A content of the “TREASURE BOX” is three kinds such as “TREASURE”, “LUCKY ITEM”, and “SKULL”, and determination of content of the “TREASURE BOX” is carried out in advance, in the course of processing for which an initial screen is displayed, by selection of one random number value by software control of the sub control circuit 171, on the basis of that random number value, with reference to a predetermined probability lottery table (not shown in the figure).

Next, in a step S172, treasure box selection acceptance processing is carried out. The player touches an arbitrary one among a plurality of “TREASURE BOXES” which are displayed on the main display 4, and the touch panel 30 detects it, and a detection signal is transmitted to the touch panel control circuit 76, and thereby, the sub control circuit 171 recognizes that display is touched by a player.

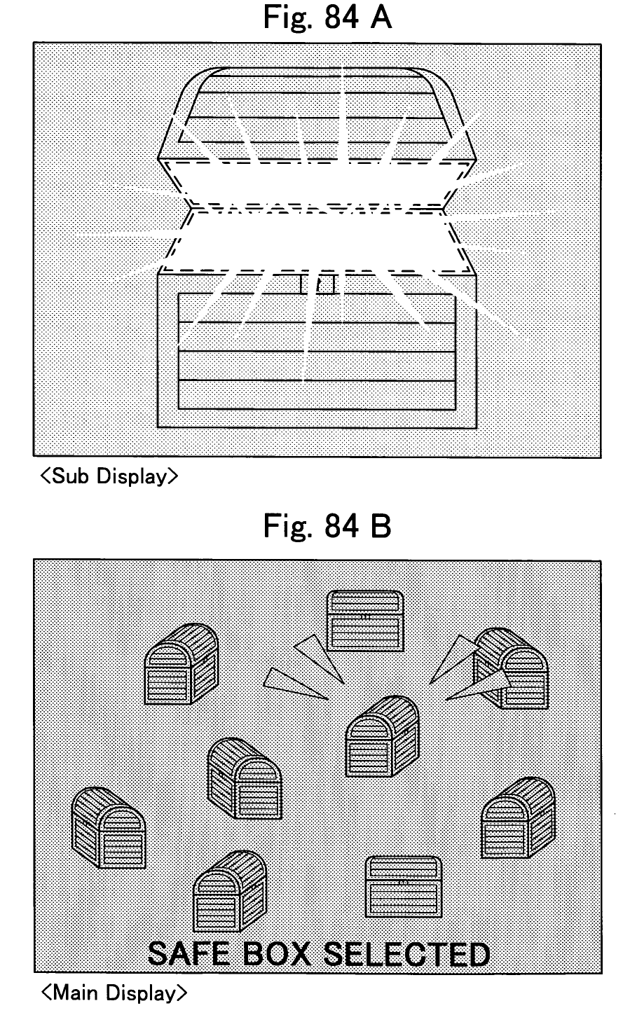

Next, in a step S173, processing of displaying such a game effect that the selected treasure box is opened on the sub display 3 is carried out. The sub control circuit 171 reads out a treasure box open demonstration command from the BANDIT'S HIDEOUT BONUS demonstration data table (see, FIG. 26) which is stored in the sub ROM 223 (see FIG. 6), and transmits it to the sub CPU 221, and the sub CPU 221, which receives that demonstration command, reads out demonstration data which corresponds to the treasure box open demonstration command, with reference to the BANDIT'S HIDEOUT BONUS effect data table, to display a corresponding game effect, on the sub display 3. FIG. 84 shows an image of that game effect.

Next, in a step S174, determination of whether content of a treasure box is a skull or not is carried out. The sub control circuit 171 carries out determination of whether content of a treasure box is a skull or not. When this determination is YES, processing is shifted to a step S175, and when it is NO, processing is shifted to a step S178.

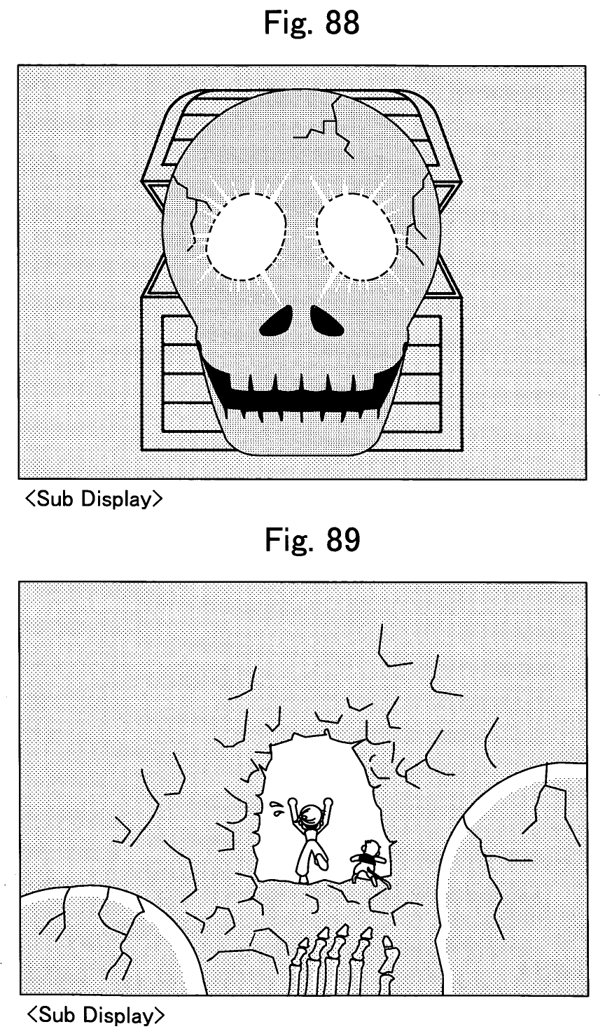

Next, in the step S175, processing of displaying a game effect of a skull on the sub display 3 is carried out. The sub control circuit 171 reads out a “skull appearance demonstration command” from the BANDIT'S HIDEOUT BONUS demonstration data table (see FIG. 26) which is stored in the sub ROM 223 (see FIG. 6), and transmits it to the sub CPU 221, and the sub CPU 221, which receives that demonstration command, reads out demonstration data which corresponds to the “skull appearance demonstration command”, with reference to the BANDIT'S HIDEOUT BONUS effect data table, to display a corresponding game effect on the sub display 3. FIG. 88 is an image of that game effect.

Next, in a step S176, processing of displaying a game effect of a main character which runs away in a hang of a hurry is carried out. The sub control circuit 171 reads out a “demonstration command for a main character which runs away from a skull” from the BANDIT'S HIDEOUT BONUS demonstration data table (see FIG. 26) which is stored in the sub ROM 223 (see FIG. 6), and transmits it to the sub CPU 221, and the sub CPU 221, which receives that demonstration command, reads out demonstration data which corresponds to the “demonstration command for the main character which runs away from a skull”, with reference to the BANDIT'S HIDEOUT BONUS demonstration data table, to display a corresponding game effect on the sub display 3. FIG. 89 shows an image of that game effect.

Next, in a step S177, processing of transmitting a BANDIT'S HIDEOUT BONUS completion command to the main control circuit 50a. The sub control circuit 171 transmits the BANDIT'S HIDEOUT BONUS completion command, to the main control circuit 50a. In addition, display of the sub display 3 is restored to payout display. When this processing is finished, this routine is finished.

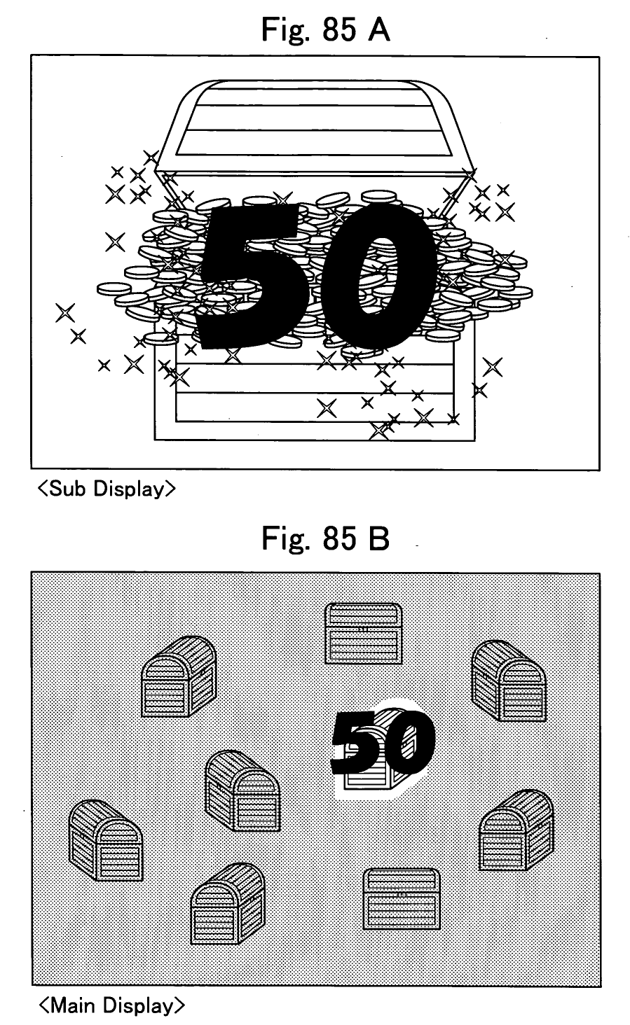

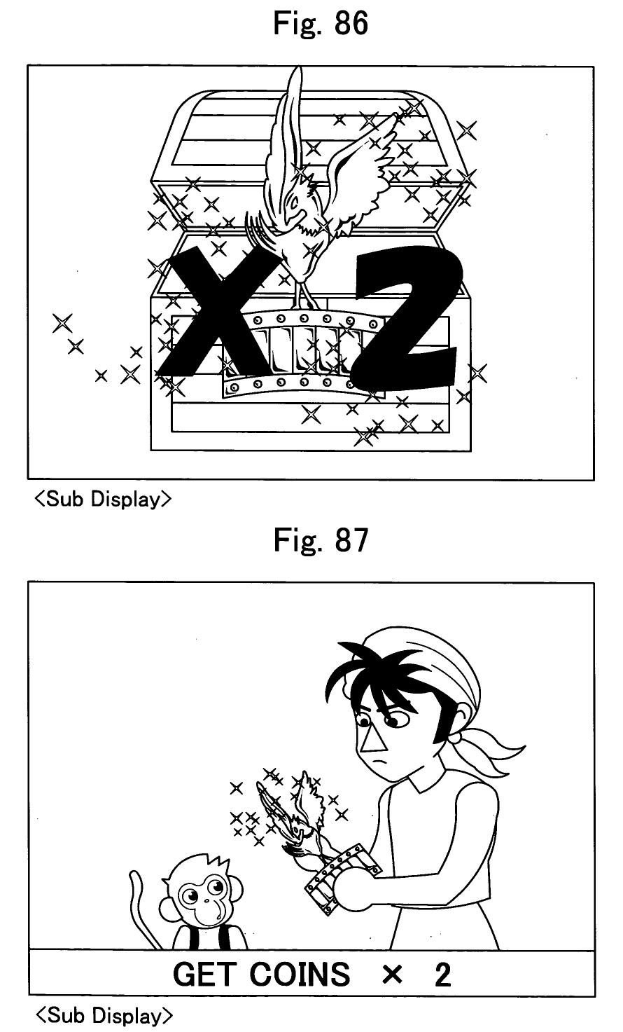

On one hand, in a step S178, processing of “displaying a game effect of treasure or lucky item on the sub display, and displaying an acquired point etc. on a treasure box game effect which is displayed on the main display “is carried out. The sub control circuit 171 reads out a “treasure appearance effect command” or a “lucky item appearance command” from the BANDIT'S HIDEOUT BONUS effect data table (see FIG. 26) which is stored in the sub ROM 223 (see FIG. 6), and transmits it to the sub CPU 221, and the sub CPU 221, which receives that demonstration command, reads out demonstration data which corresponds to the “treasure appearance effect command” or the “lucky item appearance command”, respectively, with respect to the BANDIT'S HIDEOUT BONUS effect data table, to display a corresponding game effect on the sub display 3. FIGS. 85 and 86 shows images of that game effects. Here, for example, in case fifty coins could be acquired, in order to identify a treasure box from which fifty coins appear on a screen of the main display in a lower side figure of FIG. 85B. display of “50” is added to that treasure box. Also in acquisition of the “LUCKY ITEM (an item which doubles the number of coins which a player has, by crediting it at that time point, etc.)”, in the same manner, in order to identify a treasure box from which the “LUCKY ITEM” appear, image display of “LUCKY ITEM” is added to that treasure box.

Next, in a step S179, processing of displaying a game effect of a main character which acquires treasure of lucky item and feels delight on the sub display is carried out. The sub control circuit 171 reads out a “treasure main character effect command” or a “lucky item main character effect command” from the BANDIT'S HIDEOUT BONUS data table (see FIG. 26) which is stored in the sub ROM 223 (see FIG. 6), and transmits it to the sub CPU 221, and the sub CPU 221, which receives that demonstration command, reads out demonstration data which corresponds to the “treasure main character effect command” or the “lucky item main character effect command”, respectively, with reference to the BANDIT'S HIDEOUT BONUS effect data table, to display a corresponding game effect on the sub display 3. FIG. 87 shows an image of that game effect.

Next, in a step S180, acquired point addition processing is carried out. The sub control circuit 171 adds coins which are acquired in the step S178 to credit number.

Next, in a step S181, determination of whether the predetermined number of treasure boxes are selected or not. The sub control circuit 171 carries out determination of whether the predetermined number of treasure boxes are selected by the player or not. When this determination is YES, processing is shifted to the step S177, and when it is NO, processing is shifted to the step S172.

[Details of Demonstration Which Corresponds to Winning Combination and Reel Stop Processing]

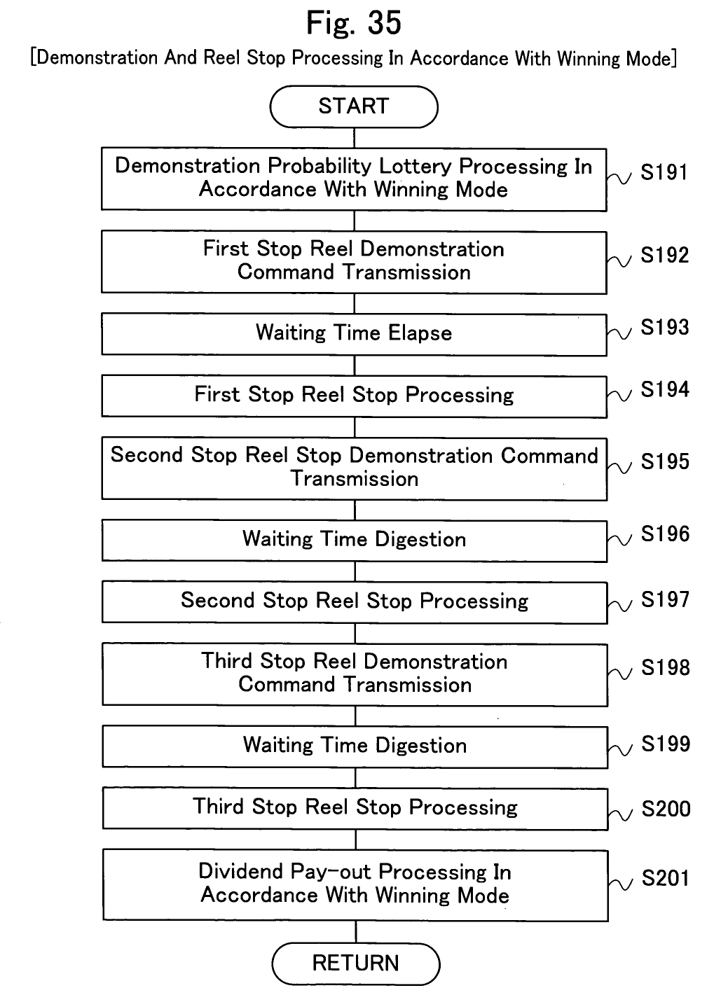

With reference to FIG. 35, details of a demonstration which corresponds to a winning combination and reel stop processing, which is carried out in the step S112 of FIG. 29, will be described. Meanwhile, in this processing, a winning combination is other than the “bonus game” and the “loss”.

In a step S191, probability lottery processing of a demonstration which corresponds to a winning combination is carried out. The main control circuit 50a (see FIG. 5) controls the random number sampling circuit 56 (see FIG. 5), and extracts one random number value from random number values that the random number generator 55 (see FIG. 5) generates. On that random number value, the main control circuit 50a further determines “succeeding game effect” (dolphin (snake) succeeding game effect, seagull (buzzard) succeeding game effect, monkey succeeding game effect) which corresponds to each winning combination (WILD, RED7, 3BAR, 2BAR, BAR, ANYBAR), with reference to the “effect selection probability lottery table which corresponds to a winning combination (except for bonus game or loss)” (see FIG. 15) which is stored in ROM 51 (see, FIG. 5).

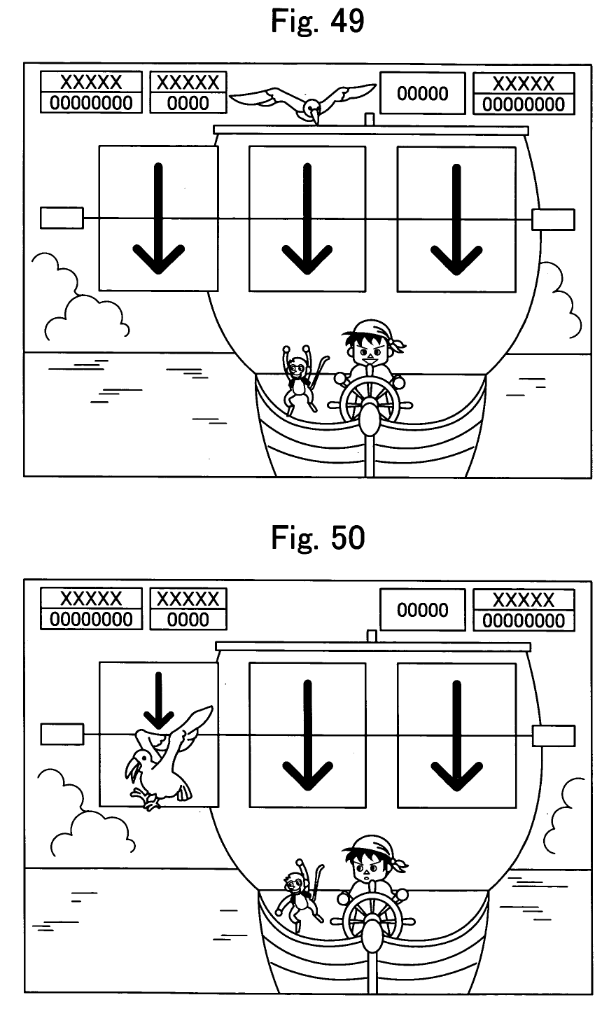

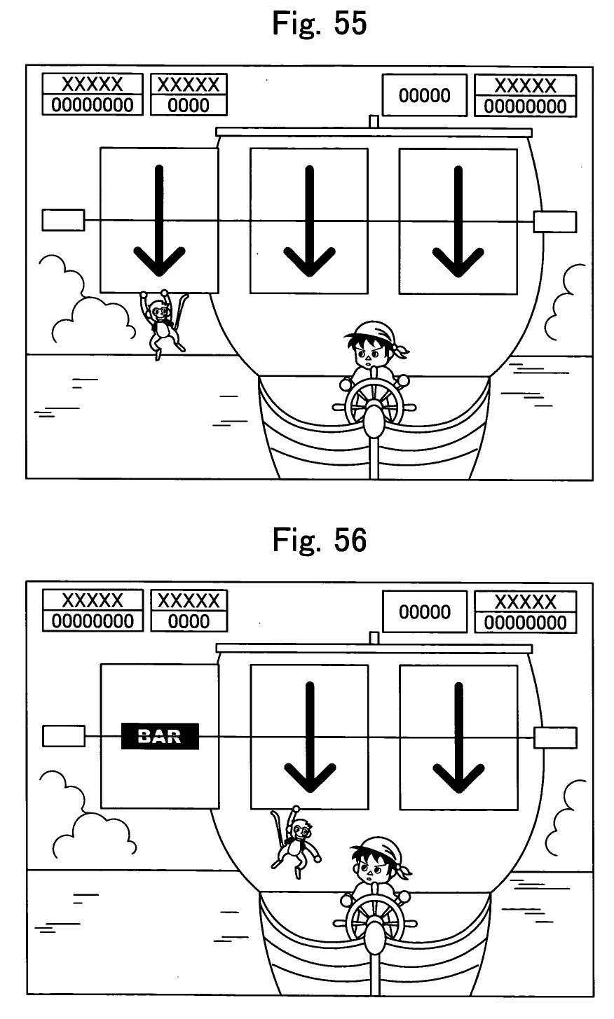

Next, in a step S192, processing of “first stop reel demonstration command transmission” is carried out. The main control circuit 50a (see FIG. 5) transmits a demonstration command of a reel which stops firstly, in accordance with the “succeeding game effect” which is determined in the step S191 and the stopping order which is determined in the reel stopping order determination processing of the step S109 of FIG. 29. That is, the main control circuit 50a transmits a “success command” (any one of seagull demonstration commands 1˜3, buzzard demonstration commands 1˜3, and monkey demonstration commands 1˜3 (see FIG. 21)) which corresponds to the demonstration which is determined in the step S191 and the stopping order which is determined in the reel stopping order determination processing of the step S109 of FIG. 29, to the sub control circuit 171 (see FIG. 6), and the sub control circuit 171, which receives that demonstration command, reads out demonstration data (see, FIG. 21) which corresponds to that demonstration command from the sub ROM 223 (see FIG. 6), and the sub CPU 221 (see FIG. 6) controls the image display control circuit 75, to carry out a relevant effect. FIGS. 49 and 50 show an image of effect display when the first stop reel is the reel 22L and the “succeeding game effect” is the “seagull succeeding game effect”. FIG. 55 shows an image of demonstration display when the first stop reel is the reel 22L and the “succeeding game effect” is the “monkey succeeding game effect”.

Next, in a step S193, waiting time elapse processing is carried out. The main control circuit 50a is turned in a waiting state for a given length of time, to wait ready until the demonstration, which is instructed for execution in the step S192, is completed.

Next, in a step S194, stop processing of a first stop reel is carried out. The main control circuit 50a controls the motor drive circuit 67 (see FIG. 5), to carry out stop processing of the first stop reel on the basis of information of an appearing symbol of the first stop reel which is stored in RAM 52 (see FIG. 5) in the step S106 of FIG. 28.

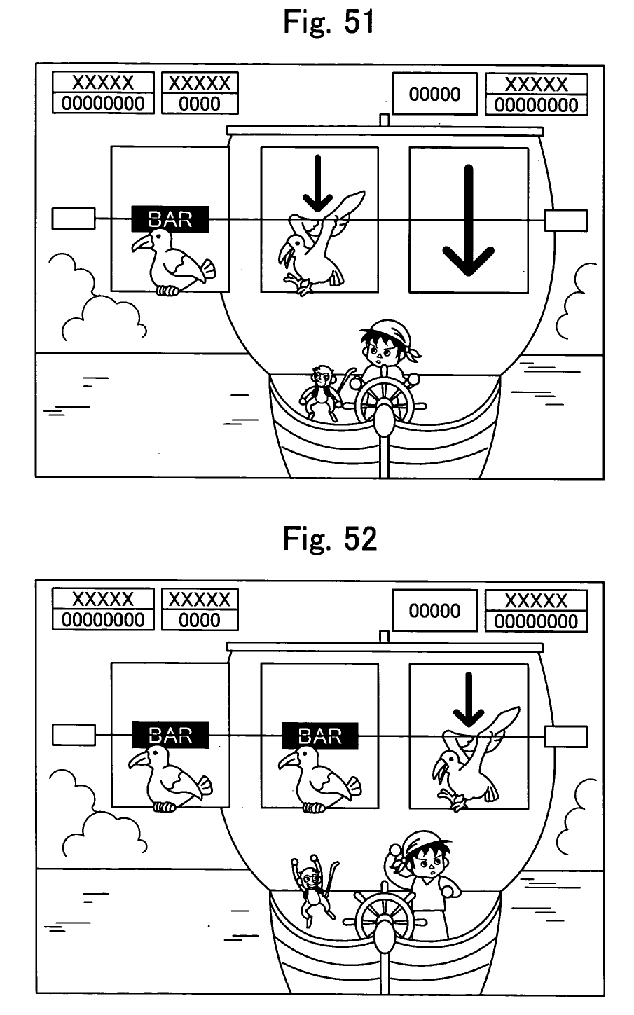

Next, in a step S195, “second stop reel effect command transmission” processing is carried out. The main control circuit 50a transmits an effect command of a reel which stops secondly, in accordance with the “succeeding game effect” which is determined in the step S191 and the stopping order which is determined in the reel stopping order determination processing of the step S109 of FIG. 29. This processing is almost similar to that of the step S192. FIG. 51 shows an image of demonstration display when the second stop reel is the reel 22C and the “succeeding game effect” is the “seagull succeeding game effect”. FIG. 56 shows an image of demonstration display when the second stop reel is the reel 22C and the “succeeding game effect” is the “monkey succeeding game effect”.

Next, in a step S196, processing, which is similar to that of the step S193, is carried out, and the main control circuit 50a waits ready until the demonstration, which is instructed for execution in the step S195, is completed.

Next, in a step S197, second stop reel stop processing is carried out. The main control circuit 50a controls the motor drive circuit 67, to carry out stop processing of the second stop reel, on the basis of information of an appearing symbol of the second stop reel which is stored in RAM 52 in the step S106 of FIG. 28.

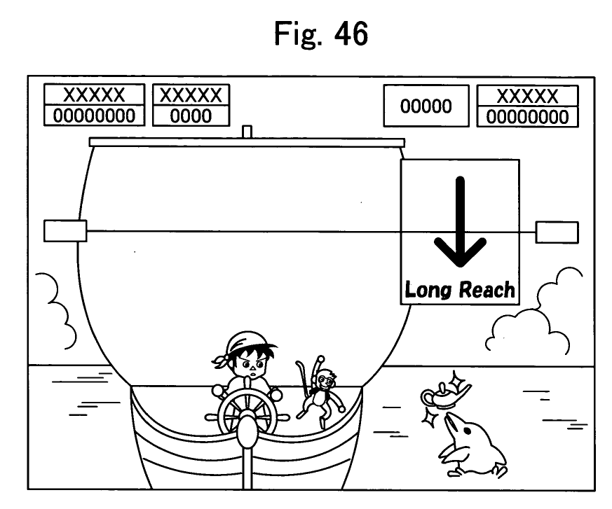

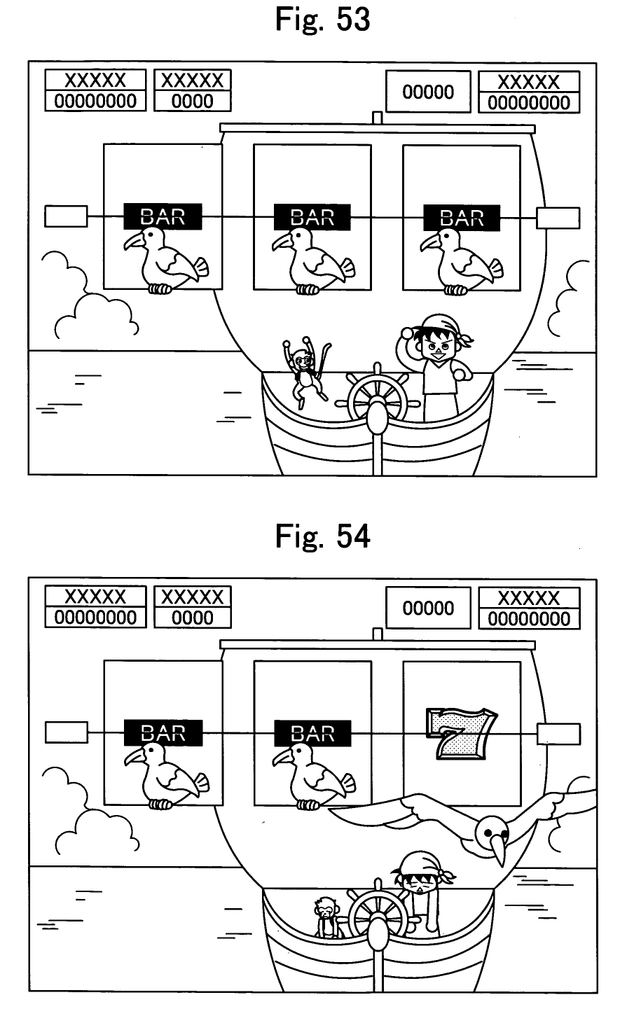

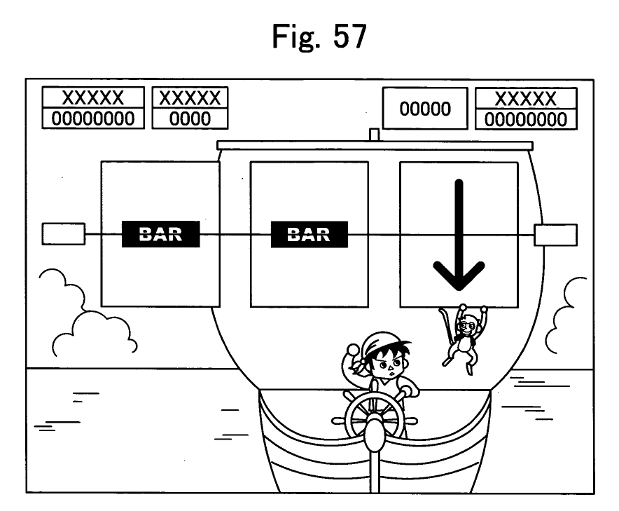

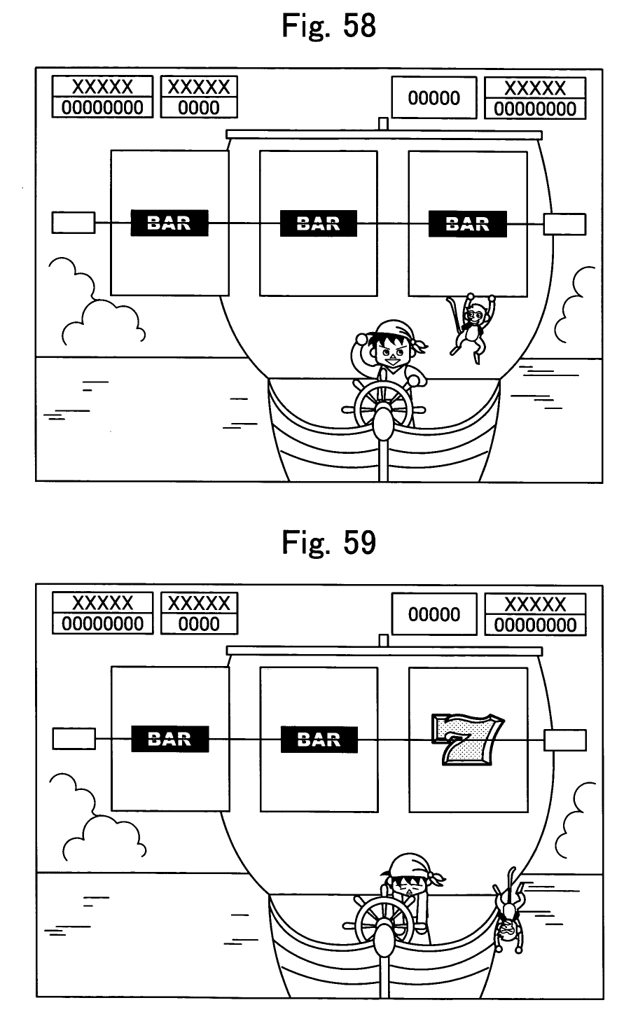

Next, in a step S198, “third stop reel effect command transmission” processing is carried out. This processing is almost similar to that of the step S192. FIG. 46 shows an image of effect display when the third stop reel is the reel 22R and the “succeeding game effect” is the “dolphin succeeding game effect”. FIGS. 52 and 53 shows images of demonstration display when the third stop reel is the reel 22R and the “succeeding game effect” is the “seagull succeeding game effect”. FIGS. 57 and 58 shows images of demonstration display when the third stop reel is the reel 22R and the “succeeding game effect” is the “monkey succeeding game effect”.

Next, in a step S199, processing, which is similar to that of the step S193, is carried out, and the main control circuit 50a waits ready until the demonstration, which is instructed for execution in the step S198.

Next, in a step S200, third stop reel stop processing is carried out. The main control circuit 50a controls the motor drive circuit 67, to carry out stop processing of the third stop reel, on the basis of information of a stop symbol of the third stop reel which was stored in RAM 52 in the step S106 of FIG. 28.

Next, in a step S201, pay-out processing of a payout which corresponds to a winning combination is carried out. The main control circuit 50a carries out pay-out of a payout which corresponds to a winning combination which was determined in the step S110 of FIG. 29, in accordance with information of winning time payout number of the winning combination determination table (see FIG. 10) which is stored in ROM 51 (see FIG. 5) and BET number. The main control circuit 50a transmits a drive instruction to the hopper drive circuit 70 (see FIG. 5), and the hopper drive circuit 70 (see FIG. 5), which receives that drive instruction, controls the hopper 71 (see FIG. 5) to carry out pay-out of a coin. At this time, the coin detection section 73 (see FIG. 5) calculates the number of coins which are paid out, and when it determines that the number reached predetermined number, transmits a pay-out completion signal to the pay-out completion signal circuit 72 (see FIG. 5). The pay-out completion signal circuit 72, which receives the pay-out completion signal, outputs such a request that the hopper drive circuit 70 transmits a signal for stopping drive of the hopper 71, to the main control circuit 50a. When this processing is finished, this subroutine is finished, and processing is shifted to the step S102 of FIG. 28.

As above, by carrying out processing of the step S192, the step S195, and the step S198, it is possible to interlock a stop of variable display of reels and a game effect which is displayed on the main display 4, with visual relevancy.

In particular, when the “succeeding game effect” is the “seagull succeeding game effect” (or the “buzzard succeeding game effect”), a seagull stays in an area of the display windows 23, 24, 25 of the reels 22L, 22C, 22R, and thereby, it is possible to notify to a player that such a possibility that a predetermined winning combination occurs is high. In addition, by this means, it is possible for a player to carry out a game with feeling of expectancy.

In addition, when the “succeeding game effect” is the “monkey succeeding game effect”, by carrying out such a demonstration that a monkey hangs down on the display windows 23, 24, 25 of the reels 22L, 22C, 22R, and the monkey moves a display window on which it hangs on sequentially, in accordance with a stopping order of the reels 22L, 22C, 22R, it is possible to notify a reel which stops next, to a player.

[Details of MAGIC LAMP BONUS Processing]

With reference to FIGS. 36 and 37, details of MAGIC LAMP BONUS processing, which is carried out in the step S203 of FIG. 35, will be described. This processing is processing which is carried out in the main control circuit 50a (see FIG. 5). Meanwhile, MAGIC LAMP BONUS is a so-called free game, and is such a game that it is not necessary for a player to make BET (to bet a coin). As BET number in MAGIC LAMP BONUS, BET number in the base game which is shifted to MAGIC LAMP BONUS is used as it is. For example, when the BET number in the base game which is shifted to MAGIC LAMP BONUS is 3, as long as MAGIC LAMP BONUS continues, a game of MAGIC LAMP BONUS with the BET number of 3 is played.

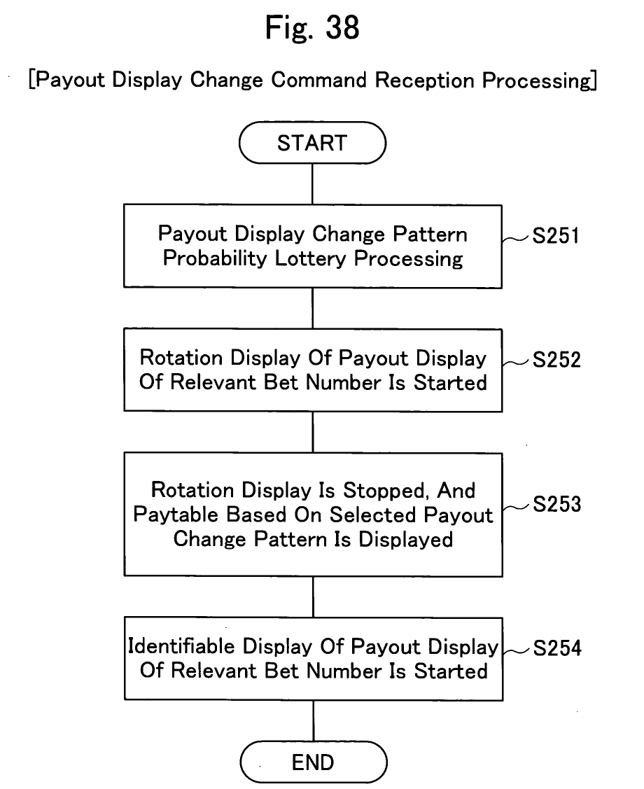

In a step S211, payout display change command transmission processing is carried out. The main control circuit 50a transmits a payout display change command to the sub control circuit 171 (see FIG. 6), and the sub control circuit 171, which receives that command, carries out payout display change command reception processing of FIG. 38, which will be described later. In this step S211, payout information before it is shifted to MAGIC LAMP BONUS is further stored in RAM 52 (see, FIG. 5). In case it is shifted to MAGIC LAMP BONUS by execution of this processing, display of a demonstration screen on the sub display 3 is not carried out, and a payout table including payout information after it is shifted to MAGIC LAMP BONUS is displayed.

In a step S212, processing of initializing a reel spin number counter is carried out. The main control circuit 50a sets “0” (clears) to the reel rotation number counter which is a variable stored in RAM 52 (see, FIG. 5).

In a step S213, processing of adding one to the reel spin number counter is carried out. The main control circuit 50a adds “1” to the reel spin number counter which is a variable stored in RAM 52 (see FIG. 5).

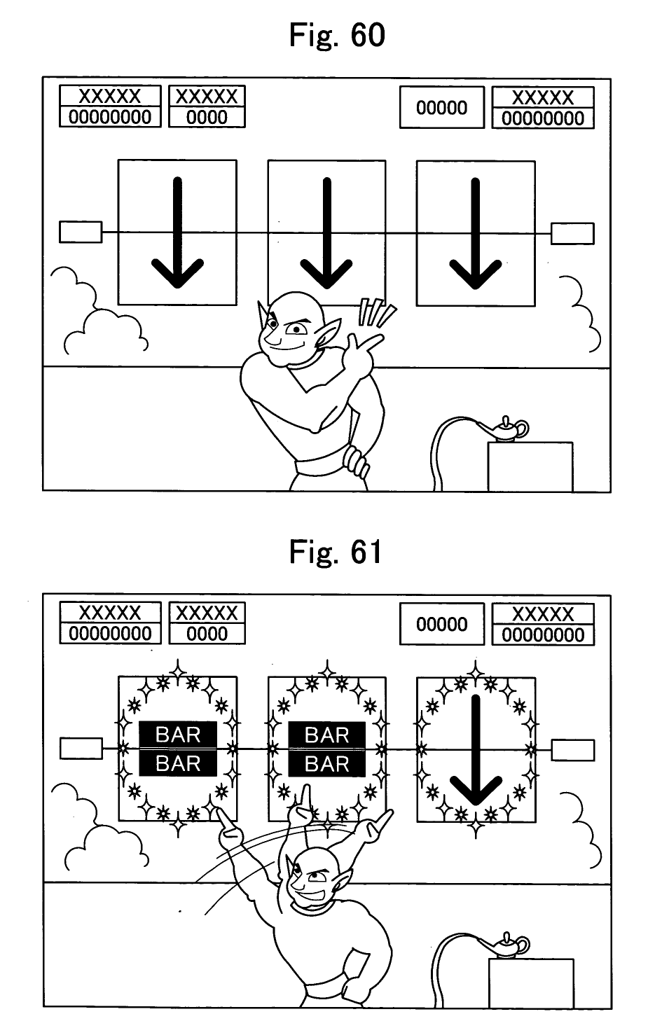

Next, in a step S214, reel spin processing is carried out. The main control circuit 50a controls the motor drive circuit 67 (see FIG. 5), to start drive of the stepping motors 68L, 68C, 68R, and thereby, spin of the reels 22L, 22C, 22R is started. Meanwhile, at this time, the main control circuit 50a transmits a reel spin start demonstration command. That is, the main control circuit (see FIG. 5) transmits the reel rotation start demonstration command (see FIG. 23) to the sub control circuit 171 (see FIG. 6), and the sub control circuit 171, which receives that demonstration command, reads out demonstration data (see FIG. 23) which corresponds to that demonstration command, from the sub ROM 223 (see FIG. 6), and the sub CPU 221 (see FIG. 6) controls the image display control circuit 75, to carry out a relevant demonstration. Meanwhile, FIG. 60 shows an image which is displayed on the main display 4, in accordance with the demonstration data which corresponds to the reel rotation start demonstration command.

Next, in a step S215, processing of determining a symbol which appears at the reels 22L, 22C, 22R by probability lottery (probability lottery processing) is carried out. The main control circuit 50a controls the random number sampling circuit 56 (see FIG. 5), and extracts one random number value from random number values that the random number generator 55 (see FIG. 5) generates. On that random number value, the main control circuit 50 further determines an appearing symbol which is common to each reel 22L, 22C, 22R, with reference to a MAGIC LAMP BONUS probability lottery table shown in FIG. 9. As to the determined stop symbol, code numbers which correspond to respective symbols shown in FIG. 4 are stored in RAM 52.

Next, in a step S216, reel stop order determination processing is carried out. The main control circuit 50a controls the random number sampling circuit 56, and extracts one random number value from random number values that the random number generator 55 generates. On that random number value, the main control circuit 50a further determines a stopping order of each reel 22L, 22C, 22R, with reference to the reel stop order determination probability lottery table shown in FIG. 12. The determined stopping order of the reels 22L, 22C, 22R is stored in RAM 52.

Next, in a step S217, “first stop reel demonstration command transmission” processing is carried out. The main control circuit 50a transmits a demonstration command of a reel which stops firstly, in accordance with the stopping order which is determined in the reel stopping order determination processing of the step S216. That is, the main control circuit 56 transmits magic demonstration commands 1 to 3 (see FIG. 23) which correspond to the stopping order which was determined in the reel stopping order determination processing of the step S2216, to the sub control circuit 171, and the sub control circuit 171, which receives that demonstration command, reads out demonstration data (see FIG. 23) which corresponds to that demonstration command, from the sub ROM 223 (see FIG. 6), and the sub CPU 221 (see FIG. 6) controls the image display control circuit 75, to carry out a relevant effect. For example, when a reel which stops firstly is the reel 22L, the main control circuit 50a transmits the magic demonstration command 1 (see FIG. 23) to the sub control circuit 171, and the sub control circuit 171, which receives that demonstration command, reads out demonstration data (see FIG. 23) which corresponds to that demonstration command, from the sub ROM 223 (see FIG. 6), and the sub CPU 221 (see FIG. 6) controls the image display control circuit 75 to carry out a relevant effect. Meanwhile, FIG. 61 shows an image which is displayed on the main display 4, in accordance with demonstration data which corresponds to the magic demonstration commands 1 to 3.

Next, in a step S218, waiting time elapse processing is carried out. The main control circuit 50a is turned in a waiting state for a given length of time, and waits ready until a demonstration, which is instructed for execution in the step S217, is completed.

Next, in a step S219, stop processing of a first stop reel is carried out. The main control circuit 50a controls the motor drive circuit 67, to carry out stop processing of the first stop reel, on the basis of information of a stop symbol of the first stop reel which is stored in RAM 512 (see FIG. 5) in the step S215.

Next, in a step S220, “second stop reel demonstration command transmission” processing is carried out. The main control circuit 50a transmits a demonstration command of a reel which stops firstly, in accordance with the stopping order which is determined in the reel stopping order determination processing of the step S216. In the same manner as in the step S195, transmission of a demonstration command is carried out between the main control circuit 50a and the sub control circuit 171, and on the basis of that demonstration command, execution of the demonstration is carried out. For example, when a reel which stops secondly is the reel 22C, the main control circuit 50a transmits the magic demonstration command 2 (see FIG. 23) to the sub control circuit 171, and the sub control circuit 171, which received that demonstration command, reads out demonstration data (see FIG. 23) which corresponds to that demonstration command from the sub ROM 223, and the sub CPU 211 controls the image display control circuit 75 to carry out a relevant effect. Meanwhile, FIG. 61 show an image which is displayed on the main display 4, in accordance with effect data which corresponds to the magic demonstration commands 1 to 3.

Next, in a step S221, waiting time digestion processing is carried out. The main control circuit 50a is turned in a waiting state for a given length of time, to wait ready until the demonstration, which is instructed for execution in the step S220, is completed.

Next, in a step S222, second stop reel stop processing is carried out. The main control circuit 50a controls the motor drive circuit 67, to carry out stop processing of the second stop reel, on the basis of information of a stop symbol of the second stop reel which is stored in RAM 52 in the step S106 of FIG. 28.

Next, in a step S223, lottery processing of whether NUDGE of a third stop reel is carried out or not is carried out. The main control circuit 50a controls the random number sampling circuit 56, and extracts one random number value from random number values that the random number generator 55 generates. On the basis of that random number value, the main control circuit 50a further determines whether NUDGE is carried out or not, with reference to a predetermined probability lottery table (not shown in the figure).

Next, in a step S224, “third stop reel demonstration command transmission” processing is carried out. The main control circuit 50a transmits a demonstration command of a reel which stops thirdly, in accordance with the stopping order which is determined in the reel stopping order determination processing in the step S216. In the same manner as in the step S195, transmission of the relevant demonstration command is carried out from the main control circuit 50a to the sub control circuit 171, and on the basis of that demonstration command, execution of a corresponding demonstration is carried out in the sub control circuit 171. For example, when a reel which stops thirdly is the reel 22C, the main control circuit 50a transmits a magic demonstration command 3 (see FIG. 23) to the sub control circuit 171, and the sub control circuit 171, which received that demonstration command, reads out demonstration data (see FIG. 23) which corresponds to that demonstration command, and the sub CPU 221 controls the image display control circuit 75, to carry out a relevant demonstration. Meanwhile, FIG. 61 shows an image which is displayed on the main display 4, in accordance with demonstration data which corresponds to the magic demonstration commands 1 to 3.

Next, in a step S225, waiting time digestion processing is carried out. The main control circuit 50a is turned in a waiting state for a given length of time, to wait ready until the demonstration, which is instructed for execution in the step S224, is completed.

Next, in a step S226 of FIG. 37, determination of whether a winning combination is WILD or not is carried out. The main control circuit 50a determines whether the winning combination, which is determined in the step S215, is WILD or not. When this determination is YES, processing is shifted to a step S234, and when it is NO, processing is shifted to a step S227.

Next, in the step S227, determination of whether NUDGE of a third stop reel is carried out or not is carried out. The main control circuit 50a determines whether it is determined in the step S223 that NUDGE is carried out, or not. When this determination is YES, processing is shifted to a step S228, and when it is NO, processing is shifted to a step S234.

Next, in the step S228, stop processing is carried out by moving a third stop reel by predetermined frame number. The main control circuit 50a controls the motor drive circuit 67 to move the third stop reel by predetermined frame number (e.g., it is one frame (i.e., one symbol) but this invention is not limited to this) on the basis of information of a stop symbol of the third stop reel, which is stored in RAM 52 (see FIG. 5) in the step S215 of FIG. 36, and thereby, stop processing of the third stop reel is carried out. As a result of this, a stop symbol of the third stop reel becomes a symbol with a previous code number or a subsequent code number, to a symbol which corresponds to a code number stored in RAM 52 (see FIG. 5) in the step S215.

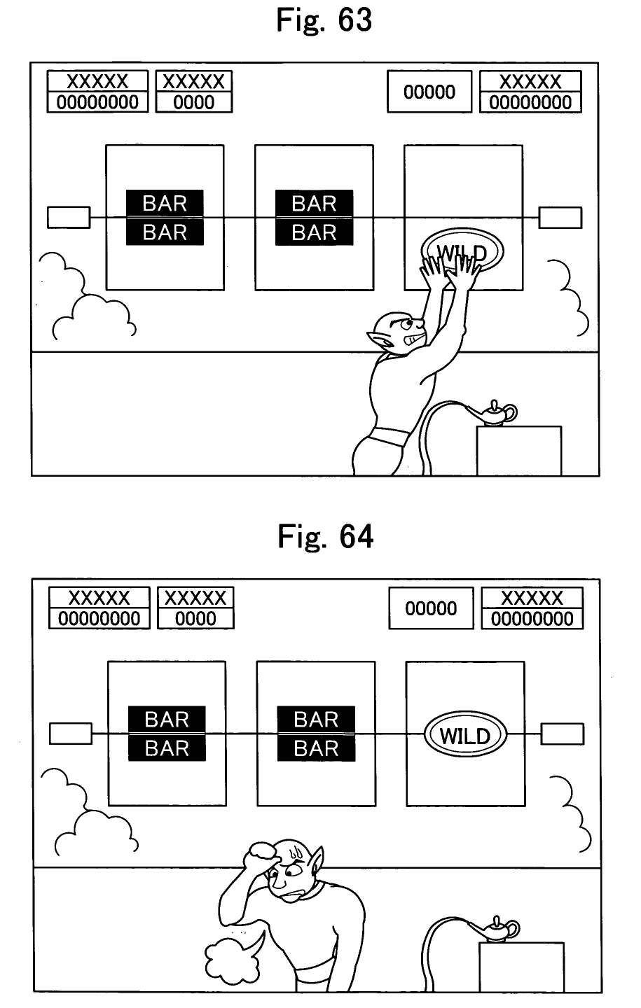

Next, in a step S229, NUDGE demonstration command transmission processing for the third stop reel is carried out. The main control circuit 50a transmits a spirit of lamp hurry-scurry demonstration commands 1 to 3, in accordance with which one of the reels 22L, 22C, 22R is the third stop reel, to the sub control circuit 171, and the sub control circuit 171, which receives that demonstration command, reads out demonstration data (see FIG. 23) which corresponds to that demonstration command, from the sub ROM 223 (see FIG. 6), and the sub CPU 221 (see FIG. 6) controls the image display control circuit 75 to display a relevant demonstration screen. Meanwhile, FIG. 63 shows an image which is displayed on the main display 4, in accordance with demonstration data which corresponds to the spirit of lamp hurry-scurry demonstration commands 1 to 3, respectively, which corresponds to which one of the reels 22L, 22C, 22R is the third stop reel (FIG. 63 shows such a case that the third stop reel, which carries out NUDGE, is the reel 22R).

Next, in a step S230, waiting time elapse processing is carried out. The main control circuit 50a is turned in a waiting state for a given length of time, to wait ready until the demonstration, which is instructed for execution in the step S229, is completed.

Next, in a step S231, third stop reel rotation start processing is carried out. The main control circuit 50a controls the motor drive circuit 67 (see FIG. 5), to start drive of any one of the stepping motors 68L, 68C, 68R, which corresponds to any one of third stop reels 22L, 22C, 22R, and thereby, spin of the third stop reel is reactivated.

Next, in a step S232, third stop reel stop processing is carried out. The main control circuit 50a controls the motor drive circuit 67 to carry out stop processing of a third stop reel, and the WILD symbol 91 (see FIG. 4) is surely brought to a stop, regardless of information of a stop symbol of the third stop reel, which is stored in RAM 52 (see FIG. 5) in the step S215 of FIG. 36. In this way, a final winning combination becomes “1WILD”.

Next, in a step S223, NUDGE completion demonstration command transmission processing is carried out. The main control circuit 50a transmits a NUDGE completion effect command, to the sub control circuit 171, and the sub control circuit 171, which receives that demonstration command, reads out demonstration data (see FIG. 23) which corresponds to that demonstration command, from the sub ROM 223 (see FIG. 6), and the sub CPU 221 (see FIG. 6) controls the image display control circuit 75 to display a relevant demonstration screen. Meanwhile, FIG. 64 shows an image which is displayed on the main display 4, in accordance with demonstration data which corresponds to the NUDGE completion demonstration command.

On one hand, in a step S234, third stop reel stop processing is carried out. The main control circuit 50a controls the motor drive circuit 67 to carry out stop processing of a third stop reel, on the basis of information of an appearing symbol of the third stop reel, which is stored in RAM 52 in the step S215.

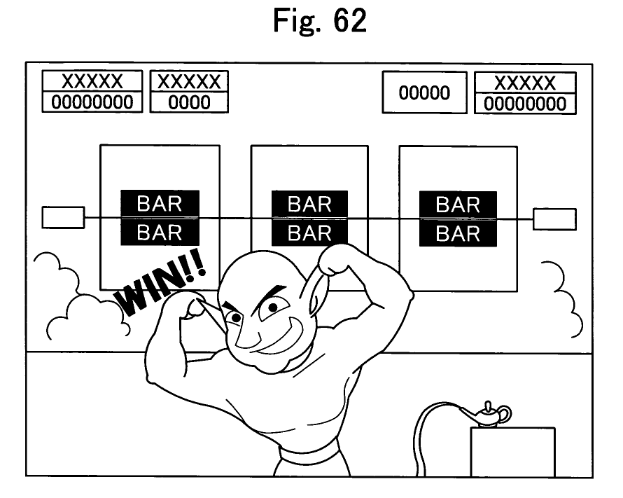

Next, in a step S235, winning succeeding game effect command transmission processing is carried out. The main control circuit 50a transmits a winning succeeding game effect command, to the sub control circuit 171, and the sub control circuit 171, which receives that demonstration command, reads out demonstration data (see FIG. 23) which corresponds to that demonstration command, from the sub ROM 223 (see FIG. 6), and the sub CPU 221 (see FIG. 6) controls the image display control circuit 75 to display a relevant demonstration screen. Meanwhile, FIG. 62 shows an image which is displayed on the main display 4, in accordance with demonstration data which corresponds to the winning succeeding game effect command.

Next, in a step S236, pay-out processing of a payout which corresponds to a winning combination is carried out. The main control circuit 50a carries out pay-out of a payout which corresponds to a winning combination which is determined in the step S215 of FIG. 36, in accordance with information of winning time payout number of the winning combination determination table (see FIG. 10) which is stored in ROM 51 (see FIG. 5) and BET number. The main control circuit 50a transmits a drive instruction to the hopper drive circuit 70 (see FIG. 5), and the hopper drive circuit 70 (see FIG. 5), which receives that drive instruction, controls the hopper 71 (see FIG. 5) to carry out pay-out of a coin. At this time, the coin detection section 73 (see FIG. 5) calculates the number of coins which are paid out, and when it determines that the number reaches predetermined number, transmits a pay-out completion signal to the pay-out completion signal circuit 72 (see FIG. 5). The pay-out completion signal circuit 72, which receives the pay-out completion signal, outputs such a request that the hopper drive circuit 70 transmits a signal for stopping drive of the hopper 71, to the main control circuit 50a.

Next, in a step S237, determination of whether the reel rotation number counter indicates three or more, or not is carried out. The main control circuit 50a determines whether a numerical value of the reel spin number counter, which is a variable stored in RAM 52, is three or more, or not. When this determination is YES, processing is shifted to a step S238, and when it is NO, processing is shifted to the step S213 of FIG. 36.

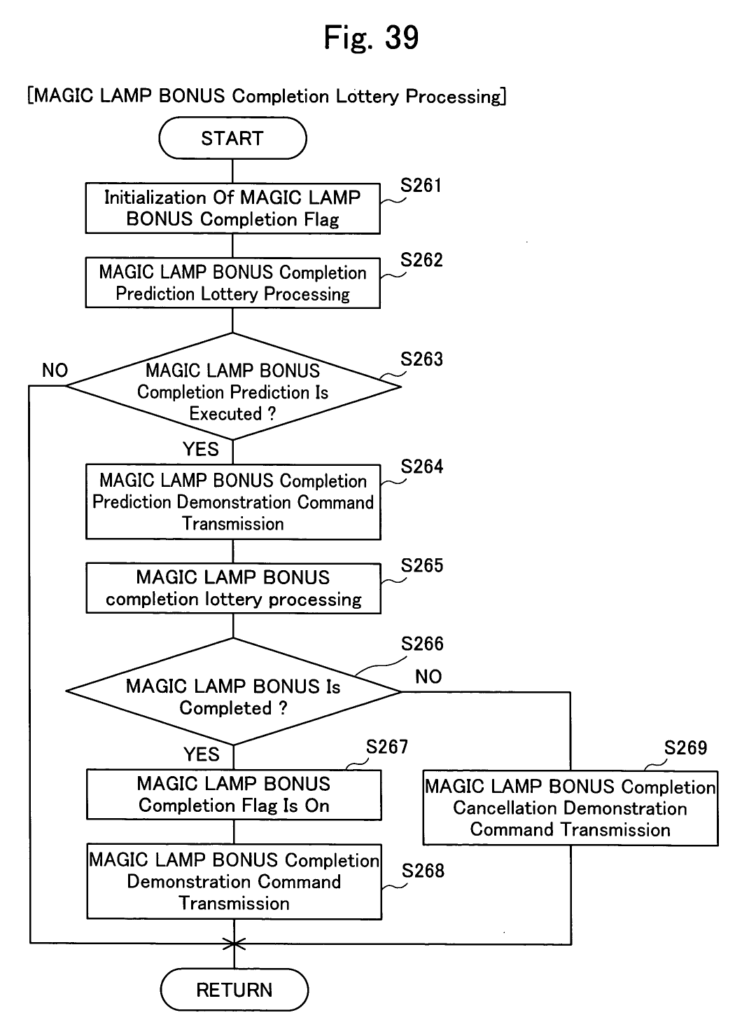

Next, in the step S238, MAGIC LAMP BONUS completion lottery processing is carried out. Details of this processing will be descried in details of MAGIC LAMP BONUS completion processing of FIG. 39, which will be described later.

Next, in a step S239, Determination of whether a MAGIC LAMP BONUS completion flag is ON or not is carried out. The main control circuit 50a determines whether a numerical value of the MAGIC LAMP BONUS completion flag, which is a variable stored in RAM 52, is “1” or not. When this determination is YES, processing is shifted to a step S240, and when it is NO, processing is shifted to the step S213 of FIG. 36.

Next, in the step S240, payout display recovery command transmission processing is carried out. The main control circuit 50a transmits a payout display recovery command, to the sub control circuit 171 (see FIG. 6), and the sub control circuit 171, which receives that command, recovers a payout table which is displayed on the sub display 3 (see FIG. 1) to a state prior to shifting to MAGIC LAMP BONUS, on the basis of payout information prior to change display, which is stored in RAM 52 in the step S211 of FIG. 36. When this processing is finished, this subroutine is finished, and therefore, a demonstration which corresponds to a winning combination of FIG. 35 and reel stop processing are finished, and processing is shifted to the step S102 of FIG. 28.

[Payout Display Change Command Reception Processing]

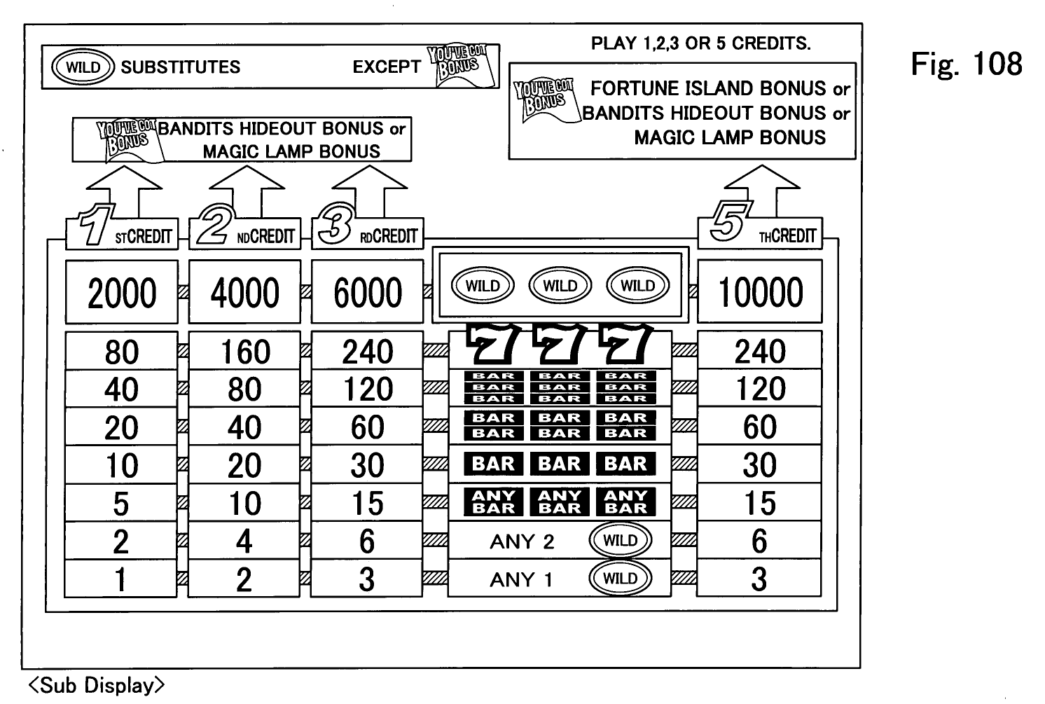

Payout display change command reception processing of FIG. 38 is processing which is carried out when a payout display change command is transmitted from the main control circuit 50a (see FIG. 5) to the sub control circuit 171 (see FIG. 6) in the step S211 for MAGIC LAMP BONUS processing in FIG. 36, and the sub control circuit 171 receives that command. Meanwhile, FIG. 108 shows an image of a payout table which is displayed on the sub display 3, prior to payout display change command reception processing execution.

In a step S251, payout display change pattern probability lottery processing is carried out. The sub control circuit 171 (see FIG. 6) extracts one random number value by software control. On that random number value, the main control circuit 50a further determines a payout display change pattern, with reference to a payout display change pattern probability lottery table (see FIG. 19) which is stored in ROM 51 (see FIG. 5).

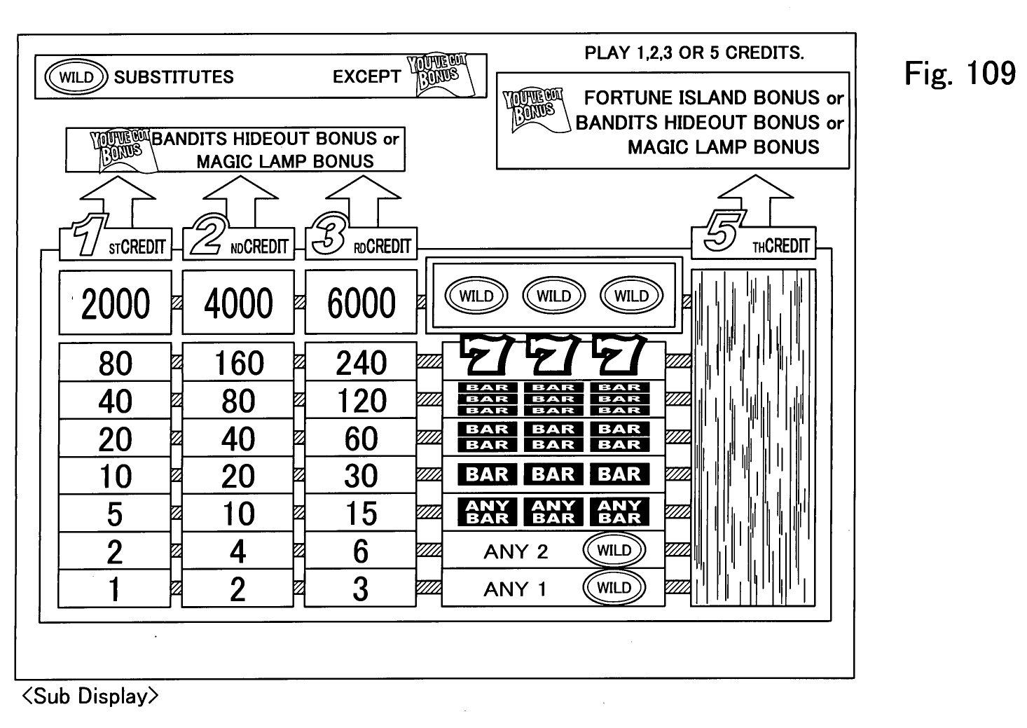

Next, in a step S252, processing of starting rotation display of payout display of relevant BET number is carried out. The sub control circuit 171 (see FIG. 6) starts rotation display of a display portion of a payout table which corresponds to BET number in a base game at the time of shifting to MAGIC LAMP BONUS. Meanwhile, FIG. 109 shows an image of a payout table which is displayed on the sub display 3, at the time of execution of processing of starting rotation display of payout table of relevant BET number. In this example, “relevant BET number” is “5”.

Next, in a step S253, processing of “displaying a payout display based on a payout display change pattern which was selected by having rotation display stopped” is carried out. The sub control circuit 171 displays payout information based on a payout display change pattern which is determined by the step S251 by having rotation of a rotation display portion of a payout table stopped.

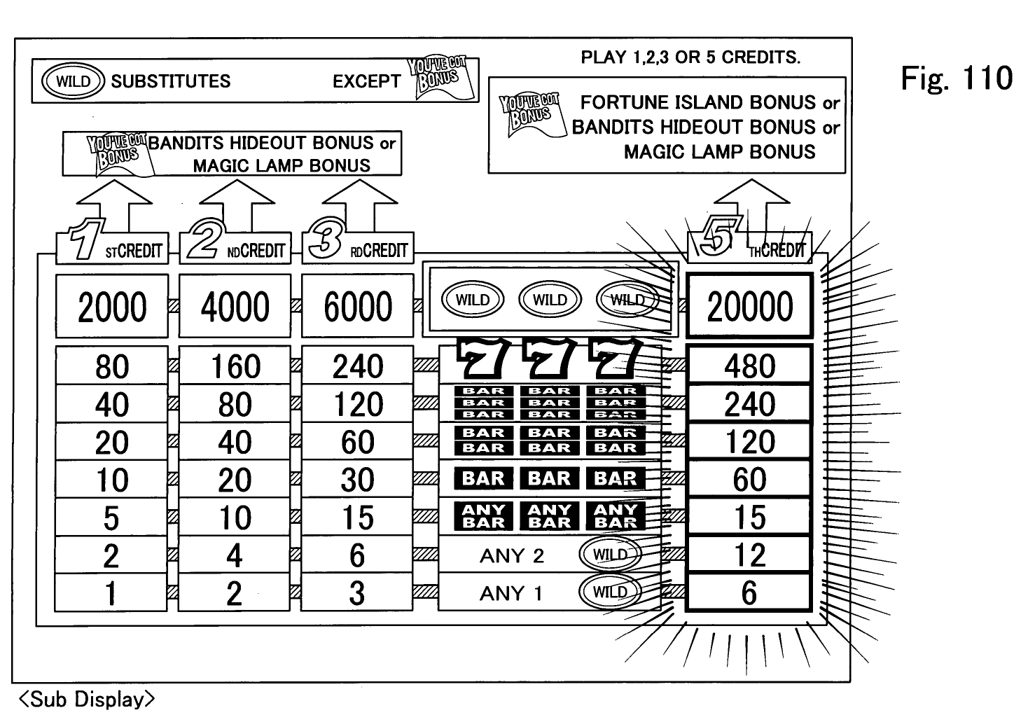

Next, in a step S254, processing of starting identification display of payout display of relevant BET number is carried out. The sub control circuit (see FIG. 6) starts identification display of a display portion of a payout table which corresponds to BET number in a base game at the time of shifting to MAGIC LAMP BONUS. This identification display is carried out by for example, a method of surrounding the display portion of the payout table which corresponds to BET number in a base game at the time of shifting to MAGIC LAMP BONUS, with a frame, and brink-displaying the frame, but not-limiting to this, any display method may be used, if it is a display method in which a relevant portion may be easily identified. FIG. 110 shows such an image that rotation of a rotation display portion of a payout table is stopped, and identification display of a display portion of a relevant payout table is started. Comparing FIG. 108 with FIG. 110, payout number of each winning combination to such a matter that BET number is “5” is as shown in FIG. 108, prior to shifting to MAGIC LAMP BONUS, but since it is determined by the processing of the step S251 that “payout, which corresponds to relevant BET number, is changed to double”, payout number of each winning combination to BET number of “5” becomes as shown in FIG. 110.

Meanwhile, in this embodiment, it is configured in such a manner that, by execution of the step S251, one payout display change pattern is determined by lottery from a plurality of payout display change patterns, and payout display is changed in accordance with the determined payout display change pattern. However, this invention is not limited to this, and it is all right even if it is configured in such a manner that payout display is changed without using lottery.

[Details of MAGIC LAMP BONUS Completion Lottery Processing]

With reference to FIG. 39, details of MAGIC LAMP BONUS completion lottery processing, which is carried out in the step S238 of FIG. 37, will be described.

In a step S261, initialization of a MAGIC LAMP BONUS completion flag is carried out. The main control circuit 50a (see FIG. 5) sets “0” (clears) to the MAGIC LAMP BONUS completion flag, which is a variable stored in RAM 52 (see FIG. 5).

Next, in a step S262, MAGIC LAMP BONUS completion prediction lottery processing is carried out. In this processing, it is determined whether a demonstration of MAGIC LAMP BONUS completion prediction is carried out or not. The main control circuit 50a controls the random number sampling circuit 56 (see FIG. 5), and extracts one random number value from random number values that the random number generator 55 (see FIG. 5) generates. On the basis of that random number value, the main control circuit 50a further determines whether a demonstration of MAGIC LAMP BONUS completion prediction is carried out or not, with reference to a MAGIC LAMP BONUS completion prediction demonstration probability lottery table shown in FIG. 17.

Next, in a step S263, determination of whether MAGIC LAMP BONUS completion prediction is carried out or not is carried out. The main control circuit 50a determines whether it is determined in the step S262 that the demonstration of MAGIC LAMP BONUS completion prediction is carried out, or not. When this determination is YES, processing is shifted to a step S264, and when it is NO, this subroutine is finished, and processing is shifted to the step S264 of FIG. 37. According to the step S263, MAGIC LAMP BONUS completion prediction is carried out with probability of approximately “ 3/4”.

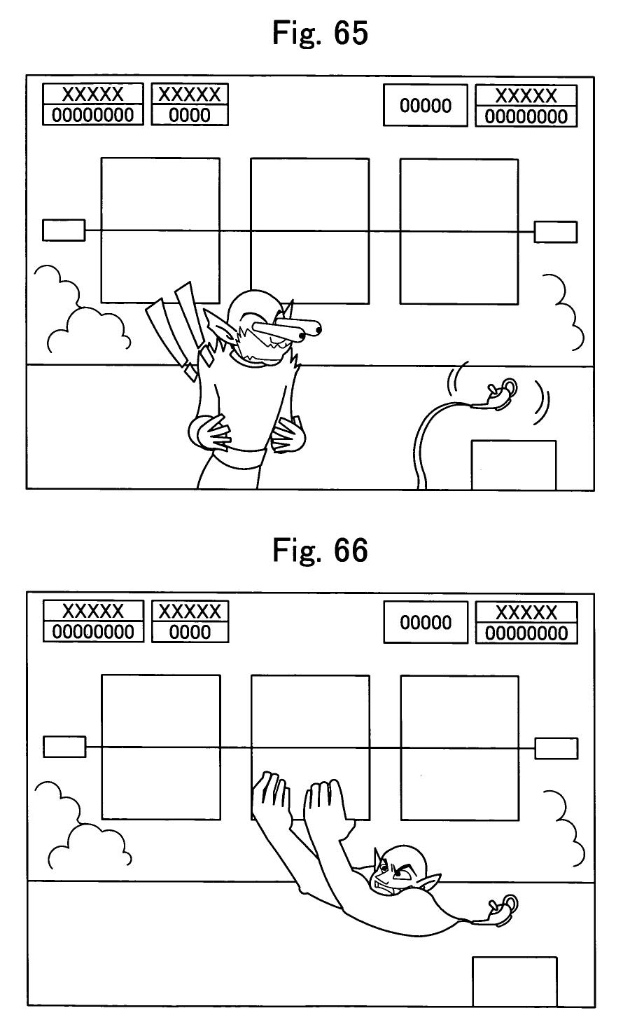

Next, in the step S264, MAGIC LAMP BONUS completion prediction demonstration command transmission processing is carried out. The main control circuit 50a transmits a completion prediction command (see FIG. 24) to the sub control circuit 171, and the sub control circuit 171, which receives that demonstration command, reads out demonstration data (see FIG. 24) which corresponds to that demonstration command, from the sub ROM 223 (see FIG. 6), and the sub CPU 221 (see FIG. 6) controls the image display control circuit 75, to display a relevant demonstration screen. Meanwhile, FIG. 65 shows an image of a relevant demonstration screen. Subsequently, the main control circuit 50a transmits a hold-on demonstration command (see FIG. 24) to the sub control circuit 171, and the sub control circuit 171, which receives that demonstration command, reads out demonstration data (see FIG. 24) which corresponds to that demonstration command, from the sub ROM 223 (see FIG. 6), and the sub CPU 221 (see FIG. 6) controls the image display control circuit 75 to display a relevant demonstration screen. Meanwhile, FIG. 66 shows an image of a relevant demonstration screen.

Next, in a step S265, MAGIC LAMP BONUS completion lottery processing is carried out. In this processing, it is determined whether MAGIC LAMP BONUS is finished or not. The main control circuit 50a controls the random number sampling circuit 56, and extracts one random number value from random number values that the random number generator 55 generates. On that random number value, the main control circuit 50a further determines whether MAGIC LAMP BONUS completion is carried out or not, with reference to a “MAGIC LAMP BONUS completion probability lottery table at the time of carrying out a MAGIC LAMP BONUS completion prediction demonstration” which is shown in FIG. 18. That is, when MAGIC LAMP BONUS completion prediction processing is carried out with probability of approximately “ 3/4” by the processing of the step S263 and the MAGIC LAMP BONUS completion prediction demonstration is carried out by the processing of this step S263, MAGIC LAMP BONUS completion is carried out with probability of approximately “⅔”. Therefore, execution of completion of MAGIC LAMP BONUS is to be determined with probability of approximately “½” (=approximately “ 2/4”×approximately “⅔”).

Next, in a step S266, determination of whether it is MAGIC LAMP BONUS completion or not is carried out. The main control circuit 50a carries out determination of whether it is determined that MAGIC LAMP BONUS is completed, or not, with reference to a determination result of the step S265. When this determination is YES, processing is shifted to a step S267, and when it is NO, processing is shifted to a step S269.

Next, in the step S267, processing of turning ON a MAGIC LAMP BONUS completion flag is carried out. The main control circuit 50a sets “1” to a numerical value of the MAGIC LAMP BONUS completion flag (turns ON the flag), which is a variable stored in RAM 52.

Next, in a step S268, MAGIC LAMP BONUS completion demonstration command transmission is carried out. The main control circuit 50a transmits a MAGIC LAMP BONUS completion demonstration command (sprit of lamp exit demonstration command (see FIG. 24)) to the sub control circuit 171, and the sub control circuit 171, which receives that demonstration command, reads out demonstration data (see FIG. 24) which corresponds to that demonstration command, from the sub ROM 223 (see FIG. 6), and the sub CPU 221 (see FIG. 6) controls the image display control circuit 75, to display a relevant demonstration screen. Meanwhile, FIG. 68 shows an image of a relevant demonstration screen. When this processing is finished, this subroutine is finished, and processing is shifted to a step S239 of FIG. 39.

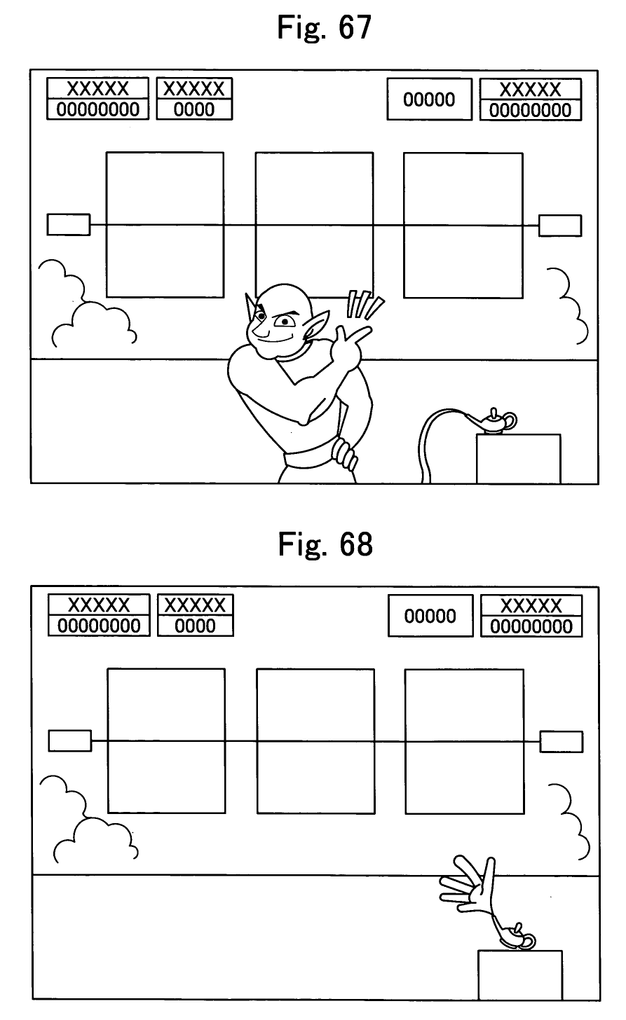

On one hand, in a step S269, MAGIC LAMP BONUS completion cancellation demonstration command transmission processing is carried out. The main control circuit 50a transmits a MAGIC LAMP BONUS completion cancellation demonstration command (hang-on demonstration command (see FIG. 24)), to the sub control circuit 171, and the sub control circuit 171, which receives that demonstration command, reads out demonstration data (see FIG. 24) which corresponds to that demonstration command, from the sub ROM 223 (see FIG. 6), and the sub CPU 221 (see FIG. 6) controls the image display control circuit 75, to display a relevant demonstration screen. Meanwhile, FIG. 67 shows an image of a relevant demonstration screen. When this processing is finished, this subroutine is finished, and processing is shifted to the step S239 of FIG. 37.

[Details of Failure Demonstration in First Stopping Order and Reel Stop Processing]

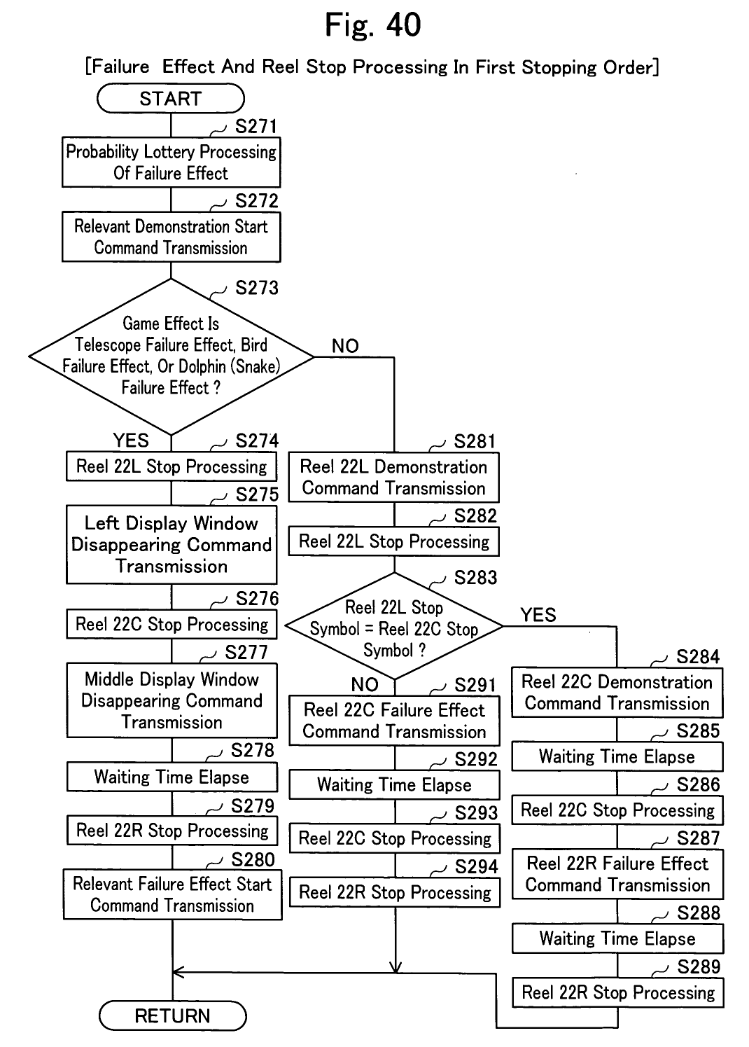

With reference to FIG. 40, details of a failing game effect in the first stopping order, which is carried out in the step S114 of FIG. 29 and reel stopping processing will be described.

In a step S271, “failing game effect” probability lottery processing is carried out. The main control circuit 50a (see FIG. 5) controls the random number sampling circuit 56 (see FIG. 5), and extracts one random number value from random number values that the random number generator 55 (see FIG. 5) generates. On that random number value, the main control circuit 50a further determines a “failing game effect” to be carried out, with reference to such a column that a reel stopping order is the first stopping order, in a “failing game effect selection probability lottery table when a winning combination is loss” which is shown in FIG. 16. That is, when a normal screen is of “SEA”, one demonstration is selected from “dolphin failure game effect”, “seagull failure game effect”, “monkey failure game effect”, “telescope failure game effect”, and “bird failure game effect”, and when the normal screen is of “DESERT”, one demonstration is selected from “snake failure game effect”, “buzzard failure game effect”, “monkey failure game effect”, “telescope failure game effect”, and “bird failure game effect”. For example, when the extracted one random number value is “95”, a selection of the “monkey failure game effect” is determined.

Next, in a step S272, relevant demonstration command transmission processing is carried out. That is, the main control circuit 50a transmits a demonstration start command which corresponds to the “failure game effect” selected in the step S271, to the sub control circuit 171 (see FIG. 6). The sub control circuit 171, which receives that demonstration start command, reads out demonstration data (see FIG. 22) which corresponds to that demonstration start command, from the sub ROM 223 (see FIG. 6), and the sub CPU 221 (see FIG. 6) controls the image display control circuit 75 to display a relevant demonstration screen.

Next, in a step S273, the main control circuit 50a carries out determination of whether the “failure game effect”, which is selected in the step S271, is “telescope effect”, “bird failure game effect”, or “dolphin (snake) failure game effect”. When this determination is YES, processing is shifted to a step S274, and when it is NO, processing is shifted to a step S281.

Next, in the step S274, stop processing of the reel 22L is carried out. The main control circuit 50a controls the motor drive circuit 67 (see FIG. 5), to carry out stop processing of the reel 22L, on the basis of information of an appearing symbol of the reel 22L, which is stored in RAM 52 (see FIG. 5) in the step S106 of FIG. 28.

Next, in a step S275, left display window disappearing demonstration command transmission processing is carried out. The main control circuit 50a transmits a left display window disappearing command (“telescope failure game effect command 12”, “bird failure game effect command 12”, and “dolphin (snake) failure game effect command 12” (see FIG. 22)) which corresponds to the “failure game effect” determined in the step S2271, to the sub control circuit 171, and the sub control circuit 171, which receives that demonstration command, reads out demonstration data (see FIG. 22) which corresponds that demonstration command, and the sub CPU 221 (see FIG. 6) controls the image display control circuit 75, to erase the left display window 23.

Next, in a step S276, stop processing of the reel 22C is carried out. That is, stop processing, which is similar to that of the reel 22L in the step S274, is carried out.

Next, in a step S277, middle display window disappearing demonstration command transmission processing is carried out. Except for on the basis of any one command of “telescope failure game effect command 13”, “bird failure game effect command 13”, or “dolphin (snake) failure game effect command 14” (see FIG. 22), processing, which is similar to that of the step S275, is carried out, to erase the middle display window 24.

Next, in a step S278, waiting time elapse processing is carried out. The main control circuit 50a is turned in a waiting state for a given length of time, to wait ready until the demonstration, which is instructed for execution in the step S277, is completed.

Next, in a step S279, stop processing of the reel 22R is carried out. By processing which is similar to the stop processing of the reel 22L in the step S274, stop processing of the reel 22R is carried out.

Next, in a step S280, relevant failure game effect command transmission processing is carried out. Except for on the basis of any one command of “telescope failure game effect command 14”, “bird failure game effect command 14”, or “dolphin (snake) failure game effect command 15” (see FIG. 22), processing, which is similar to that of the step S272, is carried out. Meanwhile, FIGS. 73 and 80 show images of relevant game effects. FIG. 73 corresponds to the “telescope failure game effect”, and FIG. 80 corresponds to the “bird failure game effect”. When this processing is finished, this subroutine is finished, and processing is shifted to the step S102 of FIG. 28.

On one hand, in a step S281, demonstration command transmission processing for the reel 22L is carried out. Except for on the basis of any one command of “seagull failure game effect command 11”, “buzzard failure game effect command 11”, or “monkey failure game effect command 11” (see FIG. 22), processing, which is similar to that of the step S272, is carried out.

Next, in a step S288, stop processing of the reel 22L is carried out. The main control circuit 50a controls the motor drive circuit 67, to carry out stop processing of the reel 22L, on the basis of information of an appearing symbol of the reel 22L, which is stored in RAM 52 (see FIG. 5) in the step S106 of FIG. 28.

Next, in a step S283, determination of whether an appearing symbol of the reel 22L is equivalent to an appearing symbol of the reel 22C or not is carried out. The main control circuit 50a determines, with reference to information of appearing symbols of the reels 22L and 22C, which is stored in RAM (see FIG. 5) in the step S106 of FIG. 28, whether both sides are equivalent or not. When this determination is YES, processing is shifted to a step S284, and when it is NO, processing is shifted to a step S291.

Next, in the step S284, demonstration command transmission processing for the reel 22C is carried out. Except for on the basis of any one command of “dolphin failure game effect command 12”, “snake failure game effect command 12”, or “seagull failure game effect command 12”, “buzzard failure game effect command 12”, and “monkey failure game effect command 12” (see FIG. 22), processing, which is similar to that of the step S272, is carried out.

Next, in a step S285, waiting time elapse processing is carried out. This processing is similar to that of the step S252.

Next, in a step S286, in the same manner as in the step S274, stop processing of the reel 22C is carried out.

Next, in a step S287, failure game effect command transmission processing for the reel 22R is carried out. In the same manner as in the step S284, transmission of a relevant demonstration command (“seagull failure game effect command 16”, “buzzard failure game effect command 16” or “monkey failure game effect command 16” (see FIG. 22) is carried out from the main control circuit 50a to the sub control circuit 171, and on the basis of that demonstration command, execution of a corresponding demonstration is carried out in the sub control circuit 171. For example, FIG. 54 shows an image of image display of demonstration data which corresponds to the “seagull failure game effect command 16”. Further, FIG. 59 shows an image of image display of demonstration data which corresponds to the “monkey failure game effect demand”.

Next, in a step S288, waiting time elapse processing is carried out. This processing is similar to that of the step S252.

Next, in a step S289, stop processing of the reel 22R is carried out. By the processing which is similar to the stop processing of the reel 22L in the step S274, stop processing of the reel 22R is carried out. When this processing is finished, this subroutine is finished, and processing is shifted to the step S102 of FIG. 28.

On one hand, in a step S291, failure game effect command transmission processing for the reel 22C is carried out. The main control circuit 50a (see FIG. 5) transmits a demonstration command of the reel 22C, in accordance with the “failure game effect” which is determined in the step S271. In the same manner as in the step S284, transmission of a relevant command (“seagull failure game effect command 15”, “buzzard failure game effect command 15”, or “monkey failure game effect command 15” (see FIG. 22) is carried out from the main control circuit 50a to the sub control circuit 171, and on the basis of that demonstration command, execution of a corresponding demonstration is carried out in the sub control circuit 171.

Next, in a step S292, waiting time elapse processing is carried out. This processing is similar to that of the step S252.

Next, in a step S293, stop processing of the reel 22C is carried out. That is, stop processing, which is similar to that of the reel 22L in the step S274, is carried out.

Next, in a step S294, stop processing of the reel 22R is carried out. That is, step processing, which is similar to that of the reel 22L in the step S274, is carried out. When this processing is finished, this subroutine is finished, and processing is shifted to the step S102 of FIG. 28.

As above, by carrying out processing of the steps S281, S284, S287, and S291, it is possible to interlock a stop of variable display of a reel and a game effect which is displayed on the main display 4, with visual relevancy.

In particular, when the “succeeding game effect” is the “seagull failure game effect” or the “buzzard failure game effect”, a seagull stays in a region of the display windows 23, 24, 25 of the reels 22L, 22C, 22R, and thereby, it is possible to notify to a player that such a possibility that a predetermined winning combination occurs is high. In addition, by this means, it is possible for a player to play a game with feeling of expectancy.

In addition, when the “succeeding game effect” is the “monkey failure game effect”, by carrying out such a demonstration that a monkey hangs down the display windows 23, 24, 25 of the reels 22L, 22C, 22R, and the monkey moves a display window on which it hangs on sequentially, it is possible to notify a reel which stops next, to a player.

[Details of Failure Demonstration in a Case Other than First Stopping Order and Reel Stop Processing]

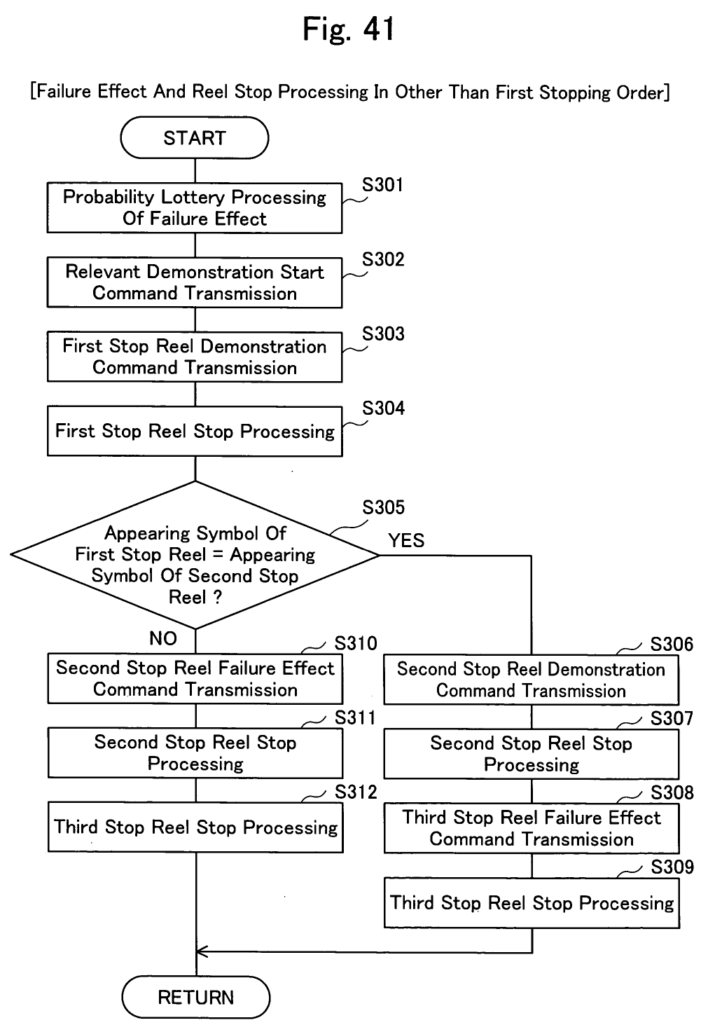

With reference to FIG. 41, details of failure game effect in a case other than the first stopping order and reel stop processing, which is carried out in the step S115 of FIG. 29, will be described.

In a step S301, probability lottery processing of “failure game effect” is carried out. By processing which is similar to that of the step S271 of FIG. 40, probability lottery processing of “failure game effect” is carried out, but in this processing, “failure game effect” to be carried out is determined, with reference to such a column that a reel stopping order is the first stopping order, in a “failure game effect selection probability lottery table when a winning combination is loss” which is shown in FIG. 16, and therefore, a reel stop demonstration which may be selected is, when a normal screen is of “SEA”, “seagull failure game effect” and “monkey failure game effect”, and when the normal screen is of “DESERT”, one demonstration of “buzzard failure game effect” and “monkey failure game effect” is selected.

Next, in a step S302, relevant demonstration start command transmission processing is carried out. In this processing, processing which is similar to that of the step S272 of FIG. 40 is carried out.

Next, in a step S303, first stop reel demonstration command transmission processing is carried out. The main control circuit 50a (see FIG. 5) transmits a demonstration command of a first stop reel, in accordance with the “failing game effect” which is determined in the step S301. That is, the main control circuit 50a transmits a command (“seagull (buzzard) failure game effect commands 11 to 13”, “monkey failure game effect commands 11 to 13” (see FIG. 22)) which corresponds to the demonstration determined in the step S301, to the sub control circuit 171 (see FIG. 6), and the sub control circuit 171, which receives that demonstration command, reads out demonstration data (see FIG. 22) which corresponds to that demonstration command, from the sub ROM 223 (see FIG. 6), and the sub CPU 221 (see FIG. 6) controls the image display control circuit 75, to carry out a relevant demonstration. For example, when the “failure game effect” is the “seagull failure game effect”, the main control circuit 50a transmits seagull failure game effect commands 11 to 13 (see FIG. 22), to the sub control circuit 171 (see FIG. 6), and the sub control circuit 171, which receives that demonstration command, reads out demonstration data (see FIG. 22) which corresponds to that demonstration command, from the sub ROM 223 (see FIG. 6), and the sub CPU 221 controls the image display control circuit 75, to carry out a relevant demonstration.

Next, in a step S304, stop processing of a first stop reel is carried out. The main control circuit 50a controls the motor drive circuit 67, to carry out stop processing of the first stop reel, on the basis of information of an appearing symbol of the first stop reel, which is stored in RAM 52 (see FIG. 5) in the step S106 of FIG. 28.

Next, in a step S305, determination of whether a stop symbol of the first stop reel is equivalent to a stop symbol of the second stop reel or not is carried out. The main control circuit 50a determines, with reference to information of appearing symbols of the first and second stop reels, which is stored in RAM (see FIG. 5) in the step S106 of FIG. 28, whether both sides are equivalent or not. When this determination is YES, processing is shifted to a step S306, and when it is NO, processing is shifted to a step S310.

Next, in the step S306, in the same manner as in the step S303, second stop reel demonstration command transmission processing is carried out.

Next, in a step S307, in the same manner as in the step S304, stop processing of a second stop reel is carried out.

Next, in a step S308, in the same manner as in the step S303, stop processing of a second stop reel is carried out.

Next, in a step S309, in the same manner as in the step S304, stop processing of a third stop reel is carried out. When this processing is finished, this subroutine is finished, and processing is shifted to the step S102 of FIG. 28.

On one hand, in a step S310, second stop reel failure game effect command transmission processing is carried out. That processing is similar to that of the step S308.

Next, in a step S311, in the same manner as in the step S304, stop processing of a second stop reel is carried out.

Next, in a step S312, in the same manner as in the step S304, stop processing of a third stop reel. When this processing is finished, this subroutine is finished, and processing is shifted to the step S102 of FIG. 28.

As above, by carrying out the steps S303, S306, S308, and S310, it is possible to interlock a stop of variable display of a reel and a game effect which is displayed on the main display 4, with visual relevancy.

In particular, when the “succeeding game effect” is the “seagull failure game effect”, a seagull stays in a region of the display windows 23, 24, 25 of the reels 22L, 22C, 22R, and thereby, it is possible to notify to a player that such a possibility that a predetermined winning combination occurs is high. In addition, by this means, it is possible for a player to play a game with feeling of expectancy.

In addition, when the “succeeding game effect” is the “monkey failure game effect”, by carrying out such a demonstration that a monkey hangs down the display windows 23, 24, 25 of the reels 22L, 22C, 22R, and the monkey moves a display window on which it hangs on sequentially, it is possible to notify a reel which stops next, to a player.

[Other Embodiment]

In this embodiment, it is configured in such a manner that, passing through the step S133 of FIG. 31, the step S134 is carried out, and passing through the step S135, the step S136 is carried out. That is, erasing of the display windows 23, 24 of reels is designed to be carried out after the reels 22L, 22C stopped, respectively. However, not-limiting to this, it is all right even if erasing of the display windows 23L, 23C is carried out before the reels 22L, 22C stop.

In this embodiment, it is designed to play a game with a life point which increases or decreases by going on blocks of a SUGOROKU board, in FORTUNE ISLAND BONUS. As to display of a life point on the sub display 3, a valid life point is displayed by a pattern of a marked-out heart, and a lost life point is displayed by a pattern of a shaded heart. It is all right even if warning is displayed to a player, when the valid life point became remaining one (or may be two), like display 503 of FIG. 107. By doing in this way, it is possible for a player to easily recognize that a life point decreases so that the FORTUNE ISLAND BONUS game got closer to its completion.

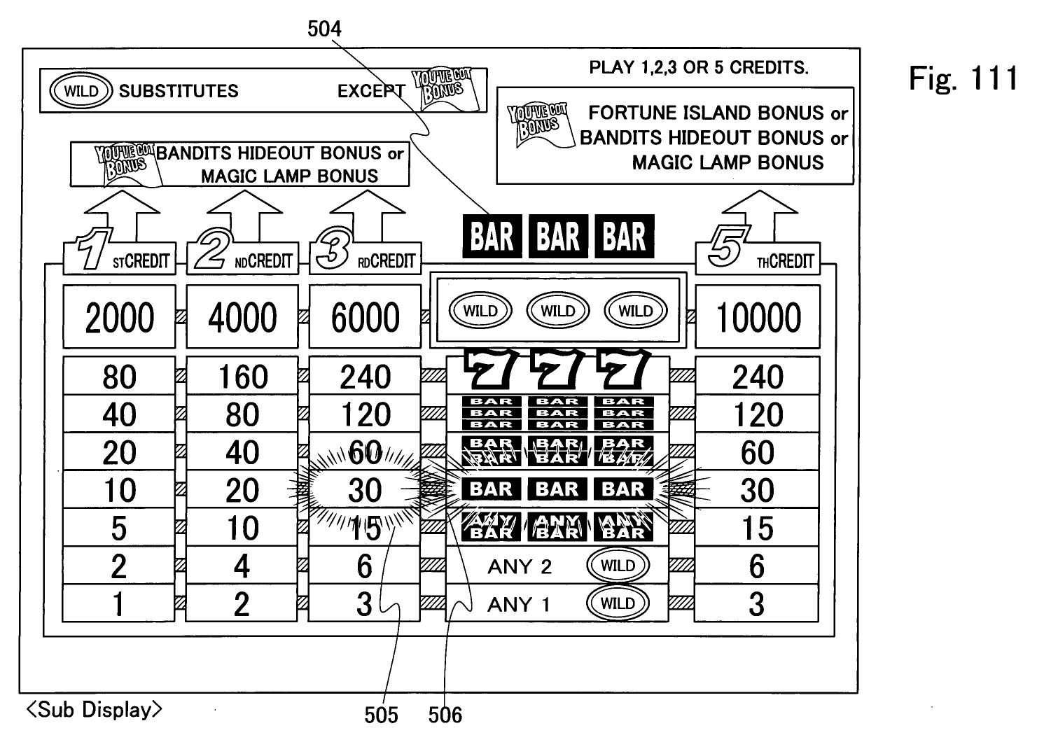

The gaming machine 1 of this embodiment is a gaming machine which displays a payout table, which is used for a game, on the sub display 3. As a display method of this payout table, the following thing may be carried out. That is, a winning combination, which is actually won, is displayed on the payout table, and thereby, the player can identify the real winning combination. In addition, in the payout table, a payout which is distributed to a winner of the winning combination and thus such winning combination are displayed so as to be identifiable from others. For example, as shown in FIG. 111, when a win of “BAR” occurs in case that BET number is “3”, “BAR-BAR-BAR” is displayed like display 504 (the achieved winning combination is displayed on the payout table and thereby, identification is enabled), and a payout number is blink-displayed like display 505, and display of the winning combination is brink-displayed line display 506. By doing in this way, the player can easily identify the winning combination which is actually the win, and in addition, can easily identify the payout number.

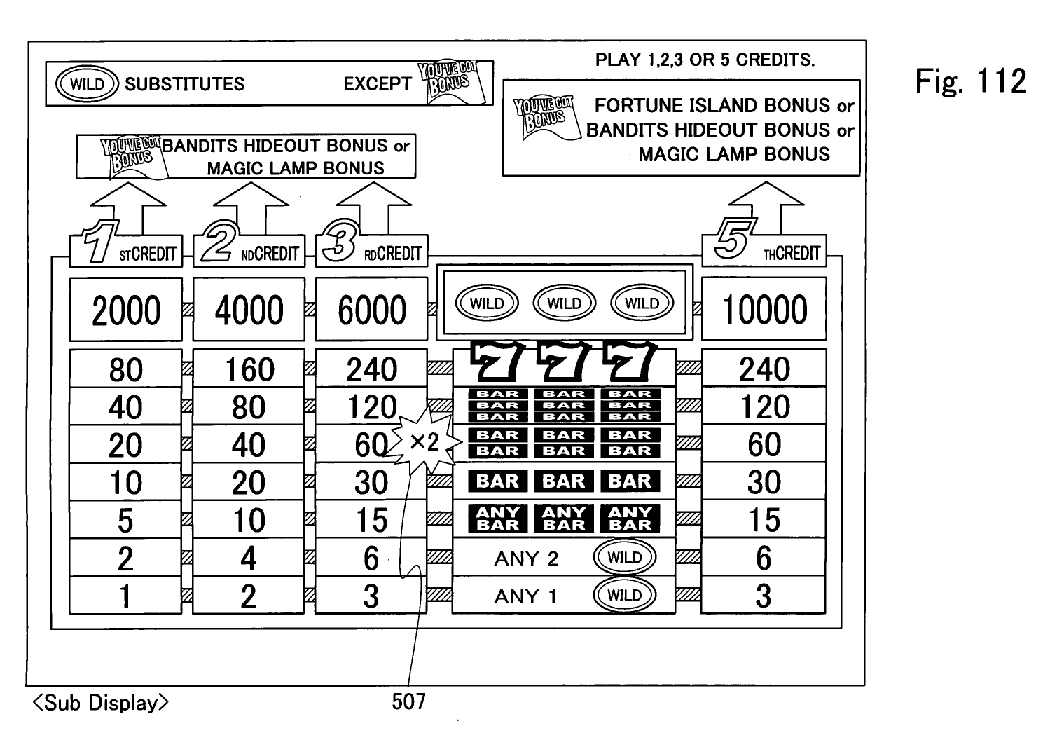

In addition, a “DOUBLE” symbol, which is the ““WILD symbol” which doubles a payout”, may be adopted as a pattern row of the reel 22. If a winning combination involving that “DOUBLE” symbol occurs, a payout becomes double or quadruple. For example, when only one “DOUBLE” symbol is included in a winning pattern like “DOUBLE-BAR-BAR”, a double payout of the normal winning combination “BAR” is distributed, and when two “DOUBLE” symbols are included in the winning combination, like “DOUBLE-DOUBLE-BAR”, a quadruple payout of the normal winning combination “BAR” is distributed. When BET number is “3” and a double payout of a normal winning combination “BAR” is distributed, display which means “X 2” is displayed in the vicinity of a display portion of a relevant payout number, line display 507 of FIG. 112. In addition, a “TRIPLE” symbol, which is a ““WILD” symbol which triples a payout”, may be also adopted for a pattern row of the reel 22, in the same manner.

The above-described embodiments include the following.

(1) A gaming machine having reels (e.g., reels 22L, 22C, 22R etc.) on whose peripheral surfaces a plurality of symbols (e.g., each symbol etc. shown in FIG. 4) necessary for a game are drawn, an appearing symbol determination means (e.g., a main control circuit 50a which carries out a step S106 of FIG. 28, etc.) which determines symbols which appear, side by side on a predetermined line (e.g., a center line L etc.), out of the plurality of symbols, a reel control means (e.g., a main control circuit 50a which carries out the step S107 of FIG. 28, the steps S133, S135 of FIG. 31, the steps S140, S144, S151 of FIG. 32, the steps S194, S197, S200 of FIG. 35, the steps S214, S219, S222 of FIG. 36, the steps S228, S231, S232, S234 of FIG. 37, the steps S274, S276, S279, S282, S286, S289, S293, S294 of FIG. 40, the steps S304, S307, S309, S311, S312 of FIG. 41, etc.) which carries out variable display control for carrying out variable display of the plurality of symbols by spinning the reels, and stop control for carrying out stop of the variable display on the basis of a determination result by the appearing symbol determination means and displaying appearing symbols which are aligned on the predetermined line, a bonus gaming shift control means (e.g., the main control circuit 50a, etc., which carries out the step S238 of FIG. 37 and the MAGIC LAMP BONUS completion lottery processing of FIG. 39) in which, when the appearing symbol is a predetermined mode (e.g., BONUS trigger symbol etc.), a condition of the gaming machine is shifted to a special gaming condition (e.g. MAGIC LAMP BONUS etc.) and by realization of a predetermined condition (e.g., in the step S238 of FIG. 37 and the MAGIC LAMP BONUS completion lottery processing of FIG. 39, to win the completion lottery), the special gaming condition is completed, a effect control means (e.g., the sub-control circuit 171 etc., including the image display control circuit 75) which controls a game effect relating to a game, and a effect display means (e.g., the main display 4 etc.) having display windows which are disposed in front of the reels and capable of carrying out the variable display of the plurality of symbols and transmissive display of the appearing symbols, the gaming machine being characterized in that the effect control means controls (e.g., to carry out the steps S217, S220, S224, S229, S233, S235 of FIG. 36 and the steps S264, S268, S269 of FIG. 39 by the main control circuit 50a, and processing which is carried by the sub control circuit 171 in accordance with processing of the above-described each step) a predetermined game effect (e.g., an image of “sprit of lamp” etc., for which display is realized by demonstration data of the MAGIC LAMP BONUS state game demonstration data table of FIG. 23) to display it on the effect display means when the gaming condition is in the special gaming condition, and when there is such a possibility that the special gaming condition is finished by realization of the predetermined condition (e.g., such a case that a win of the MAGIC LAMP BONUS completion prediction lottery of the step S262 of the MAGIC LAMP BONUS completion lottery processing of FIG. 39 occurred, etc.), control (e.g., the main control circuit 50a, the sub control circuit 171, etc. which carry out the step S264 of FIG. 39) which corresponds to a possibility of completion of the special gaming condition is carried out to the predetermined game effect.

According to the invention of (1), when a gaming condition of a gaming machine is in a special gaming condition, a predetermined game effect is displayed on the effect display means, and when there is such a possibility that the special gaming condition is finished, control which corresponds to a possibility of completion of the special gaming condition is carried out to that predetermined game effect, and therefore, a player can easily know that a gaming condition of a gaming machine is in a special gaming condition or not, or there is such a possibility that the special gaming condition is completed, depending on a symbol arrangement of a predetermined game effect. In addition, by this means, a player can play a game with so much feeling for the predetermined game effect, and can heighten seasoning of a game.

(2) The gaming machine described in (1), characterized in that, as to the predetermined game effect, when the special gaming condition is completed by realization of the predetermined condition, display on the effect display means is erased by control of the effect control means.

According to the invention of (2), when the special gaming condition is completed, the game effect is erased, and therefore, a player can easily know that the special gaming condition is completed. In addition, by this means, a player can play a game with so much feeling for the predetermined game effect, and can heighten seasoning of a game.

(3) The gaming machine described in (1) or (2), characterized in that the predetermined game effect has a visual relationship with the reel and the display window.

According to the invention of (3), a game effect moves so as to have a visual relationship with a mechanical reel and a display window of a reel, and therefore, it is possible to heighten actual feeling of the game effect and a demonstration effect. In addition, by this means, a player can play a game with so much feeling for the predetermined game effect, and can heighten seasoning of a game.

(4) A gaming machine having reels on whose peripheral surfaces a plurality of symbols necessary for a game are drawn, an appearing symbol determination means which determines symbols which appear, side by side on a predetermined line, out of the plurality of symbols, a stopping order determination means which carries out determination of a stopping order of variable display of the plurality of reels for which variable display of the plurality of symbols is carried out by spinning the reels, a reel control means which carries out variable display control for carrying out the variable display, and stop control for carrying out stop of the variable display on the basis of a determination result by the appearing symbol determination means and a stopping order which is determined by the reel stopping order determination means and displaying appearing symbols which are aligned on the predetermined line, effect control means (e.g., the main control circuit 50a and the sub-control circuit 171 etc., which carry out the steps S192, S195, S198 of FIG. 35, the steps S302, S306, S308, S310 of FIG. 41) which controls a game effect (e.g., each image data based on demonstration data which corresponds to the monkey succeeding game effect of the reel stop demonstration data table of winning combinations except for bonus game and loss of FIG. 21, each image data based on demonstration data which corresponds to the monkey failing game effect of the reel stop demonstration data table when a winning combination is a loss, of FIG. 22, etc.), and effect display means for displaying the game effect, having display windows which are disposed on front surfaces of the reels and capable of carrying out the variable display of the plurality of symbols and transmissive display of the appearing symbols, characterized in that the effect control means controls the game effect which visually relates to the stop control which is carried by the reel control means in accordance with determination of the stop determination means, to display it on the effect display means, and by this means, when the appearing symbol is determined in advance to be a predetermined mode by the appearing symbol determination means, the reel to which the stop control is applied next in accordance with the stopping order is suggested (e.g., such image control that a monkey, which is displayed on the basis of each image data based on demonstration data which corresponds to the monkey succeeding game effect of the reel stop demonstration data table of winning combinations except for bonus game and loss of FIG. 21, and each image data based on demonstration data which corresponds to the monkey failing game effect of the reel stop demonstration data table when a winning combination is a loss, of FIG. 22, hangs down a display window of a reel is carried out, and thereby, to suggest a reel which stops next, etc.) to a player.

According to the invention of (4), it is possible to carry out different kinds of demonstrations, by using the effect display means which is disposed in front of a reel. In addition, a game effect suggests a reel which stops next, having united feeling with stop of a mechanical reel, and therefore, the player can have emotional attachment to the game effect, and can play the game with some feeling. It is further possible to expect improvement of the game effect.

(5) The gaming machine described in (4), characterized in that the stopping order is determined in such a manner that adjacent two reels, among the plurality of reels, are not stop-controlled continuously, by the reel stopping order determination means.

According to the invention of (5), a moving amount of an image of the game effect suggesting a next reel to stop is enlarged to match up the mechanical reel as the mechanical reel is stopping, and therefore, it is possible to expect improvement of a demonstration effect of the game effect.

(6) The gaming machine described in (4) or (5), characterized by having a acoustic control output means which controls and outputs sound, the acoustic control output means controlling each reel distinctly such that different sounds are emitted from respective reels so as to correspond to the game effect.

According to the invention of (6), when a reel which is stopping next is suggested to the player, a demonstration by use of sound, being different from that of other reels, is carried out, and therefore, it is possible to expect improvement of a further demonstration effect, in cooperation with a game effect and a demonstration by use of sound.

(7) A gaming machine having reels on whose peripheral surfaces a plurality of symbols necessary for a game are drawn, an appearing symbol determination means which determines symbols which appear, side by side on a predetermined line, out of the plurality of symbols, a reel control means which carries out variable display control for carrying out variable display of the plurality of symbols by spinning the reels, and stop control for carrying out stop of the variable display on the basis of a determination result by the appearing symbol determination means and displaying the appearing symbols which are aligned on the predetermined line, and an effect display means for displaying the game effect, having display windows which are disposed on front surfaces of the reels and capable of carrying out the variable display of the plurality of symbols and transmissive display of the appearing symbols, with respect to each reel, characterized in that the reel control means stop-controls the appearing symbols to a mode which is different from a predetermined mode (e.g., a winning combination etc. of a bonus game shown in FIG. 10) which gives a predetermined valuable value to a player, and thereafter, it starts the variable display again, and the effect control means controls a predetermined game effect (e.g., such a game effect that display is realized by demonstration data which corresponds to “bird come-flying demonstration command”, “bird come-flying-again demonstration command”, “dolphin demonstration command 7”, and “snake demonstration command 7” in the bonus game demonstration data table of FIG. 25) which is interlocked with such a matter that the reel control means starts the variable display again, to display it on the effect display means.

According to the invention of (7), even in case that appearing symbols of reels become a loss so that the reels stopped, the reels start spinning again, taking such a matter that display of a predetermined game effect is carried out as a momentum, and therefore, it is possible to heighten player's feeling of expectancy.

(8) The gaming machine described in (7) having a plurality of the reels, characterized in that a display window shuttering means(e.g., the main control circuit 50a, the sub control circuit 171, etc. which carry out the steps S134, S136 of FIG. 31, the steps S275, S277 of FIG. 40), which applies ordering to the plurality of reels, and then, carries out the stop control, and shutters the display window which corresponds to a reel which is already stop-controlled, other than a reel in which the order is the last, and enables display of the game effect in a region of the display window, is provided.

According to the invention of (8), the display window shuttering means, which enables display of the game effect in a region of the display window, is provided, and therefore, it is possible to give versatility to display of a game effect on the effect display means.

(9) The gaming machine described in (7) or (8), characterized in that the predetermined game effect uses an identical character (e.g., “bird” etc. for which image display is realized by demonstration data of the bonus game demonstration data table of FIG. 25), before and after the reel control means starts the variable display again.

According to the invention as describe in (9), appearing symbols of reels stop at a loss, so as to follow a movement of an identical character, and after that, the reels spin again, and therefore, it is possible to expect an effect of further heightening player's feeling of expectancy.

(10) The gaming machine described in any one of (7) through (9), characterized in that, when the reel control means starts the variable display again and after that, is stop-controlled, the appearing symbols becomes the predetermined mode for giving a predetermined valuable value to a player.

According to the invention of (10), player's feeling of expectancy, which is heightened by such a matter that reels start spinning again, becomes a reality, and therefore, a player can feel high feeling of fullness, and can more heighten seasoning of a game.

(11) The gaming machine described in any one of,(7) through (10), characterized in that an acoustic control output means, which corresponds to the game effect and controls and outputs a demonstration by use of sound, is provided.

According to the invention of (11), an acoustic control output means, which corresponds to the game effect and controls and outputs a demonstration by use of sound, is provided, and therefore, it is possible to more heighten a demonstration effect of a game effect, and a player can play a game with more favorable feeling.

(12) A gaming machine having reels on whose peripheral surfaces a plurality of symbols necessary for a game are drawn, an appearing symbol determination means which determines symbols which appear, side by side on a predetermined line, out of the plurality of symbols, a reel control means which carries out variable display control for carrying out the variable display, and stop control for carrying out stop of the variable display on the basis of a determination result by the appearing symbol determination means and displaying appearing symbols which are aligned on the predetermined line, an effect control means which controls a game effect (e.g., an image of a “seagull”, etc. for which image display is realized by demonstration data which corresponds to a demonstration of the seagull succeeding game effect, the buzzard succeeding game effect of the reel stop demonstration data table of winning combinations except for bonus game and loss of FIG. 21, and demonstration data which corresponds to a demonstration of the seagull failing game effect, the buzzard failing game effect of the reel stop demonstration data table when a winning combination is loss, of FIG. 22) which relates to the game, and the effect display means for displaying the game effect, having display windows which are disposed in front of the reels and capable of carrying out the variable display of the plurality of symbols and transmissive display of the stop symbols, with respect to each reel, characterized in that the effect control means controls the game effect to be displayed on the effect display means, and by that means, suggesting to a player that it is determined by the appearing symbol determination means in advance that the stop symbol is the predetermined symbol.

(13) The gaming machine described in (12), characterized in that the game effect, which visually relates to the stop control, is realized by a movement of a character (e.g., a game effect of a “seagull” etc., which is realized by each demonstration data which corresponds to the seagull succeeding game effect of FIG. 21 and the seagull failing game effect of FIG. 22) which corresponds to each of the display windows which corresponds to the reels, and the character moves to an inside of a region of the display window from an outside of the region of the display window, when it is determined by the appearing symbol determination means in advance that the appearing symbol is the predetermined symbol, and stays in the inside of the display window.

According to the invention of (12) and (13), the player can know that it is determined by the appearing symbol determination means in advance that the stop symbol is the predetermined symbol before variable display is stopped, and therefore, the player can have feeling of expectancy in advance, to such a matter that the appearing symbols, which are aligned on the predetermined line, are the predetermined symbols. In addition, it is possible to visually recognize a symbol of a reel during a period of variable display and a demonstration which relates to it, at the same time, in such a matter that they are overlapped, and therefore, a more advantageous demonstration becomes possible.

(14) The gaming machine as described in (13), characterized in that the character moves to an outside of a region of the display window again, without staying in the region of the display window, even if it moves once from the outside of the region of the display window to an inside of the region of the display window, at the time other than the time when it is determined by the appearing symbol determination means in advance that the appearing symbol is the predetermined symbol.

According to the invention of (14), it is possible to put an appearing symbol and a demonstration under the spotlight of the player, even if the winning combination is not realized.

(15) The gaming machine described in (13) or (14) having a plurality of the reels, characterized in that ordering is applied to the plurality of reels, and then, the stop control is carried out, and when a specific character stays in a region of the display windows of respective reels other than the reel whose order is the last, a character, which is different from the specific character, moves from an outside of the region of the display window to an inside of the display window, in the reel whose order is the last, and stays in the region of the display window.

According to the invention of (15), by showing that a character stays in a display window of a reel, it is possible to clearly show to a player that there is such a possibility that a predetermined symbol appears.

(16) The gaming machine as described in any one of (13) through (15), characterized by having an acoustic control output means which controls and outputs a demonstration by use of sound which is different depending on whether the character stays in the region of the display window or not, with respect to each above-described reel.

According to the invention of (16), when it is suggested to the player whether a winning combination is realized or not, a demonstration by use of sound which is different with respect to each reel, respectively, is carried out, and therefore, it is possible to expect improvement of a further demonstration effect, in cooperation with a game effect and a demonstration by use of sound.

(17) A gaming machine which carries out a game, subject to such a matter that a valuable value is bet in advance by a player, having reels on whose peripheral surfaces a plurality of symbols necessary for a game are drawn, an appearing symbol determination means which determines symbols which appear, side by side on a predetermined line, out of the plurality of symbols, a reel control means which carries out variable display control for carrying out variable display of the plurality of symbols by spinning the reels, and stop control for carrying out stop of the variable display on the basis of a determination result by the appearing symbol determination means and displaying appearing symbols which are aligned on the predetermined line, a first display means (e.g., the main display 4 etc.) for displaying the demonstration, having display windows which are disposed in front of the reels and capable of carrying out the variable display of the plurality of symbols and transmissive display of the stop symbols, a second display means (e.g., the sub display 3 etc.) which is disposed separately from the first display means, a touch detection means (e.g., the touch panel 30 etc.) which is disposed in front of the first display means, and accepts an input of a predetermined instruction of the player, by detecting that a specific image, which is displayed on the first display means, is touched by the player, and bonus game control display means (e.g., the sub control circuit 171 which carries out FORTUNE ISLAND BONUS start command reception processing of FIG. 33, etc.) which carries out a bonus game in the gaming machine, taking realization of a predetermined condition as a momentum, and controls a game effect relating to the bonus game, to display it on the first display means and the second display means, and controls execution of the bonus game, characterized in that, in the bonus game, the bonus game control display means displays a predetermined image (e.g., the display 501 etc. shown in FIG. 91) for making a player select a specific numerical value which is selected in advance from numerical values within a predetermined region on the first display means, and the touch detection means detects that a player touched the predetermined image, and thereby, the bonus game control display means carries out display of the specific numerical value, and the bonus game control display means displays a SUGOROKU board, which has a plurality of blocks (e.g., blocks of SUGOROKU shown in an upper side figure of FIG. 91, etc.) and on which a piece, which moves only by blocks of a number corresponding to the specific numerical value on the plurality of blocks, is placed, on the second display means, and a game on the SUGOROKU board is controlled.

According to the invention of (17), in a gaming machine which uses reels, such as a slot machine, the first display means and the second display means are disposed, and the SUGOROKU board is displayed on the second display means, and a dice is displayed on the first display means, and a player touches that dice, and thereby, a selection of a numerical value of the dice is carried out, and it is possible to play such a SUGOROKU game that a piece is moved on a SUGOROKU board, on the basis of the selected numerical value, and therefore, a player can enjoy various gaming natures of a gaming machine, in a more easy-to-understand form.

(18) The gaming machine as described in (17), characterized by having a display window shuttering means (e.g., the liquid crystal panel 33 of the main display 4, and the image display control circuit 75 which controls it, etc.) which shutters the display window, when the bonus game control display means displays the predetermined image for making a player select a specific numerical value from numerical values within a predetermined range, on the first display means, in the bonus game, and which enables display of the game effect on all display regions of the first display means including a region of the display window.

According to the invention of (18), it is possible to use a region of a display window of the first display means for transmissively displaying reels, for the purpose of display of a game effect, and therefore, an effect of a demonstration is heighten, and in addition, it makes it possible for a player to easily understand a content of a SUGOROKU game as a bonus game.

(19) A gaming machine having a plurality of variable display means which variably displays a plurality of symbols necessary for a game, a random number extraction means which extracts a random number value, an appearing symbol determination means which determines appearing symbols of each of the plurality of variable display means, which appear side by side on a predetermined line, out of the plurality of symbols, on the basis of the random number value which is extracted by the random number extraction means, and a stop control means which stop-controls the variable display on the basis of a determination result by the appearing symbol determination means, characterized in that the appearing symbol determination means determines appearing symbols of each of the plurality of variable display means, on the basis of one random number value which is extracted by the random number extraction means.

As above, the embodiments have been shown, but they are simply examples and it should be understood the scope of the present invention should not be limited or narrowed because of them. and various components or elements may be altered or modified arbitrarily without departing the spirit and scope of the present invention. In addition, the advantages, which are shown in the embodiments, are simply listed as most preferable advantages which are generated from the embodiments, and the advantages according to this invention are not limited to what have been described. In addition, numerical values of various probability lottery tables, and other numerical values may be changed arbitrarily for the purpose of heightening and modifying the gaming nature of the gaming machine 1.

1. A gaming machine comprising:
reels having a plurality of symbols necessary for a game drawn on respective peripheral surfaces;
appearing symbol determination means for determining symbols which are stopped to appear on a predetermined position, out of the plurality of symbols;
reel control means which carries out variable display control for displaying variably the plurality of symbols by spinning the reels, and stop control for stopping the symbols on a basis of a determination result by the appearing symbol determination means and for displaying the symbols positioned on the predetermined position,
effect control means for controlling an image effect relating to the game; and
effect display means for displaying the image effect, the effect display means comprising: display windows which are disposed in front of the reels and capable of showing variable display of the plurality of symbols and transmissive display of the symbols, at least one of the display windows being capable of becoming unrecognizable with the image effect displayed thereon by control of the effect control means,
wherein the effect control means controls the image effect which visually relating to the stop control that is carried out by the reel control means, in response to determination of the appearing symbol determination means, to display the image effect on the effect display means, and
wherein the display windows being capable of transmissively displaying the symbols after the stop control in visual association with the image effect when the symbols are in a predetermined symbol arrangement determined by the appearing symbol determination means.

2. The gaming machine according to claim 1,
wherein the reel control means carries out the stop control to the plurality of reels in a predetermined order, and
wherein a last reel to which the stop control is performed has a predetermined specific symbol that becomes a trigger for a bonus game, the bonus game being more favorable to a player than the game being played before the bonus game, and
wherein the predetermined specific symbol is stop-controlled on a predetermined position by the reel control means such that the bonus game is triggered.

3. The gaming machine according to claim 1,
wherein the reels and the display windows are corresponding to each other,
wherein all display windows other than a last display window to which the stop control is carried out are capable of becoming unrecognizable with the image effect displayed thereon.

4. A gaming machine, with which a player is capable of playing a base game and a bonus game that is more favorable to the player than the base game, comprising:
a plurality of reels having a plurality of symbols drawn on respective peripheral surfaces thereof;
a display window being capable of transmissively displaying at least one of the plurality of symbols of each reel;
a first display including the display window; and
a control device for performing variable display and stop control of the plurality of symbols on the respective plurality of reels;
wherein:
in the base game, the bonus game is triggered when at least one reel of the plurality of reels is stopped at a predetermined position so as to display a predetermined specific symbol; and
the first display is capable of displaying an image effect thereon so as to prevent at least one symbol from being transmissively displayed in the corresponding display window.

5. The gaming machine according to claim 4, wherein the first display is provided with a panel being disposed in front of the display windows and is of an approximately same size as a display section of the first display, and wherein the image effect is shown on the panel.

6. The gaming machine according to claim 4, wherein in the bonus game, after a predetermined number of rounds having been repeated, where one round is a unit of repetition, a bonus game completion prediction lottery is carried out, and on a basis of a result of the bonus game completion prediction lottery, a condition of the gaming machine is controlled to shift from the bonus game to the base game.
